(19) United States
(12) Patent Application Publication
(10) Pub. No.: US 2007/0226005 A1
(43) Pub. Date: Sep. 27, 2007

(54) Totaldentist

(76) Inventors: Kevin Smith, West Chester, PA (US); Joon Bae, West Chester, PA (US); Jonathan Mark, West Chester, PA (US)

Correspondence Address: David M. Ostfeld;Adams and Reese LLP, 4400 One Houston Center, 1221 McKinney, Houston, TX, 77010, US

(21) Appl. No.: 11/326,875

(22) Filed: Jan. 6, 2006

(51) Int. Cl. G06F 17/30; G06Q 10/00; G06K 9/54

(52) U.S. Cl. 705/2; 707/1; 382/305

(57) ABSTRACT

A dental system for dental patients at a dental office is disclosed that is completely digital in storage of data. The data is obtained from instrumentation and patients, as well as from staff. The data is used to operate the dental office and treat the patients. Non-linear Web technology is applied to the data to functionally use the data in treatment and facility operation.

### I. BACKGROUND

A. Field of the Invention

The invention relates to dental practice management and more particularly to dental practice computer systems management.

B. Description of Related Art

Most dental computerized systems of the prior art use outdated proprietary technologies that are non-scalable, system specific, and hard to manage. For example:

| | | | | Backup & |
|---|---|---|---|---|
| | Database | OS | Imaging | Recovery |
| Prior | c-tree, | OS | Either use | None or |
| Art | flat file, | Specific | hardware key | manual |
| | or expensive | application | (proprietary | backups |
| | proprietary | versions | controller boards), | |
| | db (MS SQL | needed | or USB devices | |
| | server) | | which are limited | |
| | | | to a specific OS, | |
| | | | proprietary image | |
| | | | formats that are | |
| | | | embedded into | |
| | | | application or db | |

The dental profession is a “mom and pop” operation made up of primarily single operators. For the last 15 years or so, technology companies, primarily software developers, have tried to sell technology to this market.

There are hardware solutions being developed and sold as standalone, single problem solutions to the profession, namely digital intraoral radiographs and pictures and cad/cam technology, but these have been too expensive, too cumbersome to use, and too proprietary to integrate with other technologies in the dental office.

Because of the high costs of sales and being a door-to-door one-on-one sales gate, these technology companies themselves were small operators. Some were one and two person businesses made up of programmers trying to make money in a niche market.

The software and hardware used with all previous vendors have been proprietary, closed operating systems, languages and hardware systems as set out in the above chart. As the operating systems have changed and evolved, they become increasingly incompatible with the existing and older hardware. As the existing hardware develops newer, faster processors and components, upgrading the operating system and other software became much more cumbersome. The dental software shares this problem with generic personal systems to upgrade a standalone software system to work with proprietary hardware and operating system companies who have no interest in helping out.

Therefore, the dentist who has jumped into technology in the last 20 years faces not only an initial, large capital outlay to enter the market, but also an ongoing substantial capital outlay to keep the system running on a daily basis and keep it running through the myriad of technology changes from the various hardware/software company's products upon which their system runs.

Related to this topic is the generic equipment used. By utilizing readily available standalone PC's for their “hardware solution”, the first dental software companies tried to force the technology into the dental office.

As technology for the dental profession, the software was developed and engineered from a purely linear model of thinking, as pages in a book, one page at a time and one page after another in a logical order. What has been lacking in this whole arena of “technology for the dental profession” has been any non-lineal thinking and development, as all previous developers looked at dental technology from a linear model and from the technology into the dental office.

Since the beginning of dental software, every new dental software maker has copied their previous competitor. Thus, what is available in the prior art is a regurgitation of the same mistakes and failures. What is now causing even more confusion is the fact that most dental software systems are now owned, not by dental software developers, but by dental and medical supply companies which sell the packages as off the shelf commodities with little or no support and training and no research and development or enhancements for changes in the hardware and operating systems these systems run on.

The various systems available today for the dental profession are a hodgepodge of proprietary software and hardware pieces developed and sold by just as many disparate companies whose main goal is to keep their niche market device or software piece as proprietary as possible. This lends even more complexity and non-integration to the problems a dental office encounters when they try to bring a “total technology solution” into their office.

All previous technology solutions for the dental profession have been standalone, highly proprietary pieces to the overall solution. Thus, with as many as four standalone systems made up of a CPU, software, cart, etc., there was never enough room in the standard dental operatory to fit the technology without compromising patient care and comfort or by modifying the standard delivery system of the dental operatory, making the technology not worth the effort nor the costs.

Because separate companies have brought standalone systems to dentistry, each company has had unique overhead, research and development budgets, marketing cost, etc. whereby the costs needed to deliver a product to dentists was even higher.

The most common problem with previous available technology has been that it costs too much to purchase and maintain and gives zero return on investment.

It is an object of the present invention that incompatibility problems are resolved and yield productivity gains and automation.

It is another object of the present system to resolve the problems associated with prior art, namely in the areas of ergonomics, economics, efficiency, and ease of use.

It is another object of the present invention to use technology in such a unique way such that it can be delivered at 50% less than the costs of today's current technology.

It is another object of the present invention to be delivered at 50% less than the current market equivalent and also to have a return on investment of at least the purchase price in six months of use.

Another object of the present invention is to have a system developed looking at the dental office out to the technology and a non-linear or Web based model giving it a functionality of processes and tasks, all instantly performed and managed.

It is another object of the present invention to be staff friendly.

It is a further object of the present invention to collect data once, at the time it is created, in the fastest and easiest way possible, and then utilize this information many times in many areas simultaneously.

### II. SUMMARY OF THE INVENTION

As the prior art existing software/hardware systems have been based upon proprietary and inflexible operating systems, hardware platforms and archaic computer languages, the present system is the first to use “open source” technologies to give the flexibility needed for now and in the future as newer technologies come onboard and are developed. The system has also been developed to integrate seamlessly with the ancillary businesses of dentistry such as labs, both imaging and dental, and pharmacies, supply houses and dental continuing education. A summary of some of the features of the present invention are:

| | Database | OS | Imaging | Backup & Recovery |
|---|---|---|---|---|
| Invention | MySQL: fastest, | Linux, MacOS, | Hot-swappable USB | Full redundancy at |
| | reliable, and | MS Windows, any | devices. Not | hardware and software |
| | scalable open- | platform with | encumbered or tied | level, including an |
| | source relational | browser₌(or | to specific platform, | automated fail-over system |
| | db at minimal | capable of | uses universal JPG | for continuous service, one- |
| | cost | running JVM) | image format tied to | click snapshot backup jobs |
| | | and capable of | each patient's visit | to removable media (CD-R, |
| | | networking | | DVD-R), automated secure |
| | | | | remote off-site backup |
| | | | | available as option |

Directions for the new invention are easy to understand in terminology the dental office uses everyday. Automated functions makes practice management simple and to the point. The learning curve for system's use is targeted at two days with the present invention, as compared to weeks or months with other systems by working like a dentist works and automates every function outside the Patient visit and collects data only once. This is the power of open source, Web-based applications in a browser environment and an Internet configuration.

The data management system is shown designed to receive, store, process and/or display information obtained throughout the dental office visit. The invention is designed and structured specifically for use in a dental office. Information is input into the system at various points during the office visit. As information is input into the system, it is digitized and correlated to a standard American Dental Association (ADA) Code that exists for each and every dental procedure that can be performed in dentistry. It is this ADA Code on which the system is based. ADA Codes are standardized throughout the dentistry industry and used by all dentists and insurance companies.

As information is input into the system, it is immediately available in digital format at the next juncture of the office visit without the need to re-input the same information. Digital data generated throughout the office visit can be simultaneously and repetitively used as needed for all dental office procedures. In addition, through use of the ADA Codes, certain data processing and dental functions can be automated.

Information can be gathered into the system at four major points: the front desk, on the phone, the operatory, and the dental office Website. Once the information is in the system, it is immediately available at all points of display, including a Patient chart view screen where the answer to questions a Patient might pose to a dental staff member with regards to their treatment, billing, insurance, health, future need, etc. is located in an easy to read format.

The invention uses open source technology like Linux, Apache, JAVA and other open source technology. Therefore, it has the ability to expand as new technologies and methods of collecting digital information come on line, and as said system's technology is refined and adapted. The software and hardware of said system will be able to seamlessly incorporate the new technologies. This allows said system to adapt to future technology trends instead of being locked into proprietary, prior art technology. This use of open source technology allows said system to use any similar hardware pieces such as cameras, CMOS or CCD sensors, printers, CPU's, screens, keyboards, etc.

The hardware and the software can be interchangeable and the system will work the same. This is because it is not the technology that makes the system unique; it is the starting process and use of ADA Codes, along with the creation of the first fully digital Patient record in dentistry. Once data is entered in digital format, it can then be utilized in a very unique way not possible in a strictly linear model.

The system is a networked system that utilizes proprietary and open-source technologies to implement a complete dental practice, financial, and digital Patient record management service through an easy-to-use and familiar interface—the Web browser. The system is flexible, adaptable, and is not tied to a single operating system platform like other prior art operating systems or proprietary programs.

The core of said system is a Web application using J2EE technologies to enforce business rules and transformation.

Said system contains the following functionality:

Practice Management

Creation and maintenance of Patient records in a thorough and organized fashion
Complete personal, financial, insurance information
Full dental/medical history for each Patient
Embedded digital images and radiographs for each Patient visit
ADA Code-centric visit/procedures which drives planned treatment, automated rescheduling and notifications
Automated treatment (template-based and editable) notes based on scheduled ADA-Codes
Automated prescriptions, along with check for contra-indications and complications with known medications
Patient tracking automated for Patient follow-up visit, post-op calls, overdue recares, outstanding planned treatment, outstanding balances, and pending primary and secondary insurance claims
Automated business marketing with (template-based and editable) newsletters, letters, postcards, and birthday cards
Easy-to-view and easy-to-use GUI that is user-experience focused on guiding the user with one-click help and with minimal mouse clicks
   Back Office
Easily manageable, able to update ADA Codes and associated details of information (fee schedule and automated procedure notes)
Automated financial reports for auditing office based on day, week, “from-to-time” period, and yearly comparisons and charts
Primary or secondary insurance tracking from claim submission to receiving payment at either office or Patient level of detail
Automated time clock for employees
Automated generation of billing statements, outstanding statements based on office-specific printing schedule
   Inventory
Treatment and procedure driven prompts for just-in-time ordering (building a shopping cart list)
Utilization reports (e.g., average materials used by procedure)
Automated links to the dental supply companies
Build reorder list based on dentists experience
Links to available on-line catalogues from dental providers
   Patient Education
Office philosophy
Descriptions/illustrations of procedures
Automated recommendations on post-procedural continuing Patient care based on ADA Codes

Said system delivers back office integration between the doctor and the third-party payers, suppliers, insurance companies, and laboratories. The collaboration of all interested parties to the dental procedure forms a complete electronic dental sector e-commerce economy—an e-dental economy. Said system is also able to transmit all data to any party using XML if necessary to ensure data convergence.

### III. BRIEF DESCRIPTION OF DRAWINGS

For a further understanding of the natures and objects of the present invention, reference is made to the following drawings in which like parts are given like reference numerals and wherein:

FIG. 1 is a block diagram of the J2EE technologies;

FIG. 2 is a block diagram of the overall system;

FIG. 3 is a block diagram of the application server redundancy setup;

FIG. 4 is a block diagram of the components used with the Operating System;

FIG. 5 is a block diagram at the workstation clients;

FIG. 6 is a block diagram of System Peripherals;

FIG. 7 is an illustration of the Front Desk screen;

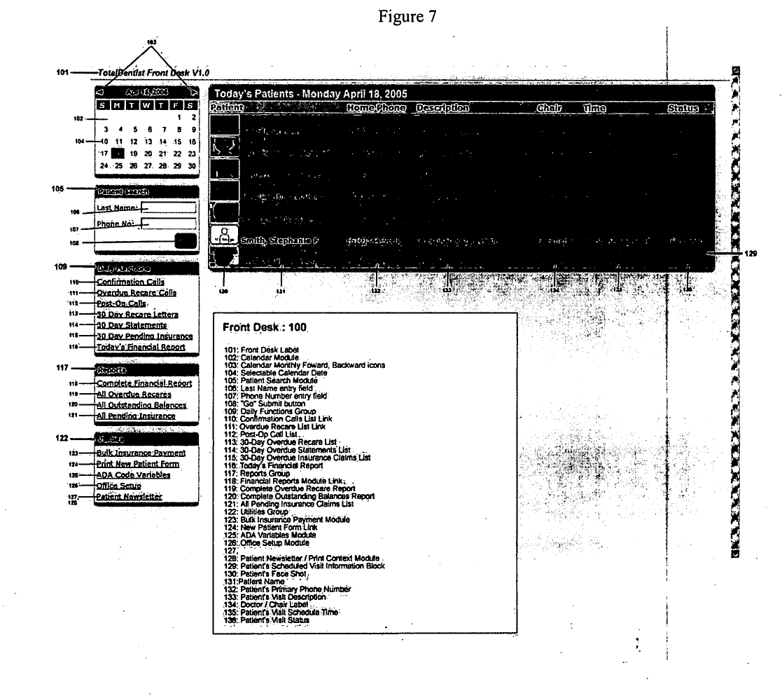

FIG. 8 is an illustration of the Patient At-a-Glance main view;

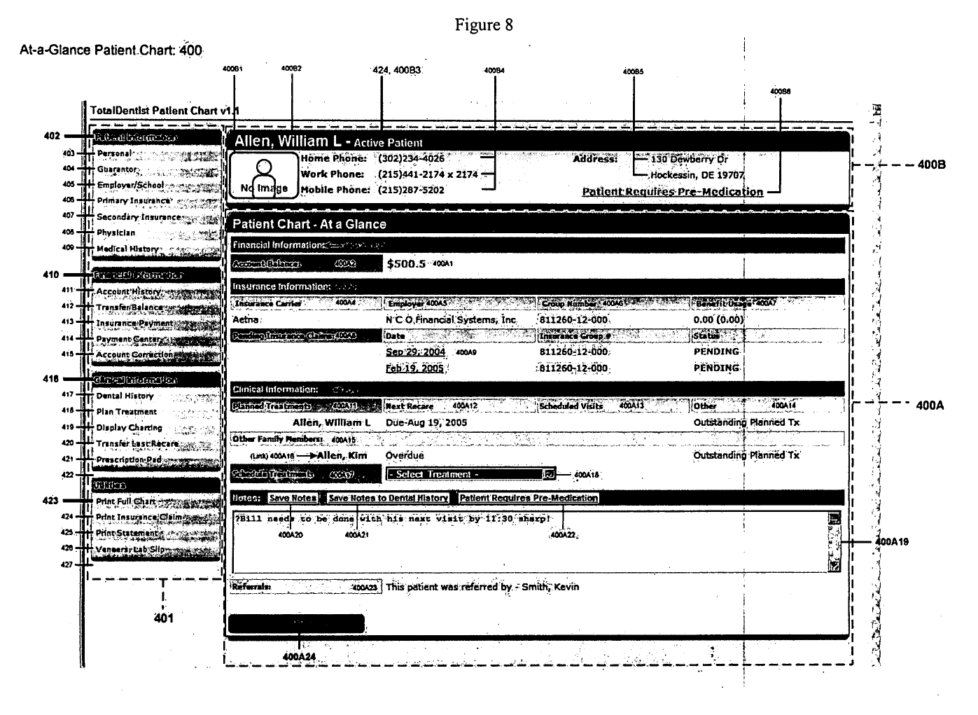

FIG. 9 is an illustration of the Patient Plan Treatment view;

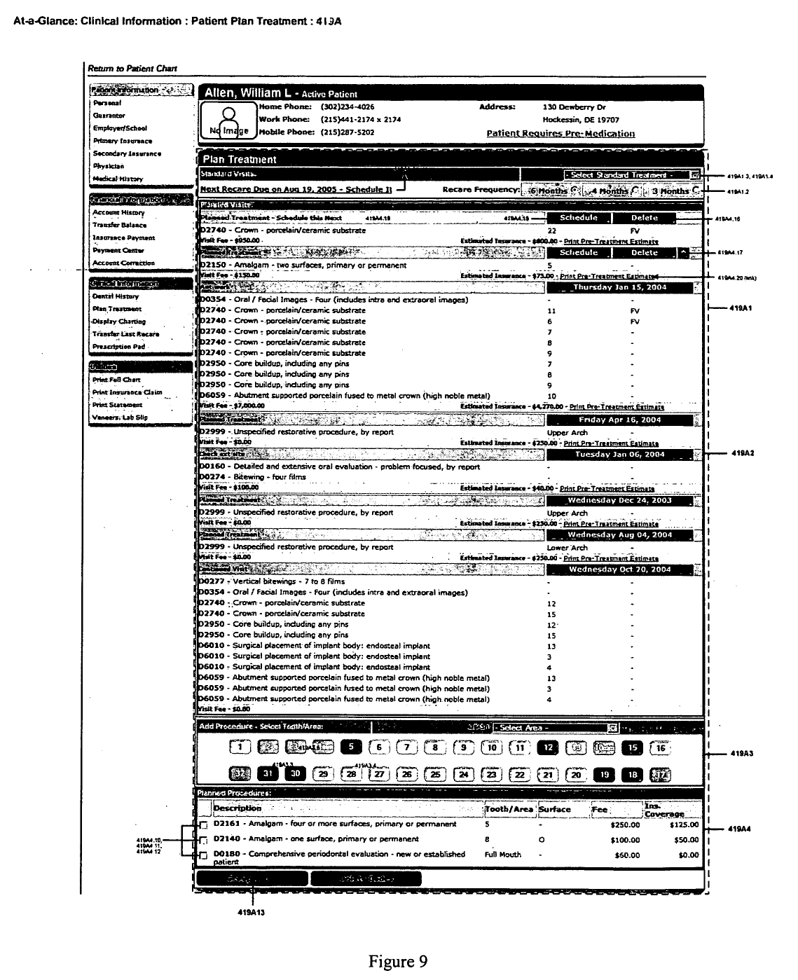

FIG. 10 is an illustration of the active Patient's Today's Visit screen.

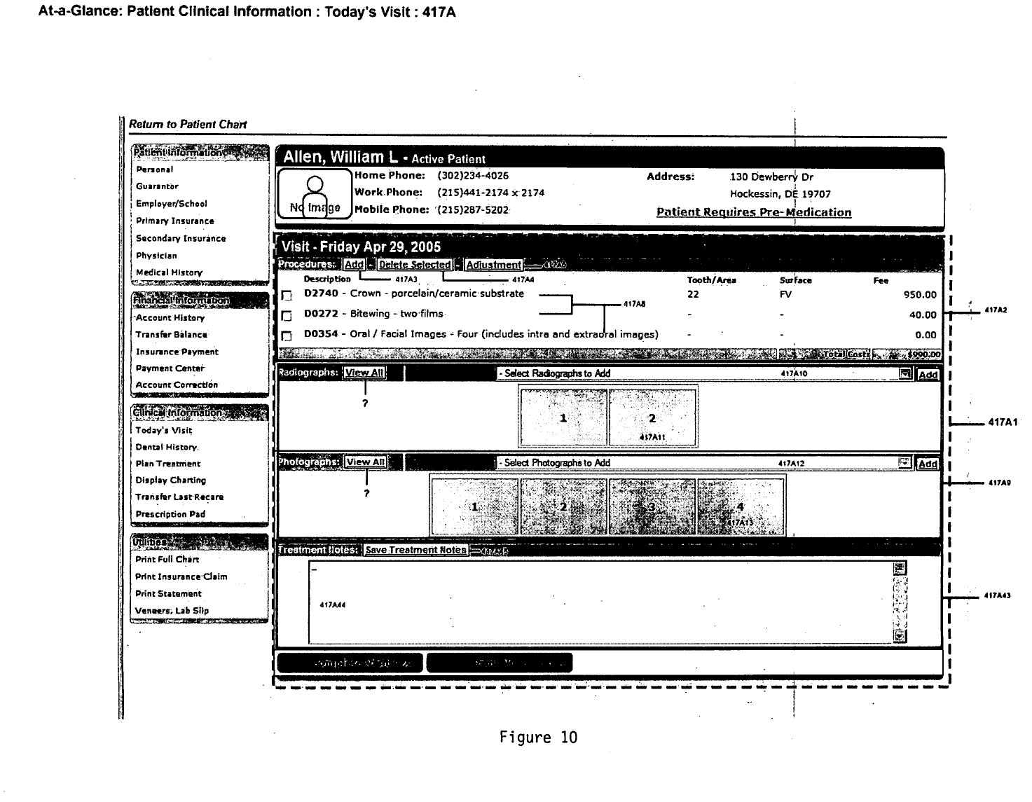

### IV. DETAILED DESCRIPTION OF PREFERRED EMBODIMENTS

Hardware and Software

The present system is broken into three different components: (1) application server (2A); (2) workstation client (2B); and (3) USB peripherals (2C).

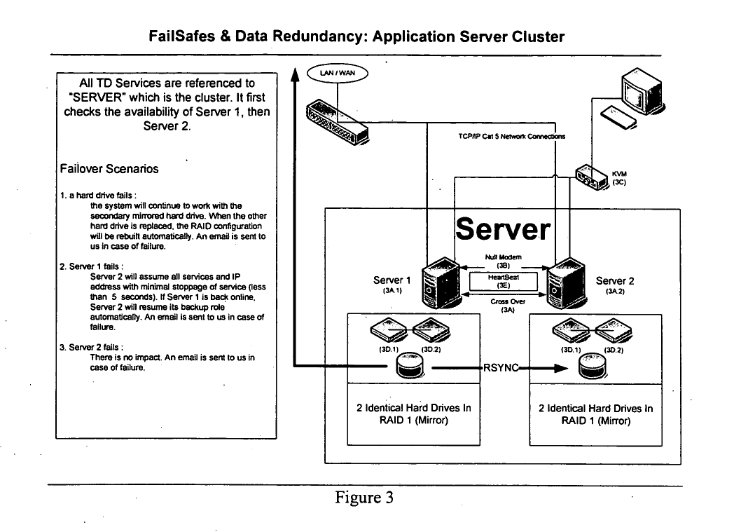

The application server (FIG. 3) is comprised of two units (3A.1, 3A.2) joined together physically by: a network crossover cable (3A), null-modem cable (3B), and a KVM switch (3C) (for sharing one monitor, keyboard, and mouse) as shown in FIG. 3. Each unit (3A.1, 3A.2) houses two 80 GB hard drives (3D.1, 3D.2) in RAID (Redundant Array of Inexpensive Disks) Level 1 (mirrored, duplicate copy) for real time physical backup of the application and all related data. The application server also includes a high-availability layer (3E) that checks to see if each of the two units are “alive”; if one shuts down, the application services related to said system are activated on the second unit—resulting in almost zero downtime. This service switchover is seamless and undetected by the user. The application data is also copied redundantly through the RSYNC-SSL service noted below between the two units (3A.1, 3A.2).

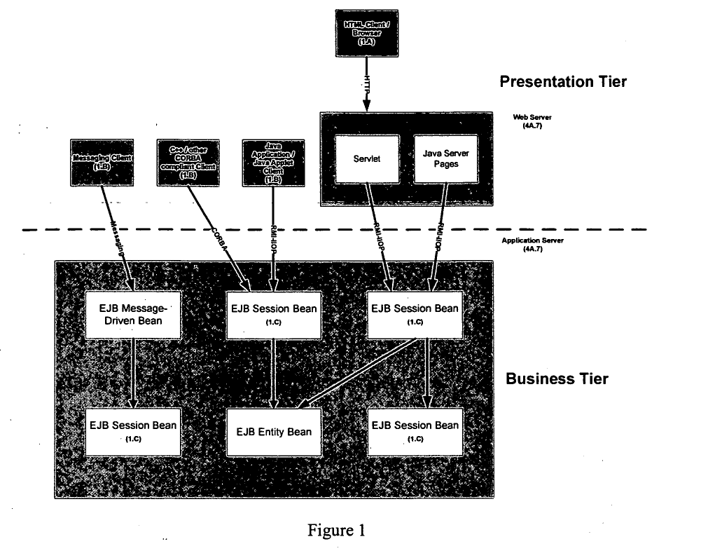

The nature of the software technology implemented also allows different types of interfaces to be used. Currently the Web interface (Web browser, FIG. 1, 1.A) is implemented but other types such as a native graphical user interface written in either native Java or other programming languages (FIG. 1, 1.B) can be implemented to use the existing business rules (FIG. 1, 1.C) quickly for the benefit of the end user.

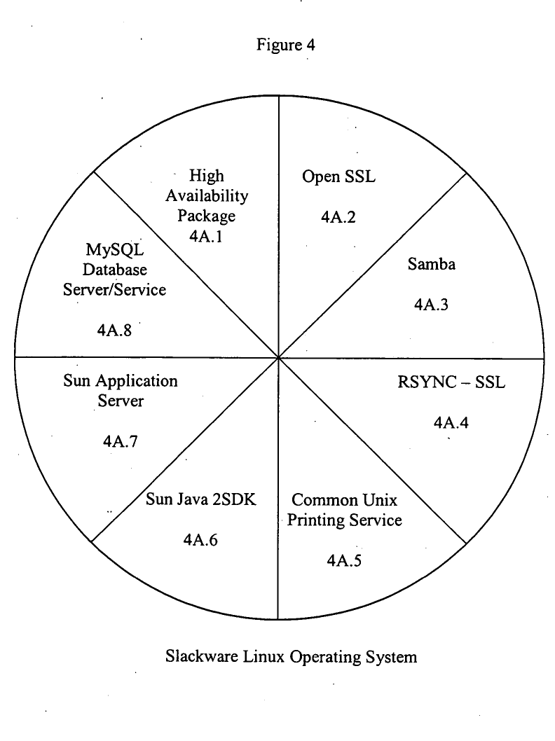

The operating system (FIG. 4) is Slackware Linux Operating System (www.slackware.com) (4A). The localized application server (2A) uses the latest version of Slackware Linux Operating System Distribution for all dependent and critical services and applications. Slackware is one of the fastest, reliable and flexible open-source distributions of Linux. Although said system uses Slackware version of Linux, said system is able to use any distribution under the Linux umbrella as an Operating System. Said system can also utilize other Operating Systems as Microsoft Windows 2000, Microsoft Windows XP, or Mac OSX with the appropriate secure networking, failover and clustering services.

The listed services below are important in the preferred embodiment for the upkeep and management of said system application. Although they are considered important, they are not platform specific. All of the following services can be run on any Linux core based OS or UNIX platform; other OS such as Microsoft Windows have similar capabilities in the Server offerings. The critical services are:

a. Linux High Availability Package (www.linux-ha.org) (4A.1)
This service allows two-node (each node is a physical server) redundancy for failsafe operation of said system and necessary services. If either node were to fail due to any reason, Linux-High Availability Package allows graceful transition of the associated IP address and other critical services (listed below) to the other remaining node without user intervention. The process is completely transparent to the user and said system service is unbroken to the client.

b. OpenSSL (www.openssl.org) (4A.2)
OpenSSL is a robust, commercial-grade, full-featured, and open source toolkit implementing the Secured Socket Layer (SSL v2/v3) and Transport Layer Security (TLS v1) protocols as well as a full-strength, general-purpose cryptography library.
Said system uses OpenSSL (128-bit encryption key) for its secure connections for the LAN and WAN.

c. Samba (www.samba.org) (4A.3)
Samba is a network file and printing service that allows interactivity between Linux and Microsoft Operating Systems. Said system uses Samba for client authentication, file transfers, and network availability.

d. RSYNC-SSL (http://samba.anu.edu.au/rsync/) (4A.4)
RSYNC-SSL is a fast file transfer protocol that uses OpenSSL that allows secure real-time copying of critical information in the LAN and WAN.

e. CUPS—Common Unix Printing Service (www.cups.org) (4A.5)
Said system depends on CUPS to provide all printing to the designated default printer.

f. Sun Java 2 SDK (http://java.sun.com) (4A.6)
The application of said system which handles all business logic and process is a servlet/java server page application, and by its nature, dependent on Sun's Java technology. Said system uses the newest production version of the software development kit available.

g. Sun Java System Application Server (http://developers.sun.com/prodtech/appserver/index.html) (4A.7, FIG. 1)
This is the industry's first and most popular production J2EE 1.4 platform application server. Focused mainly on developer productivity; the full featured, high-performance, small footprint container is FREE for development, deployment and redistribution.

h. MySQL Database Server/Service (http://www.mysql.com) (4A.8)
MySQL Database Server is an open-source GPL-licensed Relational Database Server. Said system uses MySQL Database to store all sets of information for the application.

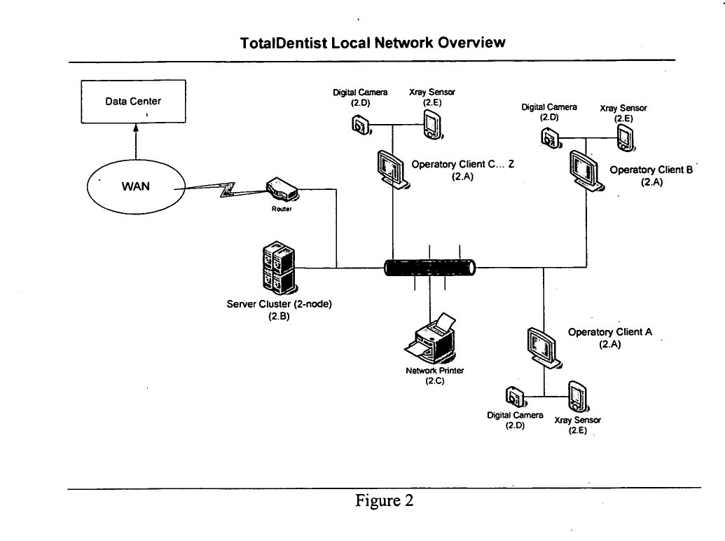

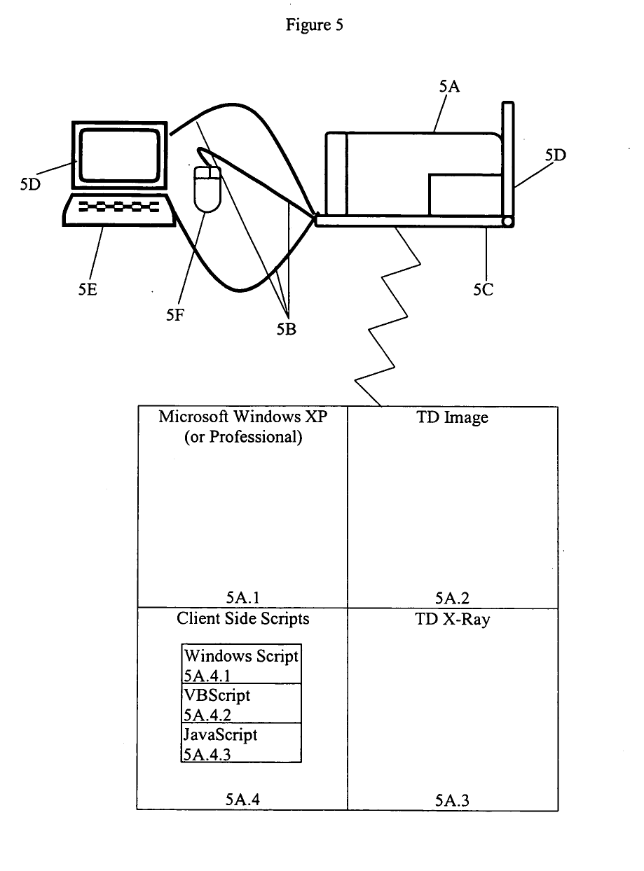

The Workstation Client (FIGS. 2, 5) is comprised of one PC (5A) using low power-consuming hardware in mini-ITX form factor (6.75″×6.75″) or similar in size that is mounted out of the way per operatory. Cables (5B) are run from the PC (5A) through the mounted folding arm (5C) to the LCD monitor (5D) and keyboard (5E) and mouse (5F). This form factor was chosen for its size and flexibility in mounting, but a standard desktop PC can be used as well. The software components of the Workstation Client (FIG. 5) are as follows:

a. Microsoft Windows XP Home or Professional Operating System (5A.1)
The Workstation Client (FIG. 5) uses Windows XP for its operating system due to its large availability and end user familiarity, but is not limited to Microsoft Windows since said system is a Web application and accessible via the Web browser.

b. TD Image (5A.2)
TD Image is an application written in Visual Basic 6 for said system. It provides interactivity with the Canon family of Digital SLR cameras using Canon's publicly available SDK Version 8. It can support several models including: D1, D10, D20, D30, D60, Digital Rebel/KISS. This application is used to take Patient face shots and all digital intra-oral images, then embed the images to the Patient visit record for said system. The application can also be ported to support other operating systems such as Linux, Mac OSX, and UNIX.

c. TD X-Ray (5A.3)
TD X-Ray is a proprietary application written in Visual Basic 6 for said system. It provides interactivity with EVA digital sensors. This application is used to take all digital radiographs, then embed the X-Rays to the Patient visit for said system. The application can also be ported to support other operating systems such as Linux, Mac OSX, and Unix.

d. Client Side Scripts (5A.4)
There are numerous Client Side Scripts embedded into said system that augment simple functionalities such as capitalizing names, numerations, dynamic formatting, (and the like), using these three types of technologies:
i. Windows Script (5A.4.1)
Windows Script is a comprehensive scripting infrastructure for the Microsoft Windows platform. Windows Script provides two script engines, Visual Basic Scripting Edition and Microsoft JScript, which can be embedded into Windows Applications. It also provides an extensive array of supporting technologies that makes it easier for script users to script specifically for Windows applications.
ii. VBScript (5A.4.2)
Microsoft Visual Basic Scripting Edition brings active scripting to a wide variety of environments, including Web client scripting in Microsoft Internet Explorer and Web server scripting in Microsoft Internet Information Service.
iii. JavaScript (5A.4.3)
JavaScript is a scripting language from Netscape that is only marginally related to Java. Java and JavaScript are not the same thing. JavaScript was designed to resemble Java, which in turn looks a lot like C and C++. The difference is that Java was built as a general-purpose object language, while JavaScript is intended to provide a quicker and simpler language for enhancing Web pages and servers. JavaScript is embedded as a small program in a Web page that is interpreted and executed by the Web client. The scriptor controls the time and nature of the execution, and JavaScript functions can be called from within a Web document, often executed by mouse functions, buttons, or other actions from the user. JavaScript can be used to fully control Netscape and Microsoft Web browsers, including all the familiar browser attributes.

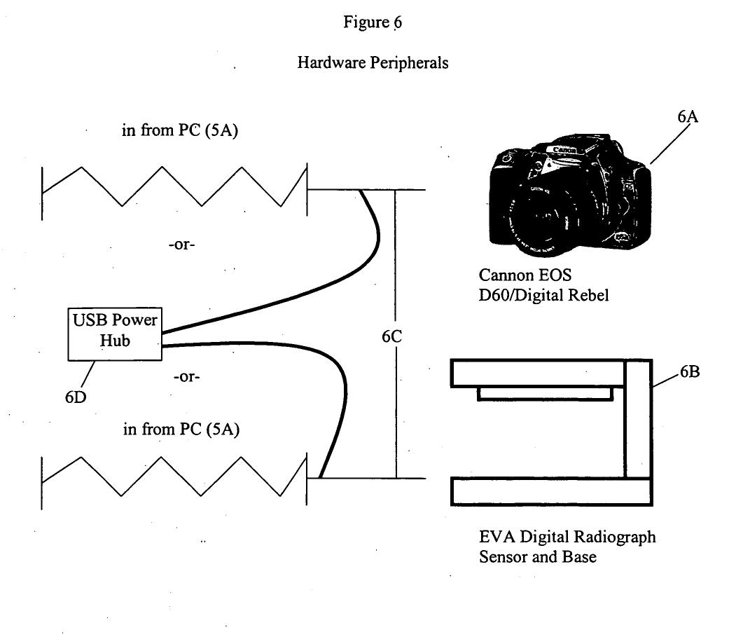

Said system uses two additional USB hardware peripherals (FIG. 6) for its Digital Imaging and Digital Patient Record Management. They are:
a. Canon EOS D60/Digital Rebel Digital SLR Camera with Ring Flash, 100 mm 2.8 m macro lens (6A); and
b. EVA Digital Radiograph Sensor and Base (6B).

Both devices are connected to the Workstation Client PC (5A) through USB connections (6C) either directly to the client PC (5A) or through a powered USB Hub (6D).

ADA Codes

Said system performs in harmony with the dentist because it operates on the most basic level of the dental office—the ADA Codes. Said system utilizes a number of associations with the ADA Codes. By using these relationships, said system can automatically generate data that reoccurs with every procedure.

For situations where the association is incorrect, said system compensates by adding convenient overrides available on an individual basis. The ADA Code centric way of looking at the way technology should be used in the dental business is unique and give said system the ability to fully automate everything outside the basic performance of the dental procedure. The following sets forth how the ADA Code relationships operate in various areas of the dental office visit.
a. Fees
The most obvious use of the ADA codes is to have them dictate the fee schedule. A certain procedure costs a certain amount. This is the basis on which the ADA Code structure was founded. It provides both the dentist and insurance company an easy way of managing their fee schedules. There is also a module whereby the dentist can raise or lower individual fees, groups of common fees, or all fees by a set dollar amount or a set percentage amount.
b. Procedure Time
Said system has incorporated the length of time an ADA Code requires to enhance scheduling features. This automates the length of any visit and makes it fail-proof; therefore a staff person always gives the proper amount of time for any specific or group of procedures. The total procedure time is also automatically carried over to the schedule giving the proper block out time frame so one cannot overlap nor double book appointments by mistake into the schedule.
c. Quantity of Visits
Some ADA Codes require multiple visits to the office. As a result said system is designed to prompt users to schedule that follow up visit, the required time and the time between visits—further helping the staff manage both the Office and the Patient's schedule. Said system has the ability to make any single visit a multiple visit thus simplifying the creation and management of the follow-up visits.
d. Prescriptions
The ADA Codes can also determine whether or not a prescription is required for that procedure. While a definitive prescription cannot automatically be written, the codes can make suggestions. Typically, a dentist only needs to provide four types of medication including analgesic (pain relief), antibiotic, anti inflammatory, and steroidal. By determining which type or types are required for a particular ADA Code, said system can make this association. Furthermore, the Patient's medical history and allergies can be cross-referenced with the Physician's Desk Reference (PDR) to determine if there are any drug interaction warnings or other health alerts. Once the dentist “writes” the proper script for that Patient visit, this script can be automatically e-mailed to the pharmacy of choice for that Patient (or have the system print out the script locally to give to the Patient). This information is also automatically written into the Patient's dental history with all pertinent information. Also as a part of system definition, the user is given a generic list of frequently used medications and its proper dosages and instructions where the dentist can simply select the proper medication(s) for the Patient.
e. Homecare Instructions
Procedures requiring homecare instructions automatically print the needed materials for the Patient at the end time of visit. The user is able to manage the association and creation or modification of these instructions as part of the system definition.
f. Treatment Notes
Since dentistry is founded upon standard procedures, it follows that for each dentist there is a corresponding standard way to perform these procedures. This can help in the documentation of the clinical work by allowing said system to automatically fill in the Patient treatment notes with the standard scripts associated with a particular procedure in the particular way in which a dentist performs. During each visit, the user may make Patient-specific adjustments and additions.
g. Radiographs and Photographs
Full documentation for both medical and legal purposes and for Patient education and dentist diagnosis and planning treatment is necessary. Taking radiographs or photographs is the best way to create this documentation, including dental claims, dental history documentation, planning treatment, Patient education and marketing and sales. The key is to take the radiographs or photographs in digital form in the simplest manner as part of the natural flow of the office/Patient procedure and then utilize the digital artifacts in many aspects (such as part of the dental claims documentation, planning future treatments, etc) in a streamlined fashion. Using said system's technology adaptation to ADA Code association, the type and number of digital images (both radiographs and photographs) are predefined as part of the Patient's visit while giving the user the flexibility to add or subtract the number of either types as needed. The key is to be able to simply and efficiently take the images and reuse the information within the system.
h. Insurance Claim Requirements
All insurance companies accept a standard ADA claim form and the current ADA Codes said system uses. If there is a need for documentation beyond these codes and simple descriptions, said system will prompt the user through the various interfaces (such as the Patient's visit, planned treatment, checkout) to generate or collect the necessary artifacts (either information or digital artifacts). After the necessary information has been collected, the system will then print the claim along with the other artifacts at the end of the Patient procedure (part of checkout).
i. Insurance Estimates
The ADA Codes are also associated with Patient claims to track how much a specific insurance company is willing to pay for the procedures on a particular claim. Said system sets default values based on the initial fee schedule; however, each time a claim is processed, the insurance coverage for each code is updated for that insurance company by group number. By doing so, said system has a highly accurate process of estimating insurance coverage that requires no manual maintenance. After a few months of use, said system will be able to estimate based on what the insurance company has actually paid and not guess what the insurance company will pay based on percentages like other systems.
j. Supply Management
For each and every standard procedure, a certain type and amount of dental supply is used. These vary according to the scheduled visit as each supply type is linked directly to an ADA Code. At the setup in the office of said system, a full office supply audit is made along with the individual amounts per procedure of each product used in that office performing dentistry. As procedures are done, the amount or number of items is deducted from the full supply, and when that amount reaches a preset threshold, the suggested supply order reminder is shown in said system. Each item is listed with the amount to order, the supplier, who the order goes to, and an option to modify the order. Then this order is automatically sent to the suppliers. Once the order is received, it is opened up again and the amounts of the items are placed into the area of total supplies and it disappears from the order.

Operation and Functionality

TABLE 1
Front Desk: Main View

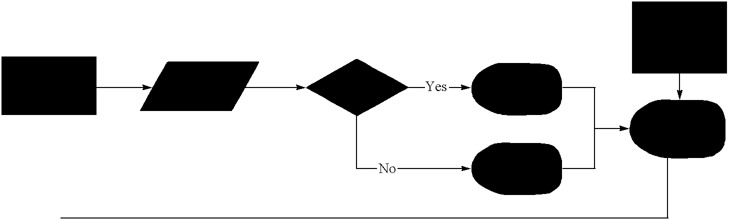

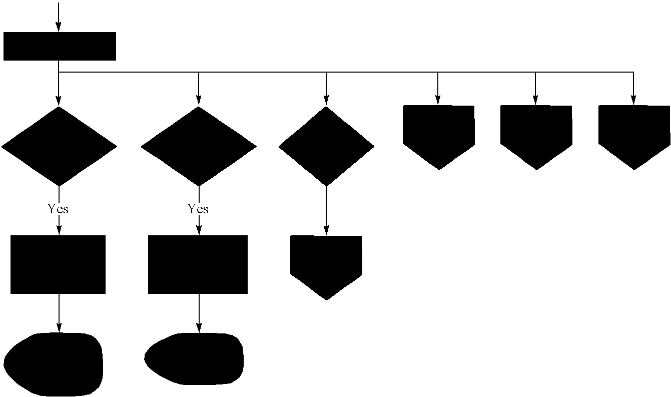

#100: Front Desk main view

The front desk main view is the area of the program where the staff performs the back office chores both daily and otherwise for the smooth running of the office. Various functions may be performed. It also displays the list of today's Patients to allow the user to access in-depth Patient information and the day's visit chart in order to view and complete the visit at any given time during the work day in a quick fashion.

Since there is constant communication from Patients to the office in two main arenas, in person in office and on the phone, this view can become functional with regards to scheduling Patients, answering their questions, etc. Thus, in an instant, the staff performing the daily back office functions can quickly and efficiently switch between Patient care and management through this screen.
#101: Name of screen active. (Table 1)

#102: The calendar icon. This allows the user to move through the months and dates efficiently to schedule Patients or view the specific date in question. (Table 2)

TABLE 2
Front Desk: Main View: Schedule

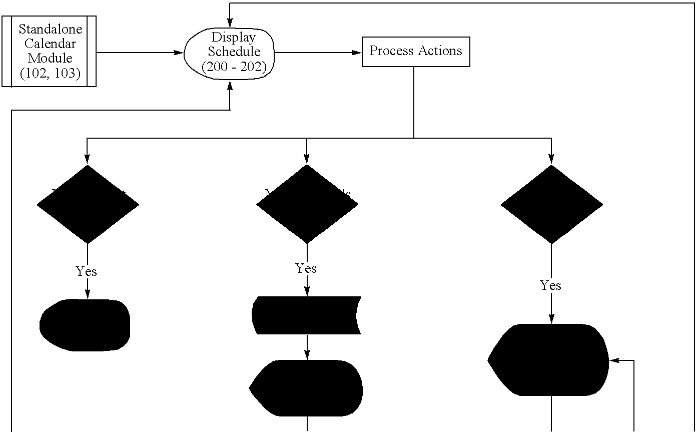

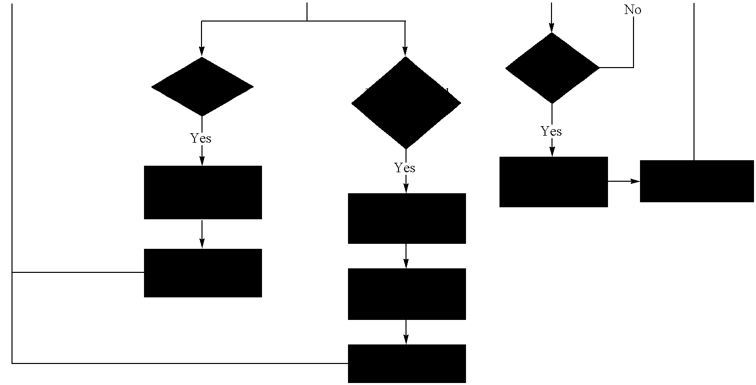

#103: Arrows are provided to move from month to month either forward in time (such as by use of a right arrow (not shown)) or backwards (such as by use of a left arrow (not shown)). As the arrow is selected the schedule pops up in the viewing area where previously the Patient list was seen. (#200) (Table 3)

#104: Pressing any number in the calendar icon displays that particular date in the schedule view (#200). (Tables 1 and 3)

TABLE 3
Front Desk: Patient Search

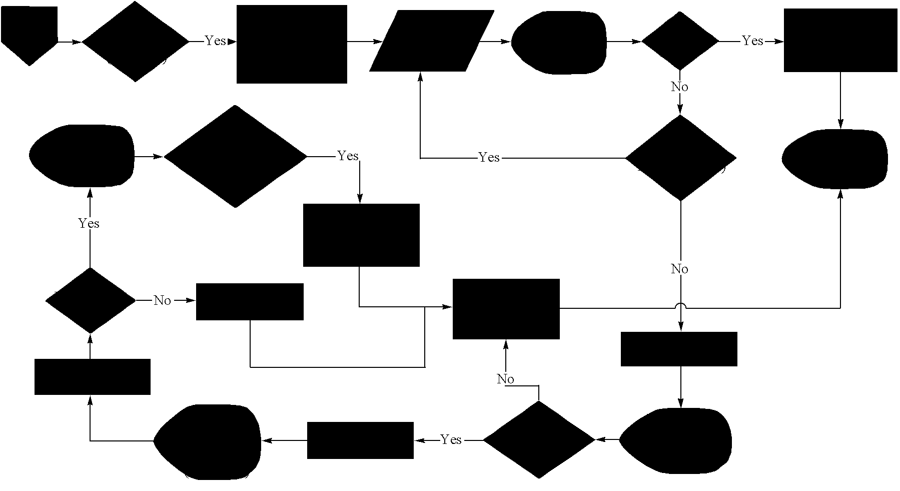

#105: Patient search icon. This area gives the user the ability to search for a particular Patient's chart by last name (#106) or phone number (#107) (Tables 3 and 5). The phone number entry area (#107) can also be linked to the office telephone such that the program will capture the caller ID phone number (if available) and then the user is shown either that particular Patients' information or a list of Patients linked to that phone number (usually a family of Patients, associated by guarantor). Selecting the GO button (#108) will bring up the search results (#300).
   The search results show the Patients' information with three choices:
#301: Select a Patient by selecting any part of the horizontal bar (highlighted when the mouse pointer is over the area) brings the user to that Patient's At-a-Glance view (#400) as discussed in more detail below.
#302: If the Patients' chart is not listed, one can select to search again to include inactive (deactivated) Patients by checking the “Include inactive Patients” checkbox. This will bring up any Patients within that search parameter who may have been marked inactive deactivated) by the office.
#303: New Person button. This is for creating a new Patient chart in case the person does not exist in the Office's records. Once this button is clicked, and referral information is obtained, as discussed below the user is given a new screen to enter in the minimal information set to create a new Patient for the Office (#500).
#500: All pertinent information is gathered and entered in the appropriate field. Once the information is entered, the “Referred By” (#501) drop-down menu is used to track how the new Patient came to the office. The list of choices can be modified in the Office Setup section.
When the user selects an option other than “Patient” (#502), the user must select “Create Patient” (#508) to complete the New Person process. A new Patient record is then created and the At-a-Glance screen (#400) is displayed for the newly created Patient record.
If “Patient” (#502) is selected in the “Referred By” drop-down menu (#508), the system displays the referral Patient search screen (#503). The user must enter the last name of the Patient in the search text box (#504) and click the search button (#505).
Patient referral search results (#506) then appear with the list of Patients with the matching last name. The user must select the proper record by clicking on the underlined last name (#507). Once the name of the referral is selected the program creates a new Patient chart for that new Patient and the At-a-Glance screen (#400) is displayed for that new Patient (See Table 23).

#106: Daily functions (Tables 4, 5, 6, 7, 8, 9, and 10). This is the section where the office performs daily business tasks to check on cash flow, outstanding billing, Patient treatment needed, insurance tracking, etc. These reports are displayed in RED at the beginning of the day then GREEN when the tasks are complete on the Front Desk View (#100) (but are always viewable and manageable regardless of display status).

TABLE 4
Front Desk: Daily Functions: Confirmation Call List

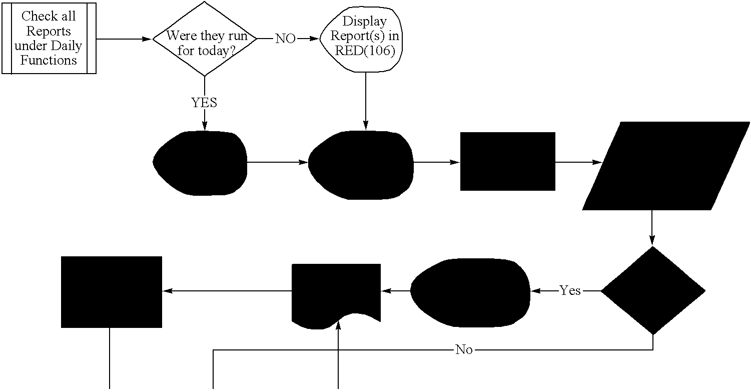

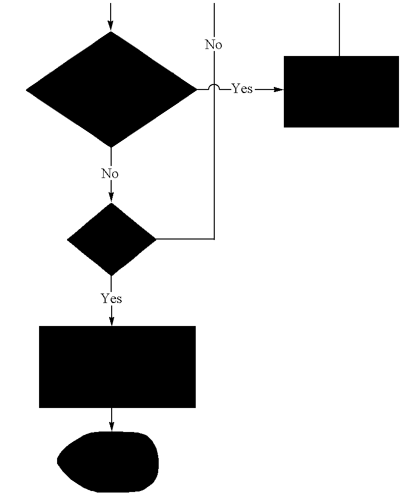

The first item is the Confirmation Calls list (#110) (Table 4). This is an active list; the staff making the phone calls must take action to clear the Patient off the list. The list of Patients is generated from the schedule and past visit information (#110A). This list can be time-changed meaning that some offices confirm Patients 48 hours in advance and some 24 hours. The specific time frame can be changed to fit the office through Office Setup as discussed below.

There are two other pertinent items on the confirmation call list (#110A) (Table 4): The “Pre-Med” marker under the Action column is a reminder that this particular Patient is required to have pre-medication before any dental visit (#110B). Clicking on this marker takes the user to that Patient's chart and to the Prescription Pad area, where the user can then write a prescription for the Patient. Once the Doctor finishes writing a prescription, the slip is automatically printed and the event is recorded into the Patient's Dental History.

The main area on the Confirmation list (#110A) is the drop down menu under the Action column (#110C)—displayed as “Scheduled” by default. This shows the four main options the user has when confirming Patients for future appointments. The user confirms, leaves message or reschedules the Patient. Choosing confirmed or left message removes the Patient from this list and marks the visit as “Confirmed”. This change in visit status is reflected in the Front desk view (#100) under the heading Status (#136) (Table 4) for that Patient's visit. Choosing reschedule will take the user directly to that Patient's chart and into the Planned Treatment section (#419A) (Table 4) with that particular visit at the top of the list in the “Planned Visits” section (#419A2) (Table 1). This report shows up RED in color initially then once it is completed for the day, turns green in color on the Front Desk view (#100).

TABLE 5
Front Desk: Daily Functions: Overdue Recare Call List

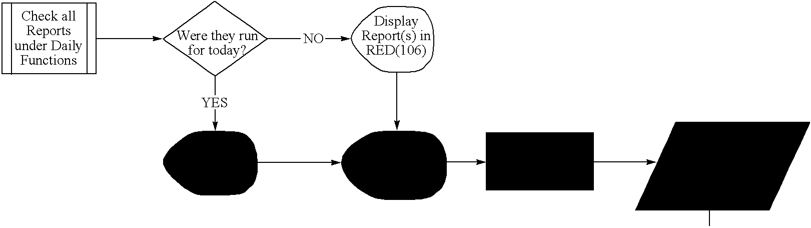

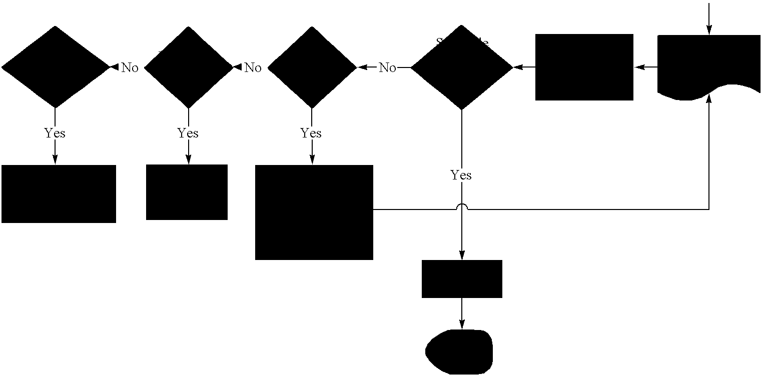

The next report is the Overdue Recares call list (#111) (Table 5). It shows all the Patients who are overdue for their recare date by one day (#111A). It provides all contact information to the user for each listed Patient to get them in the schedule for the overdue recare visit. The drop-down menu under the Action column (#111B) has these options for the user to select: Schedule, Call back later, Left message, No answer, Deactivate, Do not contact. Call back later, Left message, No answer (#111C) are temporary selections where the Patient will drop down to the lower section of this report called Previously Contacted in order to be contacted at a later date (#111D) (Table 5). Selecting Deactivate (#111E) (Table 5) takes the user to the Patient's At-a-Glance view (#400) and clicking on the Active button (#400B3) will put the user through the Deactivate Patient process (#424). If Do not contact (#111F) is selected, the Patient is removed from all call lists. This report shows up RED in color initially then once it is completed for the day, turns GREEN in color on the Front Desk view (#100).

TABLE 6
Front Desk: Daily Functions: Post-Op Call List

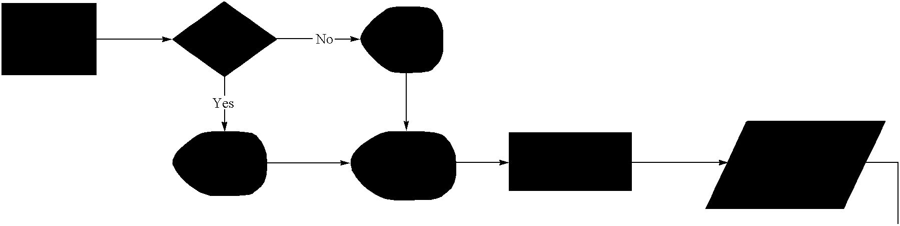

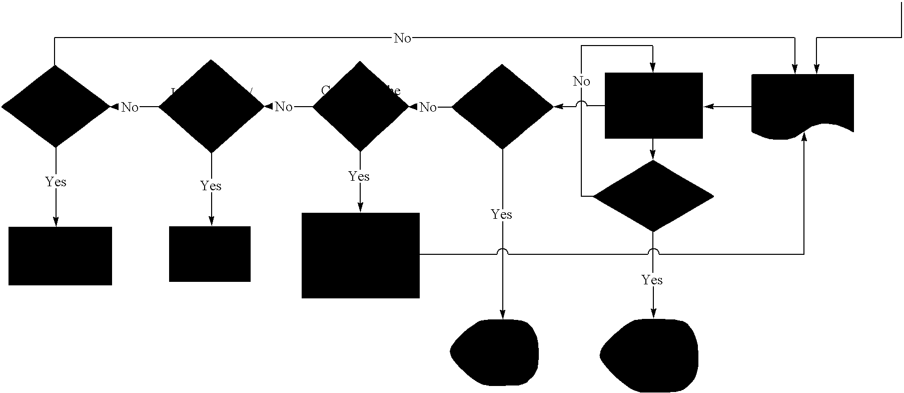

The next report is the Post Op call list (#112) (Table 7). This is a general list to follow up on all Patients for that day after their visit. There are three main sections within the list; “Incomplete Visits” (#112A) lists all Patient visits from either today or previous days that were not completed. The next section “Previously Failed Calls” (#112B) displays all unsuccessful attempts to contact the listed Patients. “Today's Outstanding Calls” section (#112C) displays those Patients who were in the office today and need to be contacted. This list will help the office from losing Patient contact if used on a daily basis.

The drop-down menu under the Action column (#112D) shows all choices for the user. “Called” means that the user has contacted the Patient. “Left message” or “No answer” moves the Patient to the “Previously Failed Calls” section (#112B). “No Call Needed” removes the Patient from the list. Selecting “Called”, “Left message” and “No Answer” writes the event into the Patient's Dental History as such. The text box (#112E) is initially populated with that visit's treatment notes. This is to give the caller a way to view relevant information for calling. This information may also be changed and modified with additional information gained from the call or through review. The Patient will remain on the list if the user chooses “Keep on List” from the drop-down menu (#112D).

Post Op Calls List (#112) shows up RED in color initially then once it is completed for the day, turns green in color on the Front Desk view (#100).

TABLE 7
Front Desk: Daily Functions: 30 Day Recare Letters List

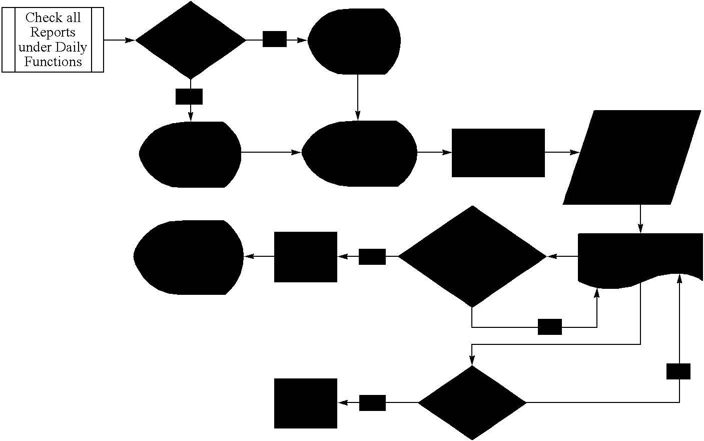

30 Day Recare Letters List (#113) (Table 7) is a list of all Patients whose next recare date is exactly 30 days from the current date. This activity should be repeated every day to make sure that all Patients with scheduled recares are notified of their upcoming visit. This report gives the users the ability to print all recare notifiers for mailing by selecting the “Print Recare Letters” button (#113A). To close the window is the “Close” button (#113B).

This report shows up RED in color initially then once it is printed for the day, turns green in color on the Front Desk view (#100) but can be selected again to print if needed for the remainder of that day.

TABLE 8
Front Desk: Daily Functions: 30 Day Statements List

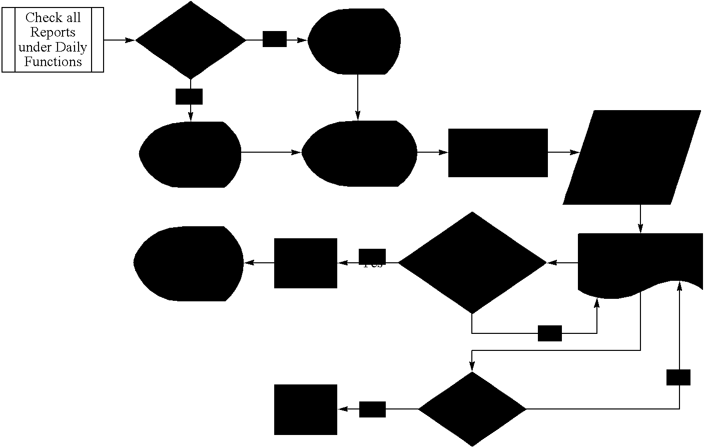

30 Day Outstanding Statements List (#114) (Table 8) is a print report of all overdue statements that are 30 days outstanding and/or have not had any financial activity for 30 days. They are printed when the user selects the “Print” button (#114A). The close button (#114B) closes the window. This report shows up RED in color initially, then, once it is printed for the day, turns green in color on the Front Desk view (#100) but can be selected again to print if needed during that day.

TABLE 9
Front Desk: Daily Functions: 30 Day Pending Insurance Call List

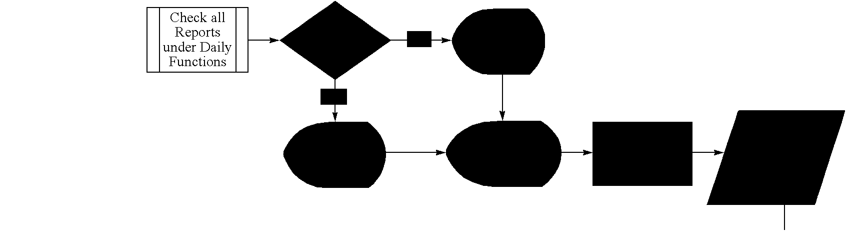

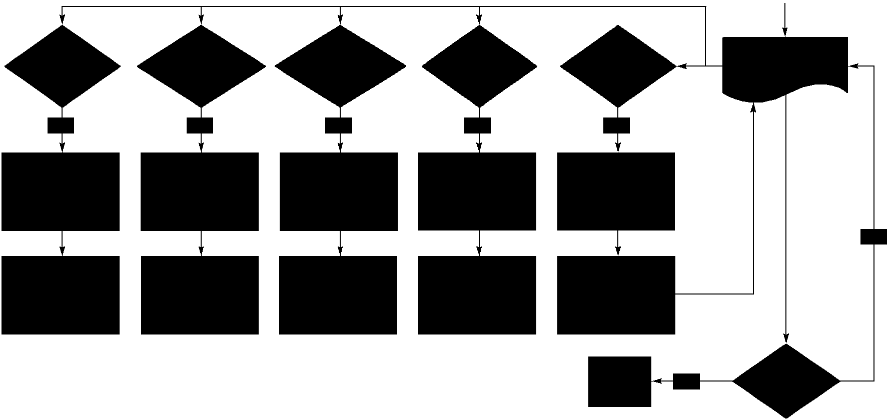

30 Day Pending Insurance Call List (#115) (Table 9) is the list that contains all Patients who have pending insurance claims and outstanding balances for 30 days previous to current date. It is a call list where the user contacts the insurance company for each of the listed claims for the individual Patient. The insurance company's response dictates the choice from the drop-down menu under the Action column (#115A). The first option is “Resubmit Claim” (#115A) which reprints the ADA claim form for the listed visit, takes the Patient off the list and places the Patient's claim record in a 30 day rotation again. The next option is “Denied” (#115B) where the Patient's record is taken off the list and a statement is printed to be sent to the Patient showing his insurance claim for the visit is denied, and seeking payment. The third choice is “Payment Sent to Patient” (#115D) where the Patient is taken off the list and sent a statement; this selection assumes the insurance company sent the payment to the Patient. The next is “Payment Sent to Office” (#115E) where the Patient is taken off the list and put into the 30-day rotation again. The last is the “Paid to Patient” (#115F) where the Patient is taken off the list and sent a statement for the balance.

TABLE 10
Front Desk: Daily Functions: Today's Financial Report

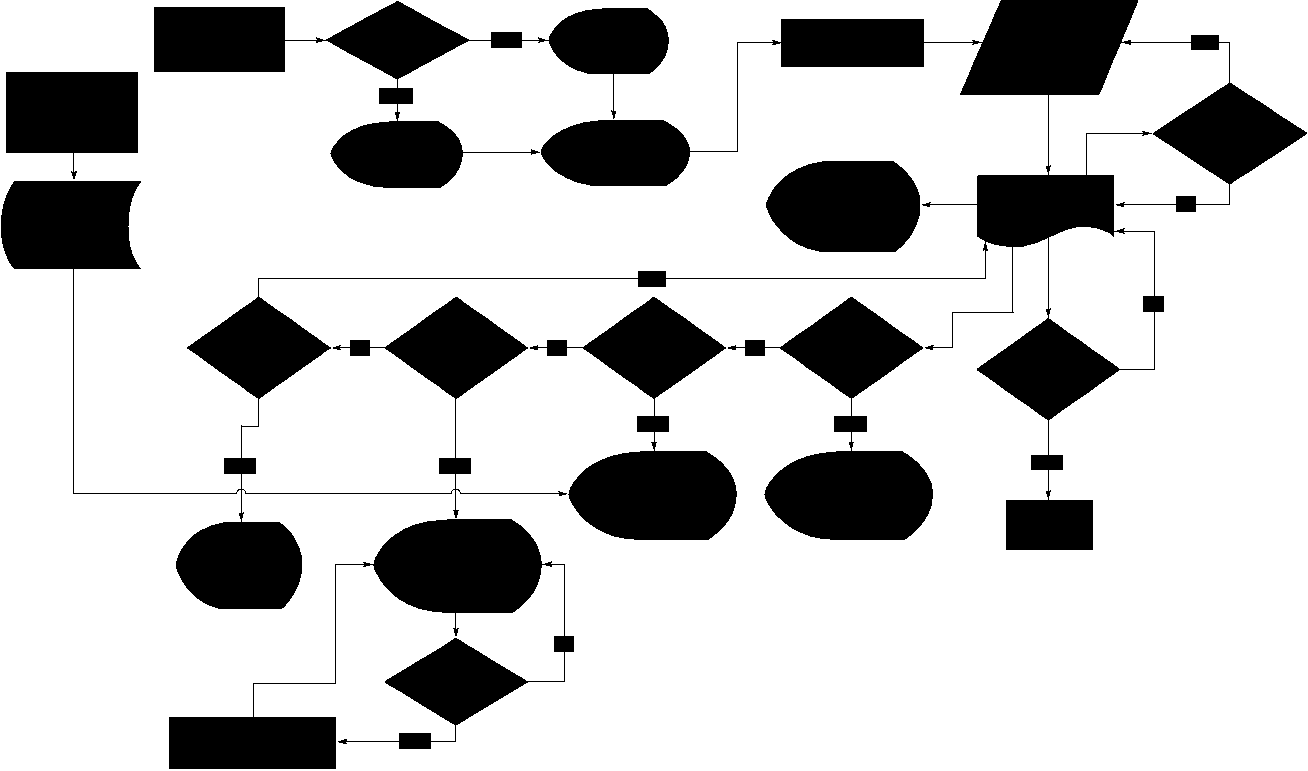

The last of the Daily Function Reports is Today's Financial Reports (#116) (Table 10).

When selected, the system displays the financial summary for the day (#116A) to the user. The main screen consists of overview sets of information: The top header displays today's date, below is the date range search (#116A5), subtotals for the day (#116A6), and below the four types of information you can view for all financial information that is collected in the system.

The first view is Production vs. Collection (#116A1). Selecting this displays production numbers vs. collection for each visit (by Patient name) for the day (#116A1.1). The top displays a quick summary (#116A1.2) and below is the list of visit information (by Patient) (#116A1.3). The user can also view the details of the individual transactions by expanding the view (#116A1.4).

Next is Scheduled vs. Ledger (#116A2). When selected, this section gives the user information to detect possibly fraudulent financial transactions for that day (#116A2.1). The system automatically records the scheduled production in every visit at a set time for that day; any change in the scheduled production from that time until the end of the day for that visit is recorded as a difference (either positive or negative) in this report. The top section gives the summary (#116A2.2). Below are the line items for each Patient visit (#116A2.3). The user may view the details of each visit by expanding the view (#116A2.4).

Next is Total Collection (#116A3). When selected it displays the total collection numbers for that day (#116A3.1). At the top is the summary of all collections, regardless of type (#116A3.2). The details are below and listed according to the different collection types; cash, checks and credit card (#116A3.3). The user also may print a bank deposit slip by selecting on “Print Deposit Slip” (#116A3.4) as it prints the recorded bank no. for each check given to the Office (#116A3.5).

Next is All Transactions (#116A4). When selected, the report displays all recorded transactions (which include all charged visit codes and amount collected for the visit) for that day (#116A4.1). By default it displays each Patient visit's line item which includes the Patient name and totals (#116A4.2). The user may view each Patient visit's details by expanding the view (#116A4.3). This view is commonly referred to as the day sheet.

On the main view of Today's Financial Report (financial summary) (#116A) are other sections. The user can use the date range search to view all appropriate financial information within a specified time frame (#116A5). The user then can filter/merge the records by selecting on each type as described above.

The section below the date range search displays a quick summary of today's financial information for lookup (#116A6).

On the bottom of the main view is the Office Overview (#116A7); this is the overall Office “At-a-Glance” that compares the current financial year's information against last year's information in three ways—Month to Date, Year to Date, and Week to Date. It also displays the office-set goals to track current progress for the year. The goals are set or changed through the Office Setup section.

TABLE 11
Front Desk: Reports: Complete Financial Report

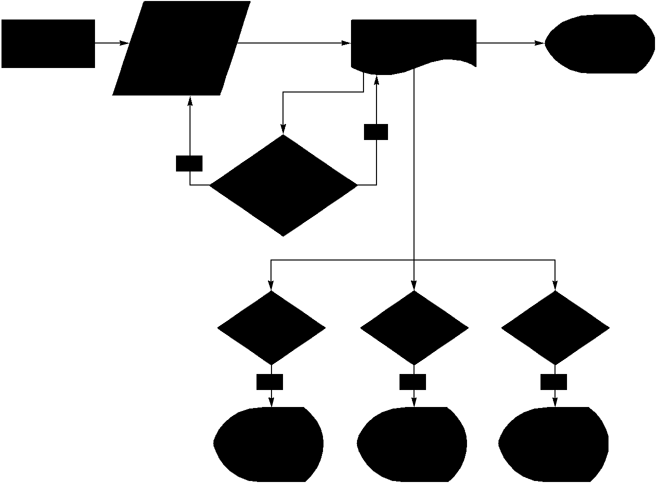

The next section on the Front Desk is Reports (#117) (Table 11).

The first report listed is the complete financial report (#118). This report is searchable by three financial categories; Total Production (118A), Total Collection (#118B) and Total Adjustments (#118C). This report defaults on first view to today's production figures. The user may choose to filter through the categories by selecting the appropriate choice in the solid bar with separate the Production/Collection/Adjustments sections (118E). This will limit the records shown by the type underneath with the appropriate column information displayed by individual Patient. (#118F). On the upper area of the report are the Date search fields (#118G) where the user may enter a date range and get the appropriate information for that time frame. The search button (#118H) activates the search for the entered date range.

TABLE 12
Front Desk: Reports: All Overdue Recares

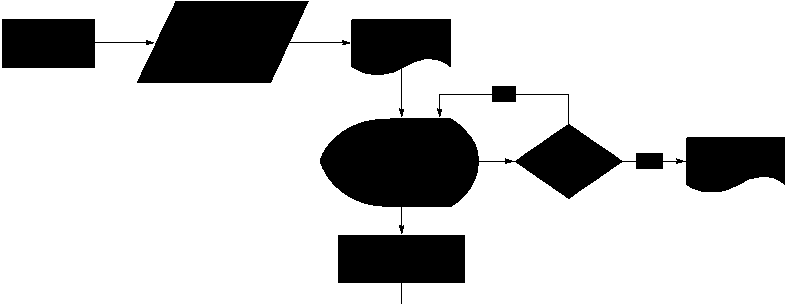

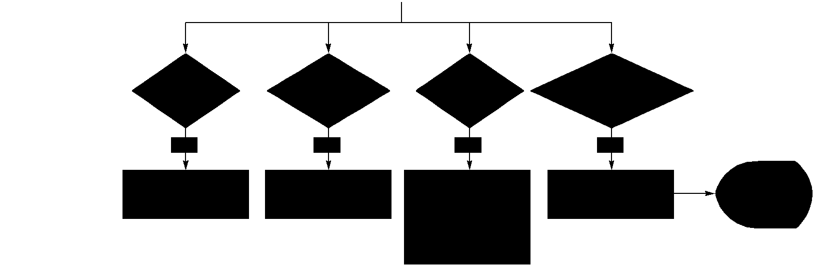

The next report is the All Overdue Recares (#119) (Table 12). It displays a list of all Patients who are overdue for their recare visit based on the individual's recare cycle (3, 6, 9 months) and the last recorded recare visit in the system. The drop-down box under the Action column (#119A) is for the user to record the result of a phone call as the previous recare call list (#111B).

The purpose of this report is to maintain Patient contact so that they do not “fall through the cracks” and to have the Patient return to the Office for continuing care.

TABLE 13
Front Desk: Reports: All Outstanding Balances

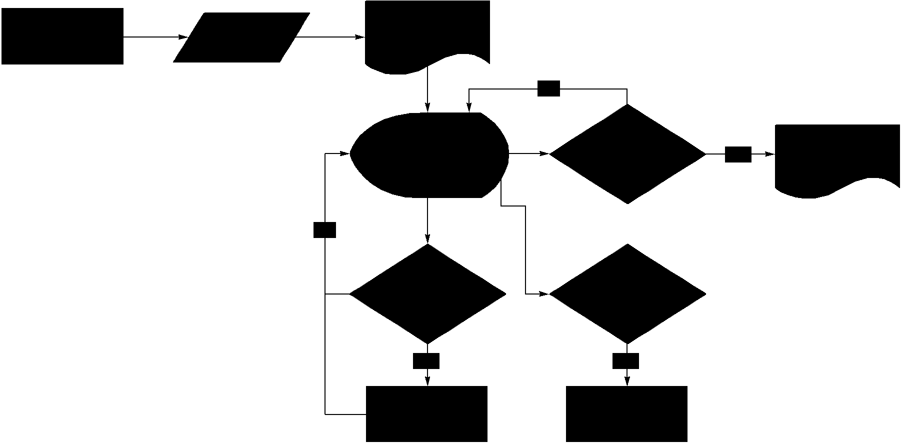

The next report is the All Outstanding Balances (#120) (Table 13). This is a list of every Patient with outstanding balances. Selecting the “Print” button on the bottom (#120A) will print individual statements for each Patient listed preferably in a 3-fold letter format (to be mailed). The close button (#120B) closes the report. Selecting a highlighted row line item will take the user to that Patient's At-a-Glance screen (#120C).

TABLE 14
Front Desk: Reports: All Outstanding Insurance Report

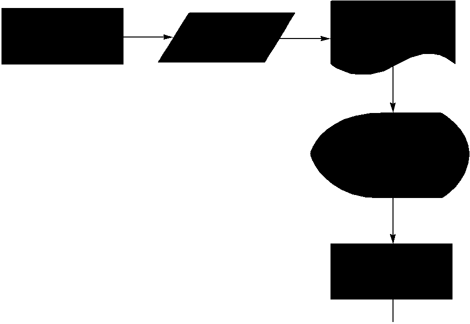

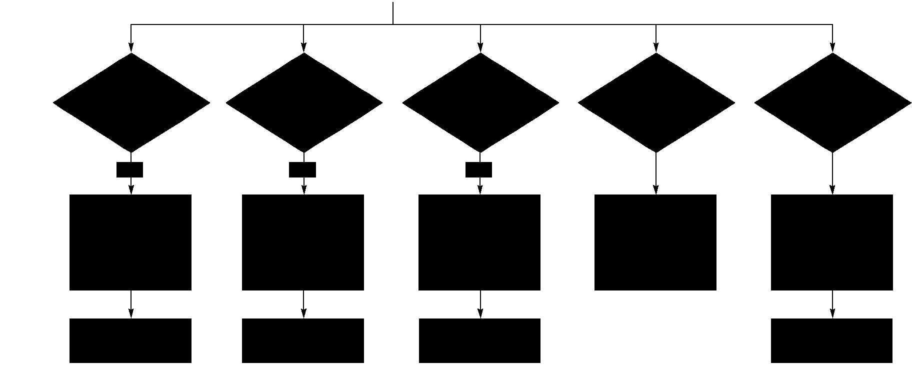

The last report in this section is the All Outstanding Insurance report (#121) (Table 14). This is a call list where the user must contact the insurance company and record the appropriate action taken in the drop-down menu under the Action column (#121A). The first option is “Resubmit Claim” (#121A) which then reprints the ADA claim form for that visit. This takes the Patient off the list and places the claim in the 30-day rotation again. The next option is “Denied” (#121B) where the Patient is taken off the list and a statement is printed to be sent to the Patient showing his claim status as denied and the Office seeking payment. The third is “Payment Sent to Patient” (#121D), where the Patient is taken off the list and sent a statement for collection. The next option is “Payment Sent to Office” (#121E) where the Patient is then taken off the list and put into the 30-day rotation again. The last is the “Paid to Patient” (#121F) where the Patient is taken off the list and sent a statement for the balance.

TABLE 15
Front Desk: Utilities: Bulk Insurance Payment

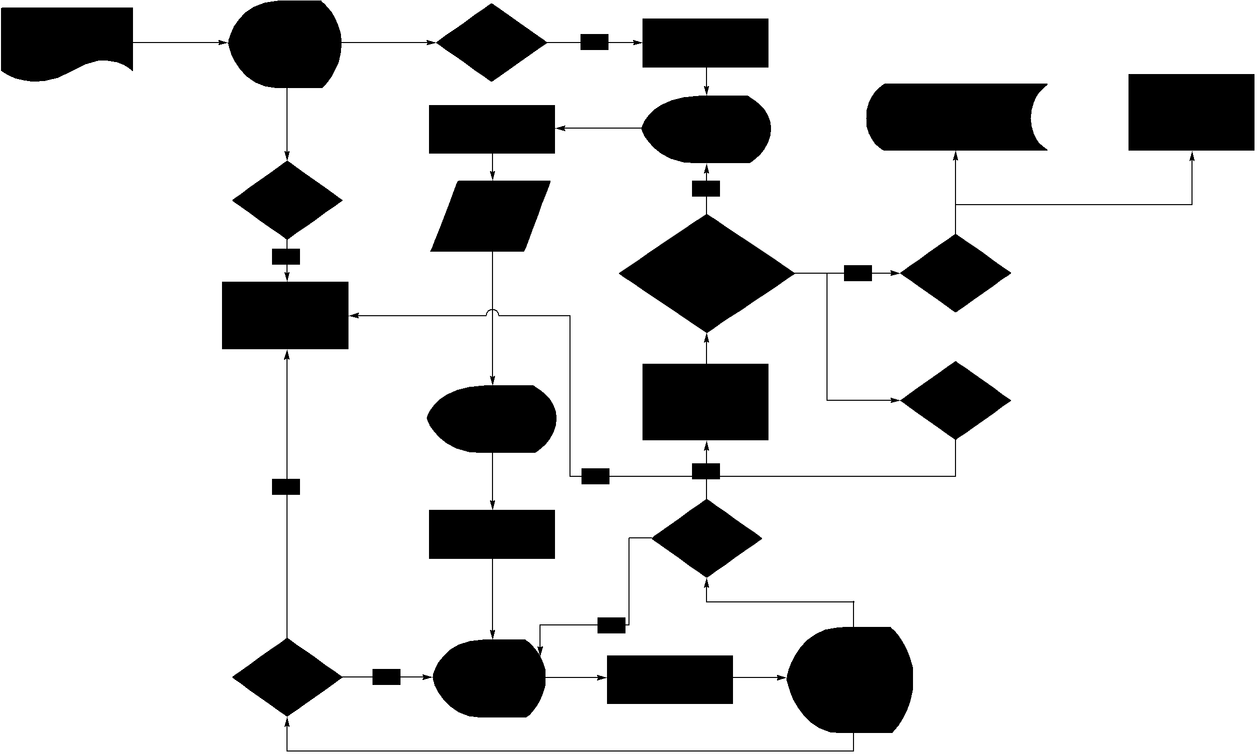

The next section is Utilities (#122) (Table 15). The first utility is the Bulk insurance check payment view (#123). When the link is selected, the user obtains the first bulk insurance payment information view (#123A) of a series. The user needs to enter the total amount of the check (#123A1), the check number (#123A2), and the bank number (#123A3). The user can cancel (#123A4) at any time and it will bring the user to the front desk view (#100). Once all the information is completed the user will select “Submit” (#123A5) and a Patient search screen is displayed (#123B) as the second step of the process. The user must enter the Patients' last names (#123B1) on the bulk check singly. When the user selects the “Search” button (#123B2) it will display all matching names of Patients (#123B3). The user must then select the proper Patient highlighted line item (#123B4) which then displays all outstanding insurance claims for that Patient (#123C). The user must then select the appropriate date (#123C1). Then the user must enter the payment amounts for each ADA code (#123D1) in the displayed “Enter payment amounts” view (#123D). If the user opts to cancel the process at this point (#123D2), the window is closed and the user is returned to the main Front Desk view (#100). By selecting “Submit” (#123D3) the user saves the entry as part of the bulk payment process (#123E).

The user must enter all amounts for each Patient listed on the bulk insurance check (#123F). The amount of the check and the amount the user has entered are tallied in the upper right (#123F3) of the view to ensure that the amounts match. The user will not be allowed to finish a bulk insurance check process unless these two amounts match.

TABLE 16
Front Desk: Utilities: New Patient Form - at Office

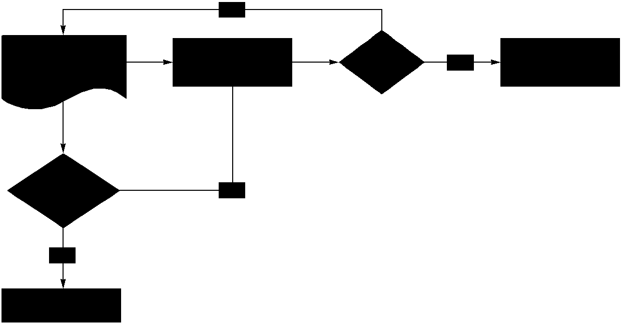

TABLE 17
Front Desk: Utilities: New Patient Form - Web

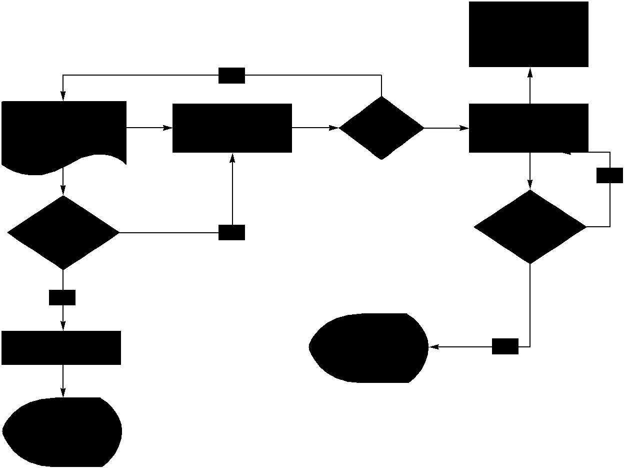

Next is Print New Patient Form (#124) (Tables 16 and 17). This displays a pre-generated PDF file to fill out new Patient information either on-screen or to be printed and information entered by hand. It can also be filled out on-line over the internet by locating the form under the internet sub-domain assigned to the Office. In the cases of filling out the form over the internet or on the computer in the office, this data is checked for errors and then entered in to the system.

The information is as follows:

Personal Information
Account Guarantor Information
Employer/school Information
Primary Insurance Information
Secondary Insurance Information
Medical History with electronic signature/date
Financial Arrangements Agreement with Patient's name printed taken automatically from Personal information and electronic signature/date.

Photography Release with electronic signature/date.

TABLE 18
Front Desk: Utilities: ADA Code Variables

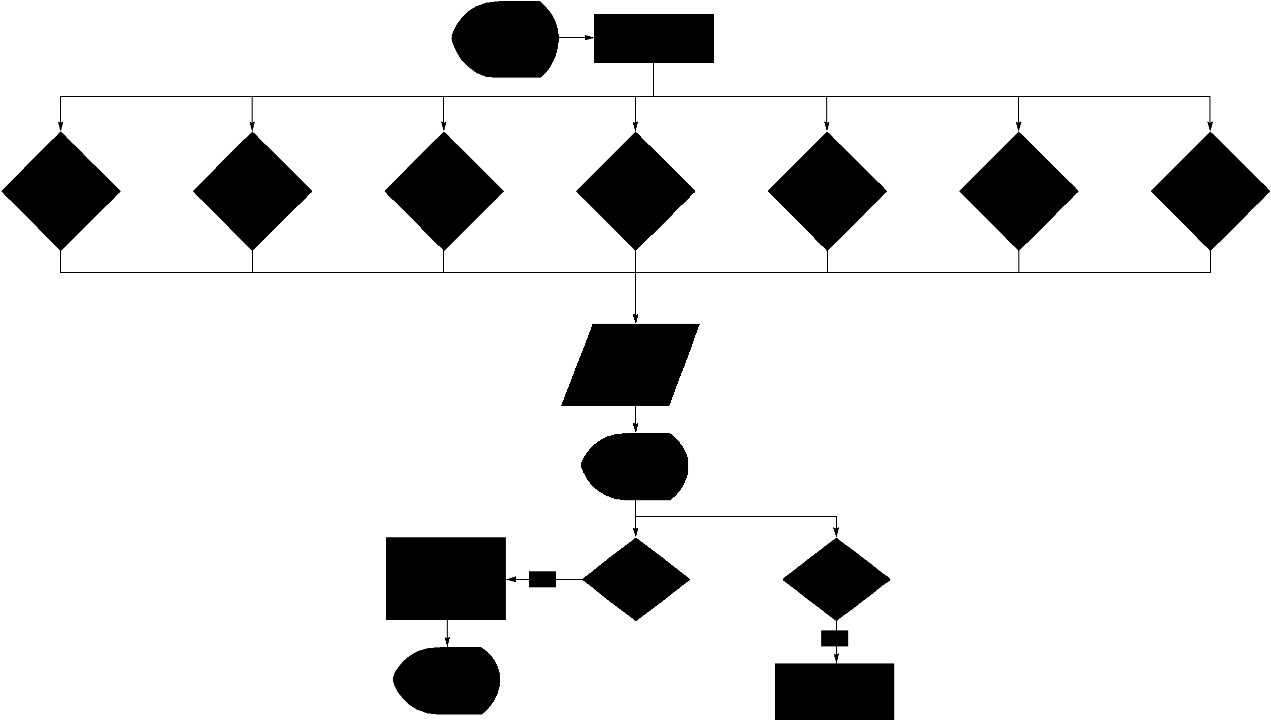

When the user selects the ADA Code Variables (#125) (Table 18) from the front desk, the system will display a new window (#125A) with a selection bar (#125A1) where the user can select to edit these different types of information in regards to the ADA codes:
Fee
Procedure Length
Number of Visits
Generic Name
Prescription Required
Homecare Instructions
Automated Treatment Notes

When the user selects an information type, the full ADA code list is displayed at the Class level.

The ADA codes are arranged in a three level hierarchy: Class, Type, and Code, respectively. Each level can be expanded by selecting on the [+] icon next to the level label. The user can then change the values accordingly at either Type or Code level. After making changes the user must select on “Save Changes” in order to save changes made. If the user decides to select “Close” or manually close out the window the view will be closed without saving changes and the user is returned to the Front Desk main view (#100).

TABLE 19
Front Desk: Utilities: Office Setup

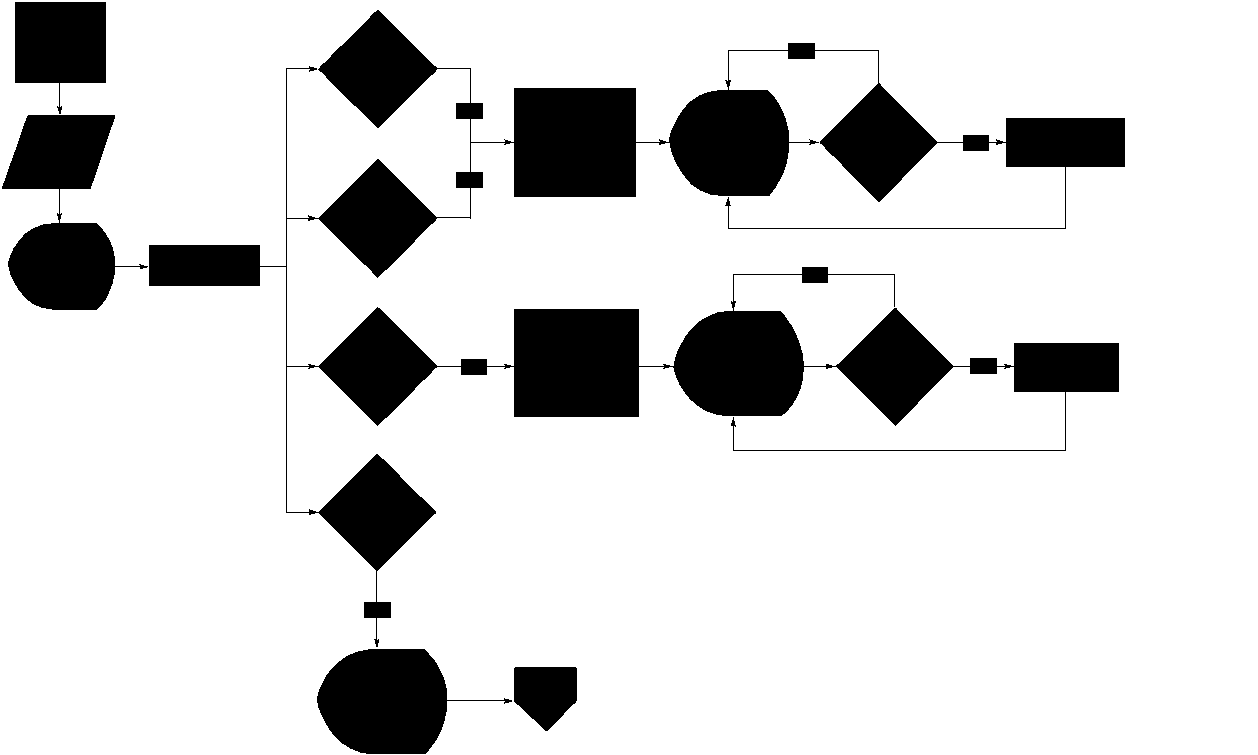

The last section in Utilities is the Office Setup (#126) (Table 19). Office Setup is important, as the information captured and managed is important for much of the automation in the system. This section is also what a new user will see first as part of the install/setup process. The user must fill in all appropriate information such as the Office Information, Personnel Information, Office Layout Information, Supply Chain Management [SCM].

When the user selects to change the Office Information (#126A1), the user is displayed with the current values in the system for the Office name, address, and contact information (#126A1.1). The user may change the values accordingly and select on “Save” (#126A1.2) to save the changes to the system. This set of information is used in all system generated printed materials (statement, claims, etc.).

Selecting the Personnel Information (#126A2) from the Office Setup screen displays all Dentist/Doctor and employee information. It displays the main view (#126A2.1) and each personnel type in separate sections with each person's name, role, and contact information in separate line items. When the user selects on a person's row line the system will display a password entry window. This system password is pre-generated and office specific which only the primary Dentist/Doctor knows. If the password is correct, the user is given an editable form to edit or delete that individual's information.

The user may also add individuals by selecting “Add Employee” on the main view of the Personnel Information screen. This will display the password entry window. Once the password has been verified, the user is given an entry form to enter all relevant information. If the person is a Dentist/Doctor, the user must check the box marked “Dentist/Doctor” This action will display the entry field for the Dentist/Doctor's license number. The check box marked “Employee” is selected by default. The user must select “Save” in order to add the person to the system as an Office personnel.

The user may select to change the Office Layout (#126A3). The user may change these two items: Office start and end times and Office Operatory labels. After selecting to change Office start and end times, the user is given a form with two fields to change for the start and end times of a typical business day. The user must select “Save” in order to save the changes. These values must be entered in order for the Schedule (#200) in the system to function properly. If the user selects to change the Office Operatory Labels the system displays a form with the options to change two types of information: Number of Operatories in Office and the Operatory Label for each Operatory. When the user changes the number of Operatories in Office, the number of label field changes accordingly to reflect the correct number of columns needed to identify each Operatory in the Schedule. The user must select “Save” in order to retain any changes to either type.

TABLE 20
Front Desk: Office Setup: Supply Chain Management

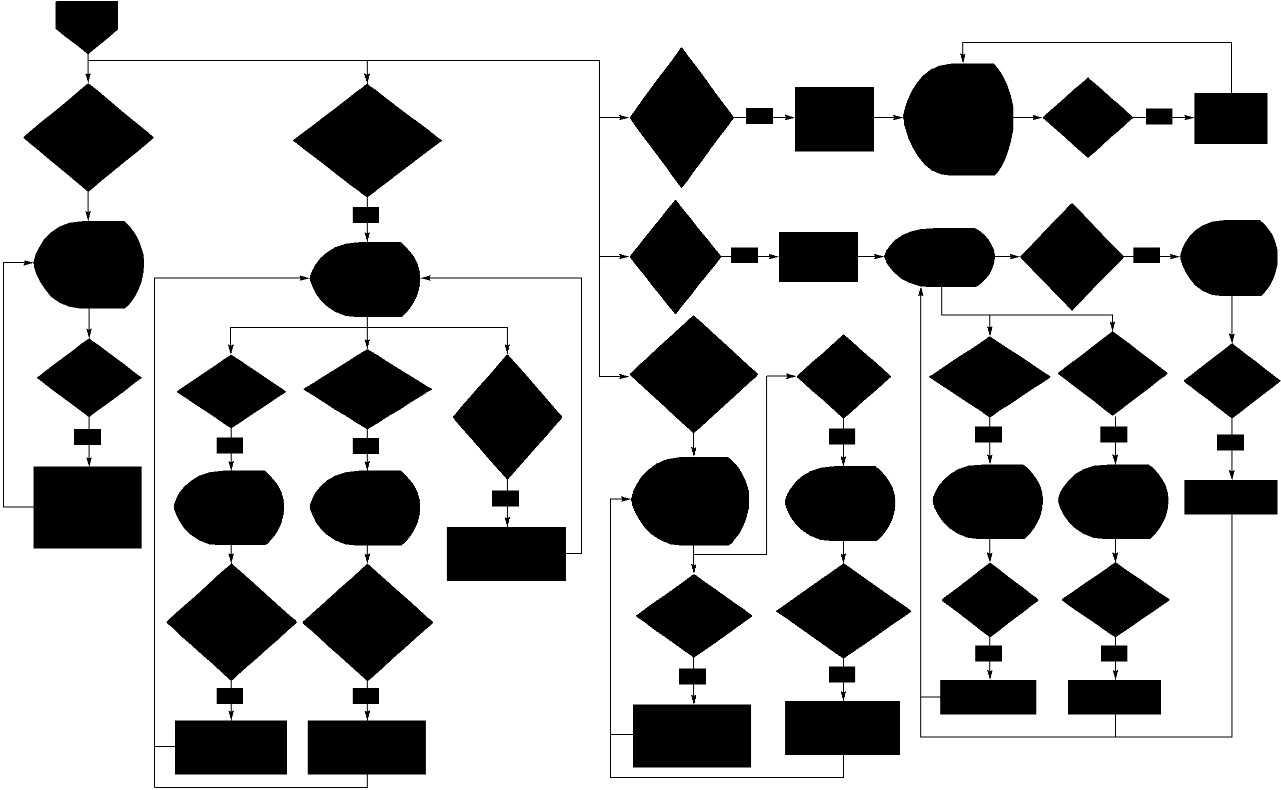

The next information set the user may change under Office Setup is the SCM (Supply Chain Management) module (#126A4) (Tables 19 and 20). This module automates all supply related information, including supply usage and reorder. The system is pre-configured with the generic list of items associated with the current CDT ADA code list and commonly used in a dental office. The user must configure at least the baseline count (if not exact count, a rounded figure) of each item (#126A4.3) on the list in order to activate the SCM.

The system calculates item usage based on the scheduled visits (individual ADA codes) and completion of those visits (is threshold equal to or less than (total count−(base item usage count (completed visits, next week's scheduled visits)−visit items count (completed visits, next week's scheduled visits))). When a certain item count falls under the set threshold, it is added to the item reorder list. This list is updated in the background during every day usage until the user chooses to view and reorder items.

The user has the ability to modify any information set associated with the SCM module through these options:
Update Current Threshold (#126A4.1)
Change Baseline Items (#126A4.2)
Change Item Usage Counts (#126A4.3)
Change Item—ADA Code Association (#126A4.4)
Change Item List (#126A4.5)

The item reordering threshold is managed through the Update Current Threshold (#126A4.1). The user is then given a list of items alphabetically (A to Z, with only items starting with “A” displayed) listed in the system and the current threshold associated per item. The user may change the displayed list by selecting the appropriate first letter in the alphabet list; this will display all items that start with the selected first letter. After making changes to the threshold number the user may save all updates by selecting “Save”.

The user can also change Baseline Items (#126A4.2). This sub-list describes the commonly used items (and count of those items used) for every visit. The screen is split into four sections: on the top is the alphabetical list, current list of items for Baseline Items in the middle, item display underneath and user Options on the bottom. By default the current selection for Baseline Items will be displayed in the middle section. The user then can select on the alphabetized list to view items starting with that letter. In order to add an item the user must select the checkbox next to the item in and select the user Option “Add” in. In order to remove an item from the Baseline Item list the user must select the checkbox next to the item in and select “Remove” from the user Option. In order to change the number of item used, the user must change the numeric value next to the listed item in and select “Save” on the user Option.

When the user needs to change the item usage numbers for items already associated with ADA codes, the user selects Change Item Usage Counts (#126A4.3) from the main SCM view (#126A4). The user then must look up an individual ADA code through the ADA code lookup module. When a single code is selected, the view will expand to display all associated items underneath the code. The user may change the number listed next to the list of items and select “Save”. Selecting “Cancel” takes the user back to the SCM main view (#126A4).

The main portion of the SCM is how the list of items is associated with individual ADA codes. The user may change or create new associations by selecting the Change Item—ADA Code Association (#126A4.4) from the SCM main view. The system displays the ADA code search module which the user can expand to see the three groups (like in ADA Code Variables section). If there are existing items already associated with an ADA code the user will see them listed under the code. In order to associate an item, the user must select the code by checking the box next to the ADA Code then select “Add Item” on the bottom of the section. This will display the full list of items in alphabetical list, organized by the first letter. The user may traverse through the list by selecting the appropriate first letter from the alphabetized list. When the user has found the appropriate item to be associated with the previously selected ADA code, the user must check the box next to the item and select “Associate” on the bottom of the view. This process must be repeated for each item to be associated with that code.

When the user has finished selecting each item to be associated with that specific ADA code, the user must select “Finish” on the bottom of the view. This will bring the user back to the ADA code module with the previously selected items displayed under the appropriate ADA code. The user then may choose a different code to associate other items.

The Change Item List (#126A4.5) is used to manage the list of supply items for the Office. When the user selects this option from the main SCM view the system will display the alphabetical item list (#126A4.5.1). The user may choose to add an item at any type by selecting on “Add” from any view. The system will then display an empty item entry form for the user to enter information. Once complete, the user must select “Save” in order to complete the entry of new item. Once saved, the user is given the list of items starting with the appropriate first letter with the new item in that list. In order to remove an item from the list, the user must select the checkbox next to the item name and select “Remove” on the bottom of the view.

TABLE 21
Front Desk: Office Setup: Patient Newsletter

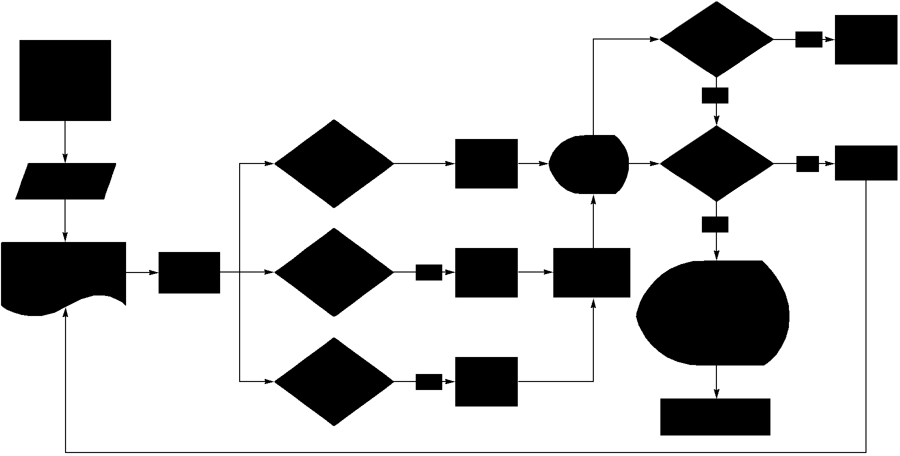

By selecting Patient Newsletter (#127) (Table 21), the user is able to change the content and template layout of the system generated newsletter. The user may type up to 3,000 characters and this content will be auto-filled into the selected template layout for the newsletter (#128). The newsletter is used for bulk mailings to the entire office Patient pool at random intervals set by the dentist in the office setup area (#126).

TABLE 22
Front Desk: Main View

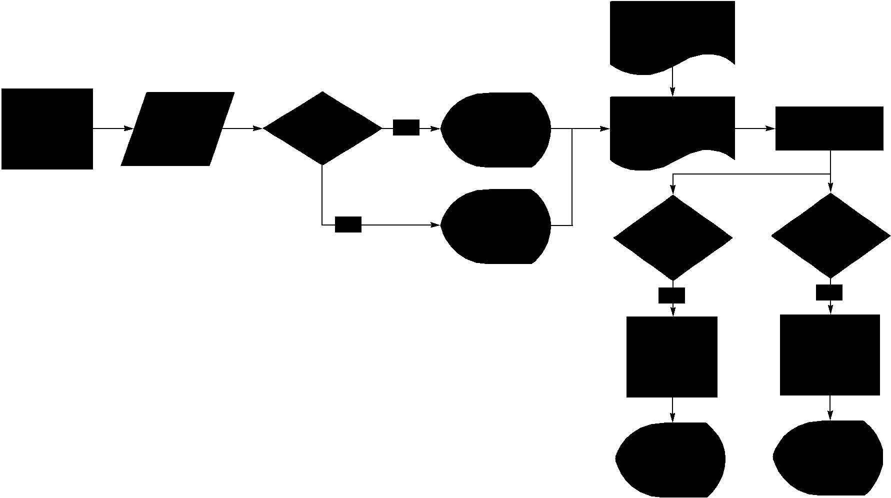

All options on the left vertical bar on the Front Desk main view have been reviewed (#100). From hereon, the center (main) view will be discussed. On the Front Desk main view is the complete list of Today's Patients (all Patients scheduled for a procedure for the day, in chronological order). Each line is a Patient in the schedule that day with the pertinent information needed for quick reference (#129) (Tables 1 and 22). These items are: Picture (#130), name (#131), home phone number (#132), the description of the procedure scheduled (#133), dentist seeing Patient and what room or operatory (#134), the length and time of the visit (#135), and whether that visit was scheduled, confirmed or left message (#136) which comes directly from two sources—from the Confirmation call list (#110) or the appointment details content (#205) under status (#205E) in the Patient chart icon (#205) in the schedule (#200). The whole line (#129) is an active button which takes the user to that Patients' At-a-Glance screen (#400). This line is displayed in gray when the visit has been completed or cancelled.

TABLE 23
Front Desk: Main View: Schedule

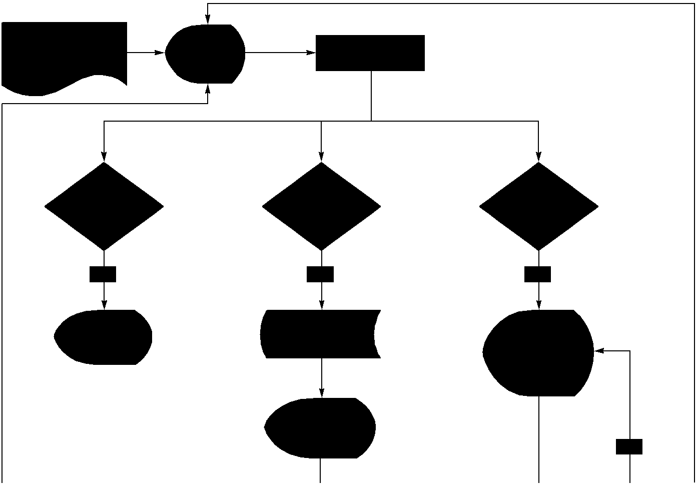

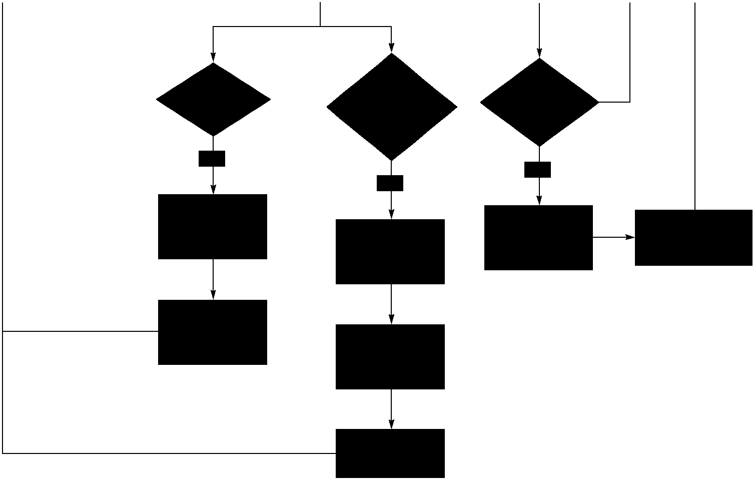

When the user selects and mouse clicks on a specific number (the day) on the calendar module (#104), the system displays that day as a grid schedule in the central area (#200) (Tables 2 and 23). The Y-axis (#201) is arranged in time at 10-minute intervals and the X-axis across the top (#202) is separated into Office Operatory Labels. These values can be customized in the Office Setup (#126A).

Clicking on the bar with the individual Patient's name (#203) goes directly to that Patient's At-a-Glance view (#400). The “Move” icon (#204) lets the user move this particular Patient's visit anywhere on that day or any other day by a drag and drop method. The Details icon (#205) gives the user quick access to all the details needed about this Patient with regards to this visit. When the user selects the “Details” icon (#205) the system displays a small window with these sets of information: Patient's personal information (#205A), Appointment information (#205B), a list of all procedures to be performed (#205C), the total fee to be charged (#205D) and the Status icon (#205E) discussed previously which gives the user the ability to change the status of the visit and alert other areas of the program.

TABLE 24
Patient At-a Glance Main View

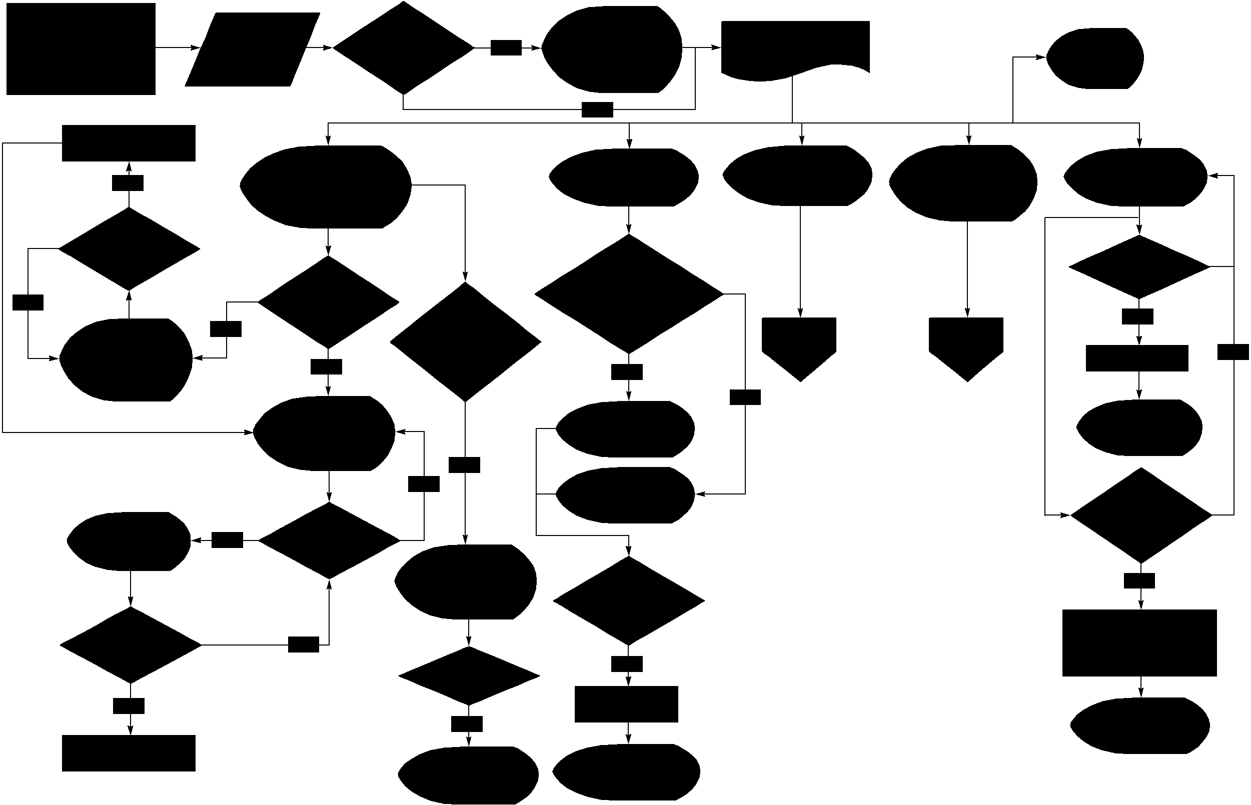

At-A-Glance (#400) view is a central view in that follows the unique business process of centralizing the single money-making event in the dental office—the dental visit or procedure (Table 24). It is the first view displayed after creating a new digital Patient chart and it is the first view displayed when opening an existing digital Patient chart. The main purpose of this view is to answer the most common questions Patients frequently ask the dental office personnel with regards to their treatment, insurance, billing and balance, appointment, and future needs. Any office staff member, including the dentist, can answer any question the Patient may quickly by accessing this view. It is also designed to allow the user to navigate to more detailed information if the Patient desires easily and efficiently. But more importantly, this view allows the user to directly schedule a Patient for the central money-making event, the dental visit. Again, central to the business process is the dental visit or procedure where all money is produced and all information is generated and collected digitally into the Total Digital Dental Record™ (TDDR™).

The main area (#400A) of the At-a-Glance (#400) is the area below the header. The header (#400B), which was discussed previously, is a constant while viewing any Patient chart.

The header (#400B) contains the Patient picture (face image)(#400B1), Patient name (#400B2) Patient status (active/inactive) (#400B3), all contact numbers where the Patient can be reached (#400B4), the Patient address (#400B5) and a conditional warning in case the Patient needs pre-medication for dental work (#400B6). This is discussed in detail in the Medical History section (#409). The header gives the user basic information that is used frequently while conversing or contacting the Patient.

TABLE 25
Patient At-a Glance: Insurance Information

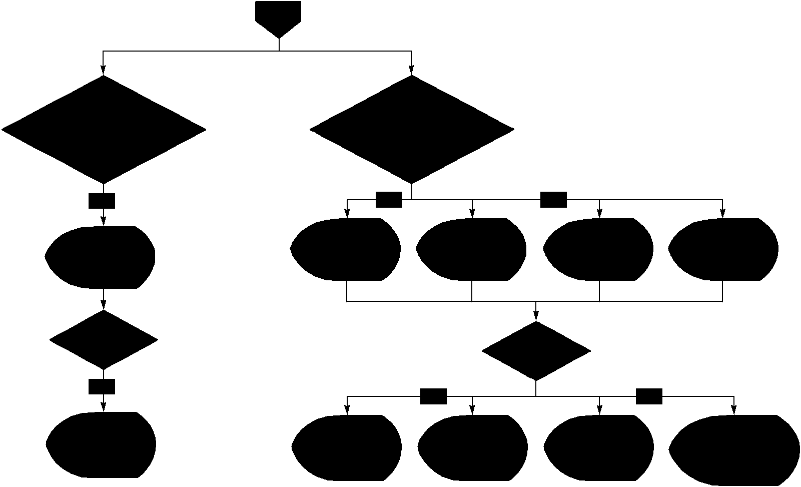

Patient At-a-Glance [AAG] or the Patient Chart (interchangeable terms) (#400A) (Tables 24, 25, and 26) is where all pertinent information relating to the Patient is located. The options on selecting to view or modify different information sets are on the right and the main display area is in the center, below the header for the Patient. The details of the main display area include:
Financial Information (#400A1)
Insurance Information (#400A3)
Clinical Information (#400A10)
Notes (#400A19)

The first section is Financial Information: Account Balance (#400A1). This gives the balance outstanding in RED and any credit in GREEN. The account balance line (#400A2) is linked to the account history detail (#411)—meaning that clicking on the “Account Balance” label takes the user to the Account History view.

The Insurance Information section (#400A3) gives all the pertinent data on that Patient's insurance including Carrier (#400A4)—which is linked to the Primary Insurance (#406), employer (#400A5)—which is linked to Employer/School (#405), Group Number (#400A6)—which is linked to the Primary Insurance (#406), and Total Benefit Usage (#400A7)—which is linked to Primary Insurance Policy Information (#406A1.1). If the Patient has secondary insurance the information would appear below and all links would be the same except it would apply to Secondary Insurance (#407).

On the bottom of the Insurance Information section is the Pending Insurance Claims (#400A8). This lists all outstanding insurance claims by date, group number and status. The header is linked to Collect Insurance Payment (#413A) which displays all pending insurance claims for that Patient. The date of the claim (#400A9) is linked to that particular date of service claim payment window (#413A2) that is discussed under the Insurance Payment section (#413).

TABLE 26
Patient At-a Glance: Clinical Information

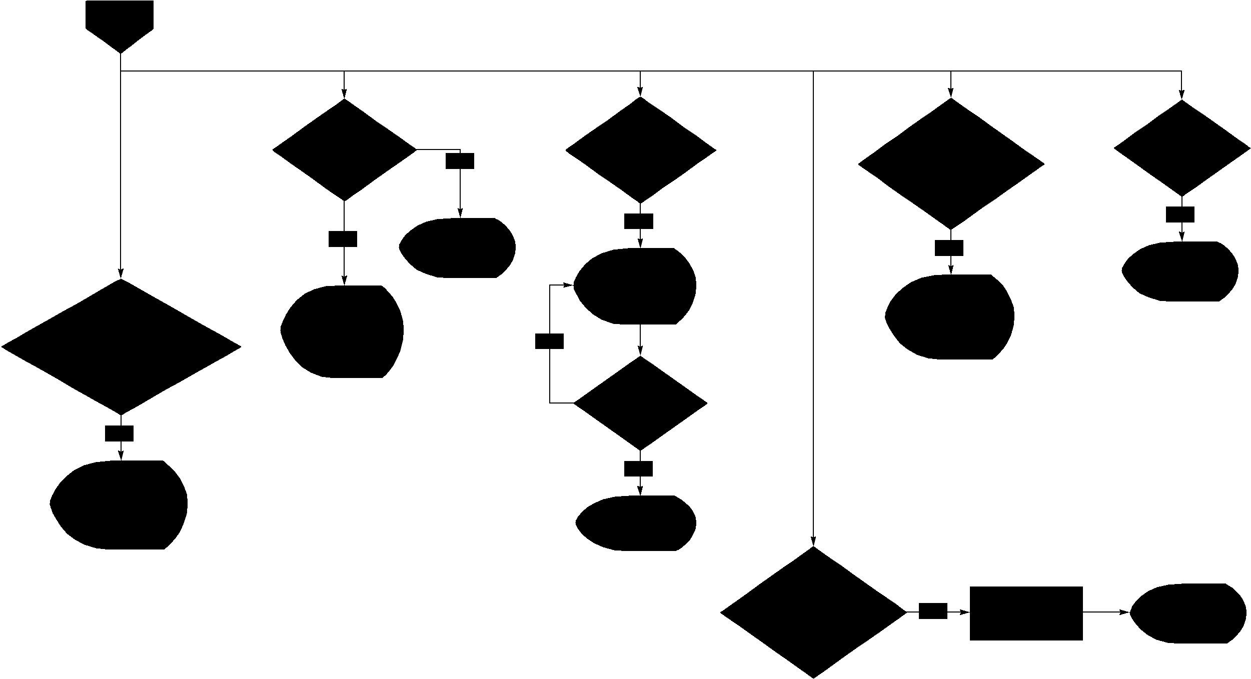

The Clinical Information section on the main AAG view (#400A10) has to do with outstanding treatment. The subsection displays planned treatment (#400A11) (which the header is linked to that Patient's planned treatment screen (#419A)), next recare date (#400A12) (the date is displayed in green if scheduled or “Overdue” in red if not scheduled). It is actionable in either case; if recare has been scheduled, then selecting the date will display the schedule and if recare is not scheduled, selecting the “Overdue” will create a chunked recare visit in Plan Treatment, and display the Plan Treatment view. Under Next Visits (#400A13) is displayed all scheduled visits for the Patient. If selected, the system will display the schedule for the visit (#202). Other (#400A14) lists outstanding planned treatment for the Patient (#419).

Other family members (#400A15) are listed below the primary Patient with all the same information. The Patient's name is linked (#400A16) to his or her chart.

This related information allows the user to quickly answer any Patient questions and schedule them rapidly for appointments for the Patient or a relative/dependent.

Next subsection is Schedule Patient (#400A17) which allows the user to schedule a Patient for the most frequently grouped codes the system designates as “SuperCodes”. It is a drop down menu (#400A18). When a “SuperCode” is selected from the Patient's AAG, the system will display today's schedule and the selected “SuperCode” Visit as floating box to place in the schedule (like scheduling a Plan Treatment). The list of “SuperCodes” can be managed through the Office Setup section (#126). This rapid scheduling module is one of the many TD Firsts in dental technology (#200).

The notes section is a text area for the user to enter information needed for the treatment of the Patient or for better practice/Patient management. There are two actions the user can make after entering information: “Save notes” saves the text in the notes text area, while “Save Notes to Dental History” saves the content into the Patient's Dental History record (#418) along with the date and time stamp.

The “Patient Requires Pre-Medication” notice is a link to the Patient's prescription pad (#422).

Referrals section describes by what means the Patient got to the Office and/or whom they referred to the office as well (this comes from the drop down menu of referrals (#501) on New Patient information (#500A)). The “Close Patient Chart” closes the window and displays either the schedule (#200) or the Front Desk main view (#100).

The AAG main view (#400A) also has selectable header links for Financial Information, Insurance Information (#400A3), and Clinical Information (#400A10). When selected, the general Office policies (Office philosophy, financial policy, insurance policy general care) are displayed for each type. These policies can be updated or changed in the Office Setup section (#126).

The left hand column (#401) on the Patient Chart/At-A-Glance screen (#400) contains the different types of information as related the Patient's Digital Dental Record. The sections are:
Patient Information
   Personal
   Guarantor
   Employer/School
   Primary Insurance
   Secondary Insurance
   Physician
   Medical History
Financial Information
   Account History
   Transfer Balance
   Insurance Payment
   Payment Center
   Account Correction
Clinical Information
   [Today's Visit]
   Dental History
   Plan Treatment
   Transfer Last Recare
   Prescription Pad
Utilities
   Print Full Chart
   Print Insurance Claim
   Print Statement
   Veneers, Lab Slip

For each section and type of information, the user is able to view and then change or take actions accordingly to each type.

Patient Information (#402) contains all the information gathered at the beginning of creating the digital Patient chart (#124).

TABLE 27

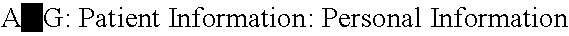

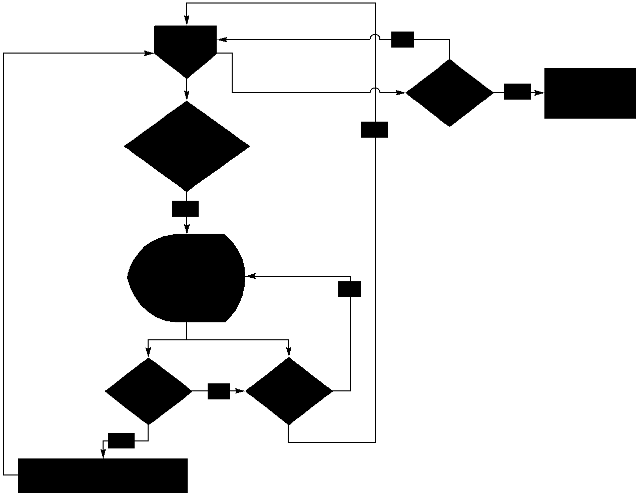

The Personal Information (#403) contains all Patient-specific information—name, address and contact information in the main view (#403A) (Table 27). The user may change this information by selecting “Change Information” (#403A1) on the bottom of the view. When selected, the form will display editable fields with the current information (#403B). After editing, the user may save changes by selecting “Save” (#403B1) or “Cancel” (#403B2) which reverts the information from the previous save. If the user changes the option “Referred By” dropdown (#403B3), the user will be prompted through the same process of selecting the person who referred the active Patient (same steps from Create New Patient (#501)).

TABLE 28
Patient Information: Guarantor Information

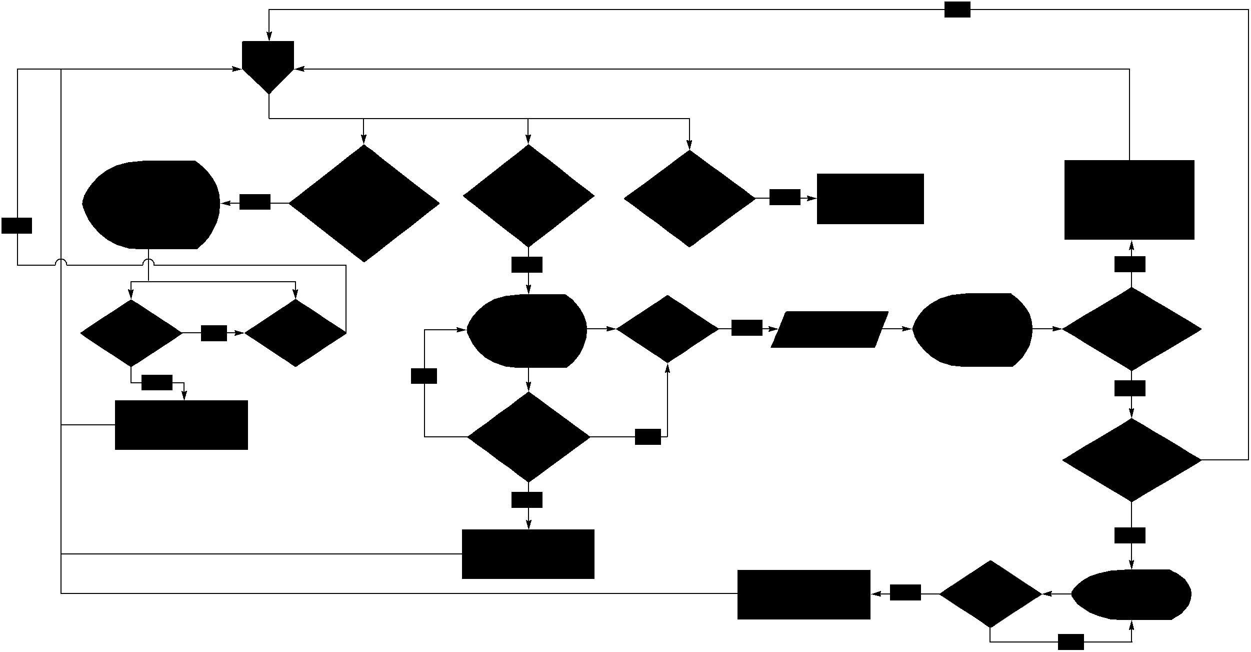

The Guarantor section (#404) contains all information related to the Guarantor/Guardian (person responsible) of this Patient (#404A) (Table 28). By default it will display the previously recorded information for the Patient (if information has not been entered it will be empty). The user may select “Return to chart” (#404A2), “Edit This Information” (#404A3)—which allows the user to change the current information in the edit view (#404D), or “Change Guarantor” (#404A1) which allows the user to select a different person as Guarantor (#404B). There are two choices on this view, “Search” (#404B1), which is used to search the database for the name of the guarantor already entered in the system. This will return a list of Patients (#404C) that match the search string with their name, address, and primary contact information. The last name of each listed person is linked (will highlight when mouse cursor is moved over the last name) so selecting on the last name will choose that person to be the Patient's Guarantor; this will also return the user to the Edit Guarantor Information view (#404A). The user can also select “Self” (#404B2) to mark the Patient to be his or her own Guarantor. Checking this will insert this Patient's information into the Guarantor Information (#404A) and displayed as such. This information can be edited further by selecting on “Edit This Information” (#404A3). When selected, the fields will become editable. After making changes, the user must select on either “Save” (#404D1) or “Cancel” (#404D2).

Note: If the an existing Patient is selected as the guarantor for the active Patient, (#404C) and edited in the Edit Guarantor Information view (#404D), the updated information will be displayed for that Guarantor's Patient digital chart and for anyone else under that Guarantor's listing.

There may be situations where the Patient's Guarantor is not in the database. If this is true, the user must select on “New Person” on the search results screen to create the person as in Create New Patient process.

TABLE 29

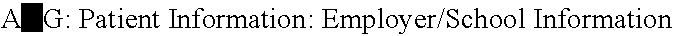

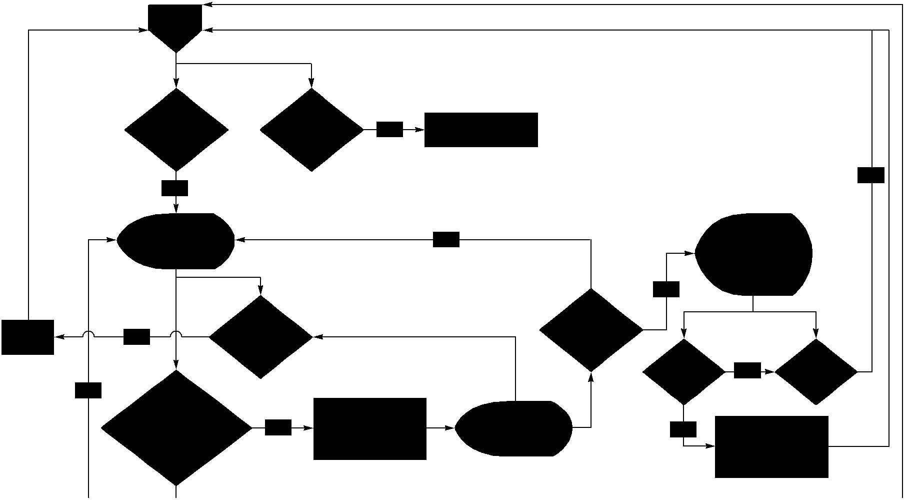

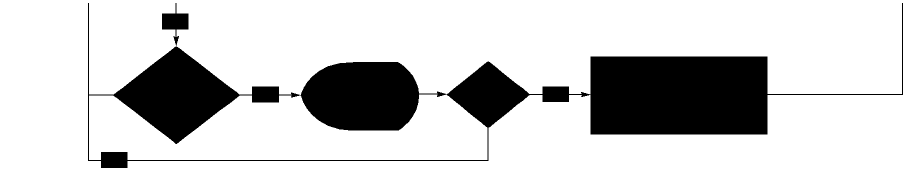

Next selection is Employer/School (#405). Selecting this will bring up the Employer Information view (#405A) (Table 29). On this are two options for the user: “Return to Chart” (#405A2) and “Change Employer” (#405A1). Selecting “Return to Chart” (#405A2) takes the user back to the main At-a-Glance/Patient Chart (#400). “Change Employer” (#405A1) allows the user to select a different Employer/Business from the view (#405B). The user then may change the Employer by selecting on a different name from the drop-down list which is alphabetized (#405B2). After selecting a name, the user will see all pertinent information change accordingly (e.g. address #405C). If the information is correct, the user must select “This is Correct” (#405B1). This action then will take the user back to the Employer Information view (#405A). If the displayed name is correct but contains incorrect address or contact information, the user must select “Edit This Information” (#405C2). The user will then be able to modify the record's information accordingly (#405D). After making changes the user must select “Save Information” (#405D1) which records the information and takes the user back to Employer Information (#405A). If the user selects “Cancel” (#405D2) the user is taken back to Employer information (#405A) without saving changes.

If the Employer is not listed in the drop-down list (#405B2) the user may create a new Employer record by selecting “Add Employer” (#405B). The user is given an empty form for the user to fill out for the new Employer (#405E). After filling in the information, the user must select “Create Employer” (#405E1) in order to save the new record. If the user decides to discard the new record, the user must select on “Cancel” (#405E2) which brings you back to Employer Information (#405A) without saving the new record. If a new Employer record has been created, the user is taken to the main Employer/School view (#405A) with the new record already selected.

TABLE 30

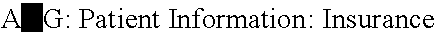

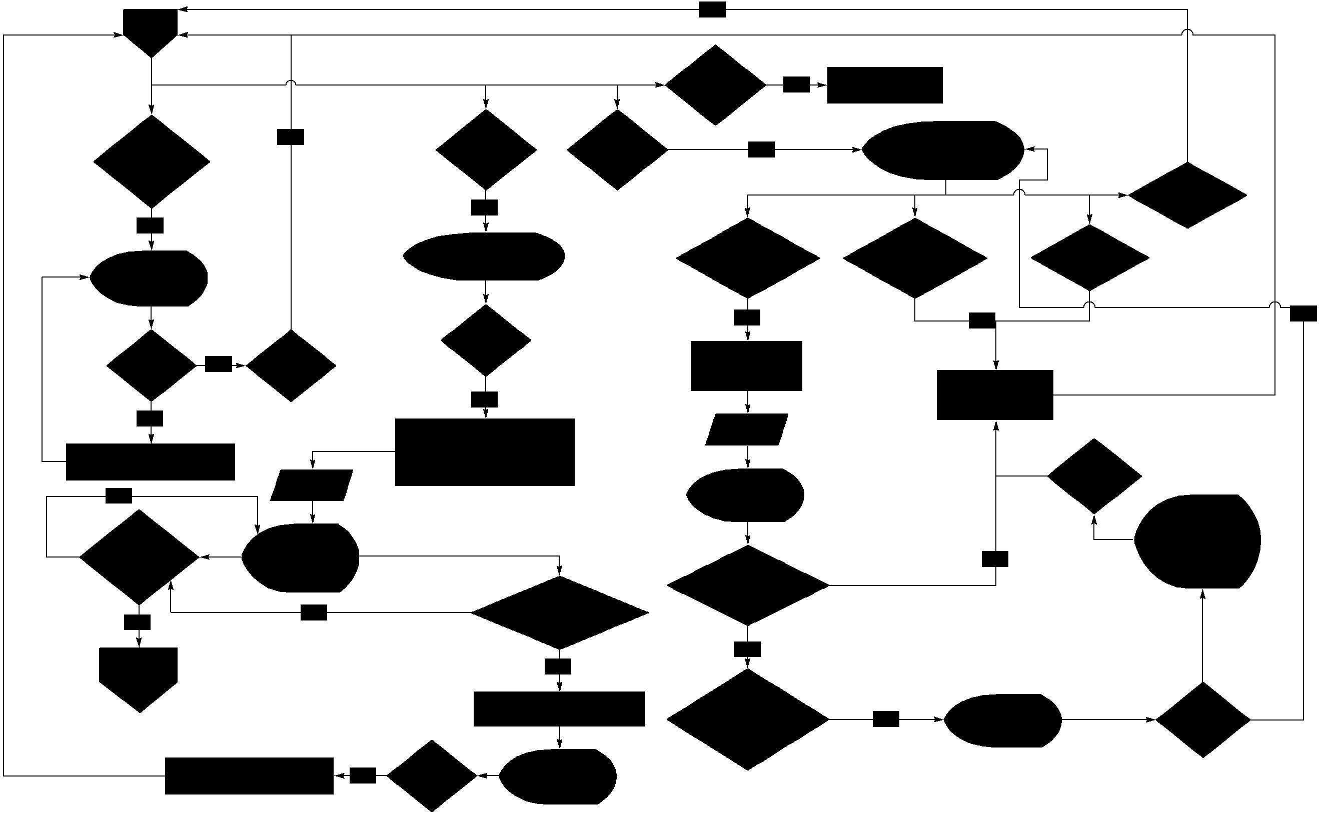

Next subsection is the Primary Insurance (#406) (Table 30). By selecting this, the user may view all Primary Insurance information for the Patient in the PI view (#406A). The Insurance information is broken into three sections: Policy, Subscriber Information, and Carrier Information. Under Policy, the user is given the Policy Number and the Patient's Relationship to Subscriber. There is also “More Policy Information” (#406A1) which when selected displays the user Primary Insurance-Policy Information (#406A1.1). This is where the specific policy information for benefits is recorded to be used in the Insurance Payment Estimates within the system. The user must select on “Save” (#406A1.3) in order to save the changes. If the user selects “Cancel” (#406A1.2), the changes are discarded and the user is taken back to the Primary Insurance Information view (#406A).

The Subscriber Information section contains all Subscriber related information. Under the Subscriber is the Carrier Information, which is linked to the Subscriber and the Policy Number.

In order to change the Subscriber, the user may select “Change Subscriber” (#406A2) on the bottom of the PI view (#406A).

“Change Subscriber” (#406A2) displays to the user the PI: Subscriber Search view (#406A2.1). The user may enter in the last name of the Subscriber to search or select on either “Self” (#406A2.1.2) or “None” (#406A2.1.1). Selecting on either “Self” or “None” check boxes will immediately enter the applicable information (the Patient's own information or none, respectively) and display the Primary Insurance Information view (#406A) with the selected Subscriber information.

If the user is searching the system for the Patient's Subscriber, the user must select the “Search” option (#406A2.1.3) after entering in the Subscriber's last name. The system will then display all matching results in alphabetical order with the person's name, address, and contact number (#406A2.1.4).

If the correct person is found in the list, the user selects the appropriate person's last name (#406A2.1.5) to select the person as the Patient's Subscriber. The user will then be taken back to the PI main view (#406A) with the newly selected Subscriber information displayed.

There is also an option to “Create New Person” (#406A2.1.6) on the Search Results display, which is used if there is no match to choose as the Patient's Subscriber. Selecting this displays the New Subscriber form (similar to New Person) (#406A2.1.7). After entering in all relevant information the user must select “Create Subscriber” (#406A2.1.8) in order to save the information. The user is also taken to the next step of the process where the user must choose the correct Subscriber Relationship (#406A2.1.9). After making the selection, the user must select “Save Subscriber” (#406A2.1.10) to complete the process. The user is taken back to the Primary Insurance main view (#406A). The user may also decide to select “Cancel” during the process of creating a new Subscriber and this will discard all information (#406A2.1.13) and returns the user to the Primary Insurance main view (#406A).

TABLE 31

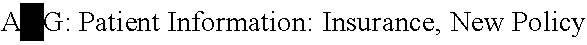

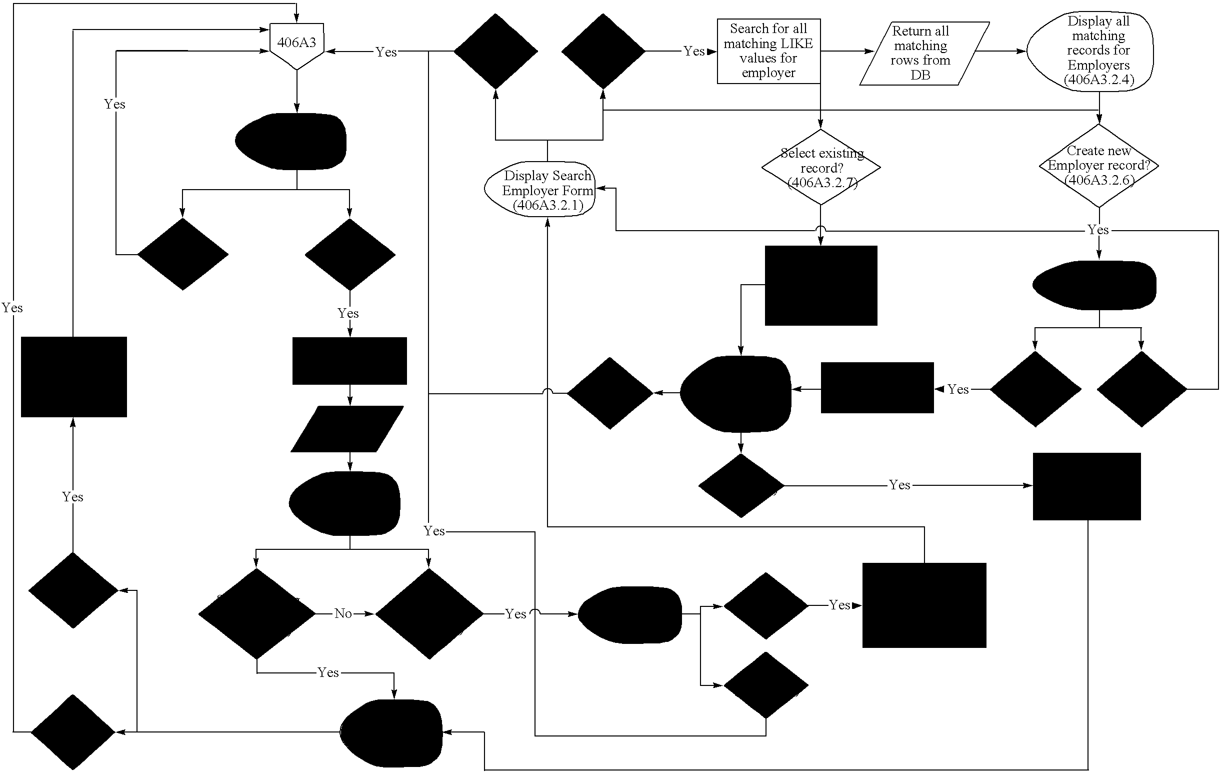

Selecting “Change Policy” (#406A3) on the Primary Insurance main view (#406A) takes the user to Primary Insurance, Policy Search (#406A3.1) (Tables 31 and 32). There are three types of information to search for a policy: by Carrier Name (#406A3.2), Employer Name (#406A3.3) or Group Number (#406A3.4). The user may enter all, partial, or none in the three listed. The system will return any matching results similar to the entered values for Policy Search when “Search” (#406A3.5) is selected. The results are then displayed in alphabetical order by Carrier Name (#406A3.6), along with employer name and group number. The three distinct information sets of Group Number, Carrier, and Employer create the Policy record. If the Patient's appropriate Policy record is listed in the search result, the user may select the Carrier (#406A3.7) to choose that Policy record for the Patient. After selection, the user may make changes to any of the three information sets (Policy, Carrier, Employer) (#406A3.8) displayed. Any change made to this Policy Record will update all Patients' records with the same Policy. After reviewing the information, the user must select “Save Changes” (#406A3.9) to complete the process. This returns the user to the Primary Insurance main view (#406A) with the appropriate information displayed. If the user selects “Cancel” (#406A3.10) during the process at any time it returns the user to Primary Insurance main view (#406A) discarding all changes. If the Policy Record is not listed in the Policy Search results (#406A3.6) the user may select “Create New Policy” (#406A3.1 1).

To create a new policy, the user must search for the Carrier (#406A3.12). The user must enter the Carrier name (partial or complete) to search for and select “Search” (#406A3.14). The user will then view the matching similar results (#406A3.15). If the proper Carrier record is listed as part of the results, the user may select the Carrier Name to continue the New Policy process (#406A3.16). The user must then search for the Employer the Patient's Policy is tied to. The process is similar to the Carrier search (#406A3.15). The user must search for the Employer in the system. In the following similar results, the user must select the Employer name. If the correct Employer record exists and the user has selected it, the user is given the form to enter the new Policy's Group Number tied to both the previously selected Carrier and Employer. The user must select “Save” in order to complete the process of creating the new Policy Record (#406A3.9). The user has the option to exit out of creating a new Policy by selecting “Cancel” in any step of the process. This will bring the user back to the Primary Insurance main view (#406A).

In case that the Carrier or Employer is not found, the user may create New Carrier (#406A3.18) or Employer. When either of these actions is taken, the user is given the appropriate form to enter the new record's information. The user must select “Save” in order to create the new record in either case. After the new Carrier or Employer record is created, the process continues as noted above.

Next is the Secondary Insurance, which works exactly as Primary Insurance with all the same views, buttons, options, and flow.

TABLE 32

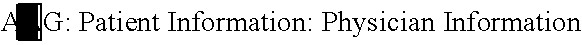

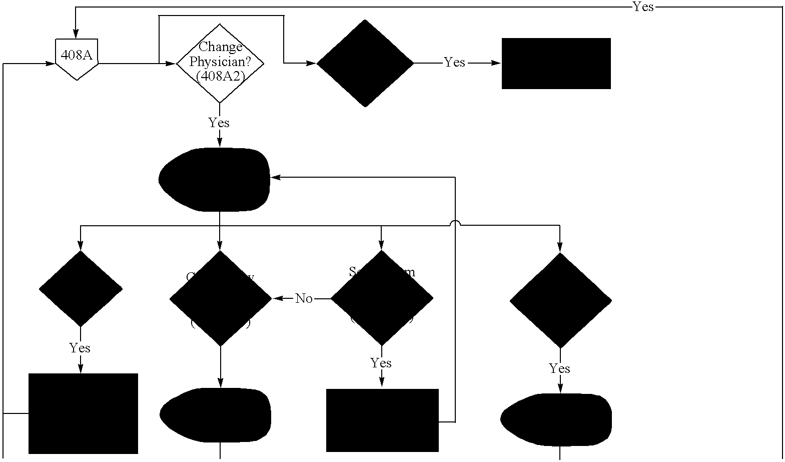

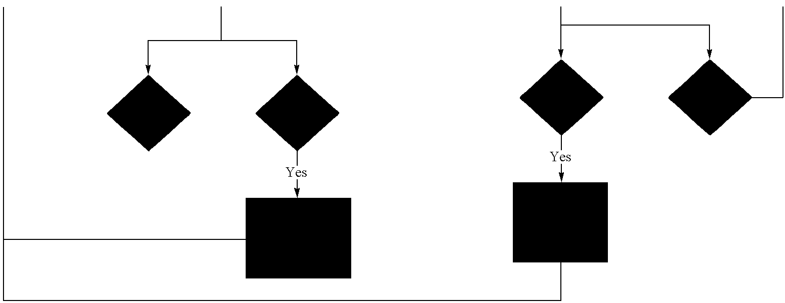

The Patient's Physician information (#408) is displayed (#408A) when selected (Table 32). The user may either select “Return to Chart” (#408Al)—which returns the user to the Patient At-a-Glance (#400)—or select “Change Physician” (#408A2). The user will be given the Change Physician view (#408A3). On this view is a drop-down menu containing a list of physicians the Office has collected (#408A4). If the user selects a physician from the list, (#408A5), the view will display all related information about the physician to the user (#408A6). After selecting a physician from the drop-down menu the user may select “This is correct” (#408A6.1) to associate the selected physician to the Patient (and returns the user to Physician main view (#408A)). The user may also choose to “Edit this Information” (#408A6.2). By selecting this option the user has taken action to change the information associated with this Physician. Please note that the changes made here should be reflected to all Patients who are associated to this Physician. The user is given an editable form (#408A7) to edit or change the information for the Physician. The user may then “Cancel” (#408A7.1) to discard all changes and go back to the main Physician view (#408A) or save the changes by selecting “Update Information” (#408A7.2). This saves all changes and returns the user to the Physician main view (#408A) displaying the modifications.

If the user cannot find the correct Physician in the drop-down menu (#408A4) to associate with the Patient, the user may select “Add Physician” (#408A5.1) from the drop-down menu. The user will be displayed a New Physician form (#408A8) to enter in the correct information for the new physician record. After entering in the information, the user may either “Cancel” (#408A8.1) to discard all changes and to return to the Physician man view (#408A) or select to finish the process by selecting “Create Physician” (#408A8.2). This will create the new Physician record and take the user back to Physician main view (#408A) with the newly created record associated with the Patient.

TABLE 33

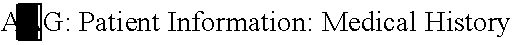

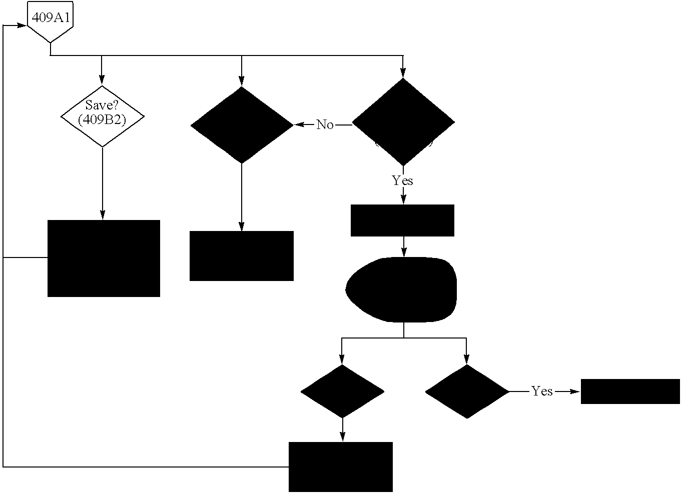

Medical History (#409) is a complete medical questionnaire for all new and existing Patients to fill out. It is updated on average every 3 to 5 years depending on the Patients overall age and health conditions. The system by default displays only the latest questionnaire. If the user needs to view the previous Medical History taken, the user may select “Show all Medical Histories” (#409A1) (Table 33). After recording the answers to the questions the user may either cancel and discard the information and return to the Patient AAG main view (#400) by selecting “Return to Chart” (#409B1) or select “Save Medical History (#409A2) which records the answers to the system.

The data collected as part of the Medical History process is used in the same fashion as the business process dictates; one collects the data digitally and uses the data in many ways:

The Medical History contains certain questions that when registered trigger specific tags for the Patient and his or her care. If the Patient answered “Yes” to certain questions in the medical history, that marks the Patient as needing Pre-Medication. This notifier appears on the Patient's At-a-Glance main view (#400) and the Confirmation call list. (#110B)

Also the medication questions (#409B3), if answered “Yes”, tags this information (names of medications and dosages) (#409B4) and records it to the Prescription module in the system. If one writes a prescription for this Patient from the TD prescription module (#422) the prescription information (name and dosage) is linked with the saved information (name and dosage) from the Medical History and is sent to the PDR database to look for matches in contraindications and allergies and problems. If any information is found to be a match, the system displays a warning when the doctor selects to write the prescription (#422A9) on the Prescription Pad view.

Also in the course of a Patient's Initial Exam or during a routine Recare visit, there may be a need to monitor the Patients' blood pressure and heart rate for screening purposes. This is done on the Medical History view where it denotes Activate BP/HR Monitor (#409B5.1). When selected, a new screen (#409B5.2) is displayed and the BP/HR is taken with the USB digital automated cuff (a plug-and-play device). If the data is sufficient, it is saved with the save button (#409B5.3). It is then saved into the Patient's Dental History with the date stamp (#409B5.4).

TABLE 34

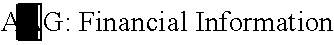

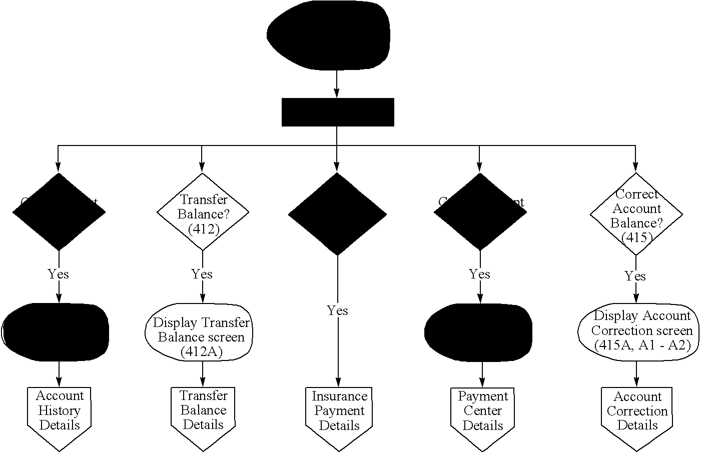

The next subsection in the Patient's AAG is the Financial Information (#410) (Table 34). The user is able to view and change any of these types of information:
Account History (#411)
Transfer Previous Balance (#412)
Insurance Payment (#413)
Payment Center (#414)

Account Correction (#415)

TABLE 35

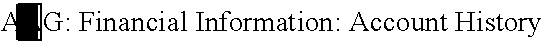

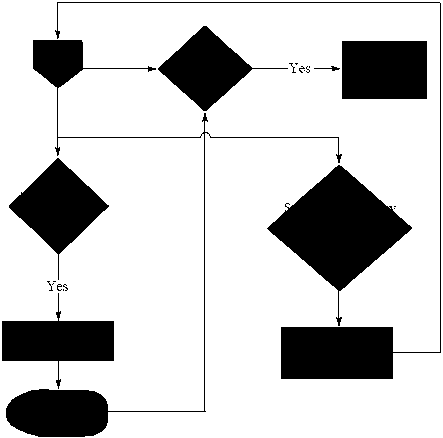

The first section is the Account History (#411). When the user selects this, the system will display every transaction that is part of the Patient's history in the Account History main view (#411A). The user may print the Patient's service charged and all payments made by selecting “Print” (#411A1) (Table 35). After the user selects to print the history the system will display a print status. Selecting “Return to chart” (#411A2) returns the user to the Patient's main At-a-Glance view (#400). The user may also sort the displayed information in ascending or descending order by selecting “Date” column header (#411A3) or “Patient” column header (#411A4) to sort alphabetically by Patient last name (in case the Patient is Guarantor for multiple Patients). The user may also sort by the “Description” column header (#411A5) to sort the services alphabetically.

TABLE 35

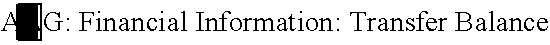

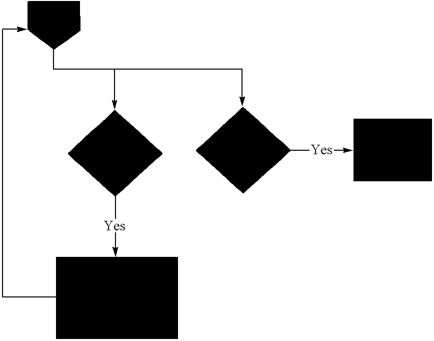

Next section is Transfer Balance (#412). It allows an easy transferring of outstanding balances from a previous ‘system’ whether a paper chart or a computer system where extraction of data is not possible to TD. When Transfer Balance (#412) is selected the user will view the entry form (#412A) (Table 36) where the outstanding balance amount is entered into the Amount field. The user must select “Process Transfer” in order to save the amount entered as outstanding balance for the Patient (#412A3). If the user chooses to close out the view without saving, the user may select “Return to Chart” (#412A2) which will return the Patient to the Patient's At-a-Glance main view (#400).

TABLE 37

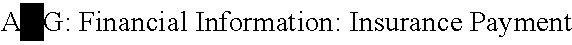

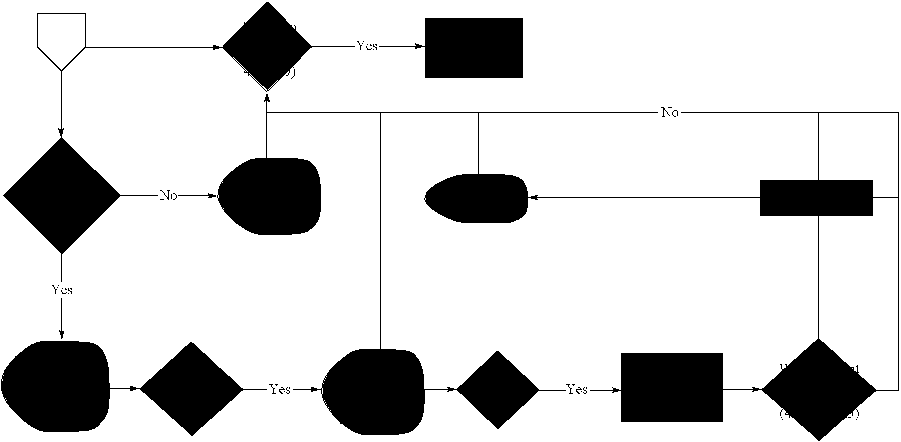

The Insurance Payment section (#413), when selected gives the user a view of that Patient's outstanding insurance claims (#413A) (Table 37). Selecting a claim (by left-clicking the date (#413A1)) displays the detailed services for the procedure performed on that date (#413A2), and a field to enter the total the insurance paid for each individual ADA code (#413A3). By default, the system will display an estimate for each procedure based on the information gathered over time of this particular insurance company, the ADA code, and the average amount paid by the company for the code.

The user may select “Claim Paid to Patient” (#413A4) in case the Insurance Company has sent the payment check to the Patient and the Office received the confirmation of payment from the Insurance Company.

The user may select “Claim Paid to Office” (#413A5) if the Office received payment from the Insurance Company for the Patient's claim. The amount given for each ADA code is recorded to the Patient's account as an insurance payment and a statement is generated (see Account History).

If the user wants to return to the Patient's At-a-Glance main view (#400) without saving any information, the user may select “Return to Chart”. In order to save and record all entered information the user must select “Process Claim” (#413A7). This will record all information as part of the Patient's Account History and the system's internal insurance tracking module. If there are any system generated artifacts (such as a printed statement) and information sets saved as part of collecting an Insurance Payment, the system will notify the user through the status view displaying exactly what process is being completed (#413A9). After the completion of all system tasks, the user may select “Return to Chart” which will return the user to the Patient At-a-Glance main view (#400).

TABLE 38

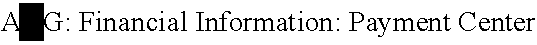

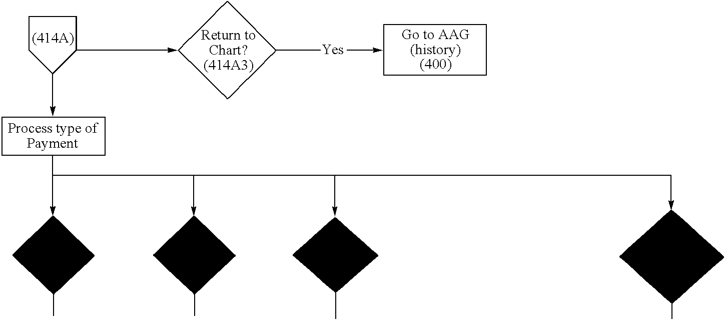

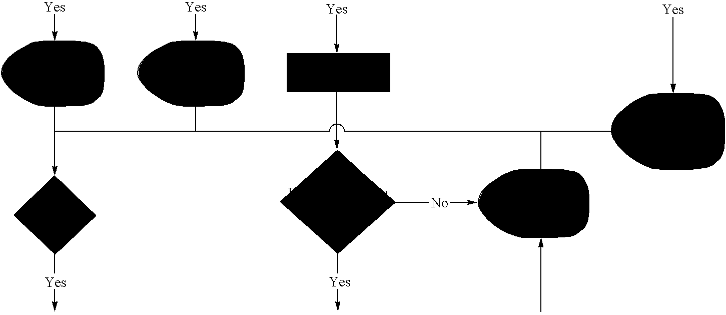

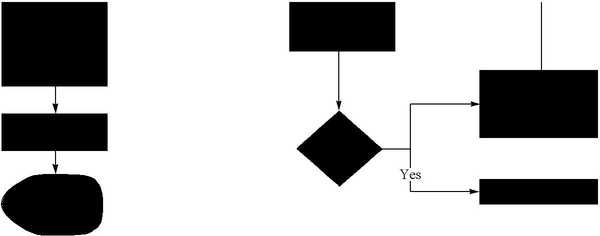

In the Payment Center section (#414) the user may collect payment from the Patient through this section's view (#414A) (Table 38). The user may choose to collect four types of payment: Cash, Check, Credit Card, and Financing Co. (#414A1).

When each type is selected by the user, the user will be given an entry field (#414A2, #414A7, #414A11, #414A17) for the amount, and related information such as the Check Number (#414A8), the bank number (#414A9) for checks and a drop-down menu for card type (#414A12), the expiration date (#414A13), the card number (#414A14) and the security code (#414A15) for “Credit Card”, and the check number (#414A18) the bank number (#414A19), and the Financing Company name (in the drop-down menu) (#414A20) for Finance Co. The user must then select either “Return to Chart” (#414A3) to close the view and return to the Patient's At-a-Glance main view (#400) without saving information or “Process Payment” (#414A4) to save the information as a Payment recorded into the Patient's Account History and to generate an automatic statement for the Patient. The user is given a status of this process after selecting “Process Payment” in the status view (#414A5).

If the Office has the optional USB Credit Card Teltex/Processor for TD, the user's steps to record this information is simpler than stated above. The user must first select “Credit Card” (#414A1) and simply “swipe” the Patient/Guarantor's credit card through the magnetic reader and charge the correct amount into the device. All pertinent information will be recorded and entered into the appropriate fields automatically. The user may then choose to save the information as stated above (#414A4) or cancel and return to the Patient's At-a-Glance view (#400) without saving the information by selecting “Return to Chart” (#414A3).

In case the user selects “Process Payment without entering in a total amount for payment, the user will be taken back to the Patient's Payment Center main view (#414A) by default without recording the process as a valid Payment.

TABLE 39

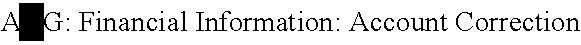

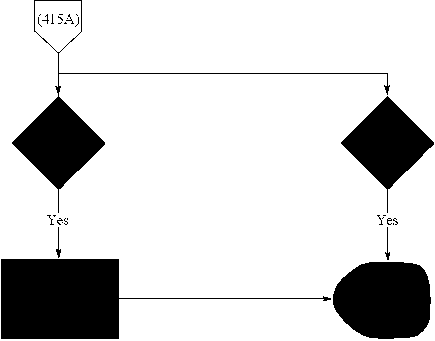

TABLE 40

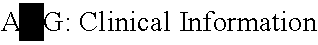

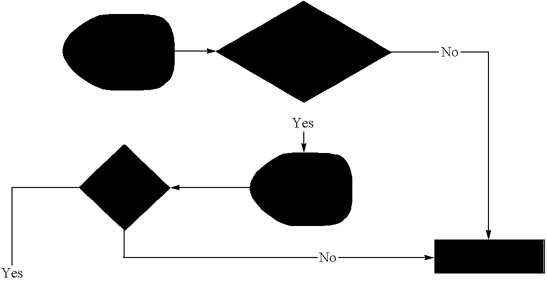

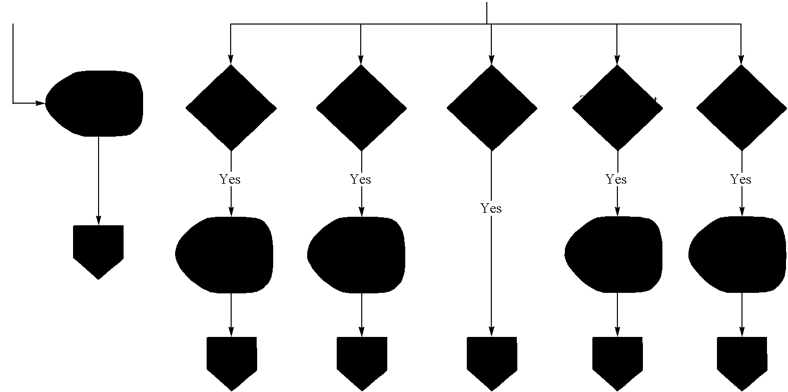

TABLE 41

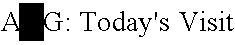

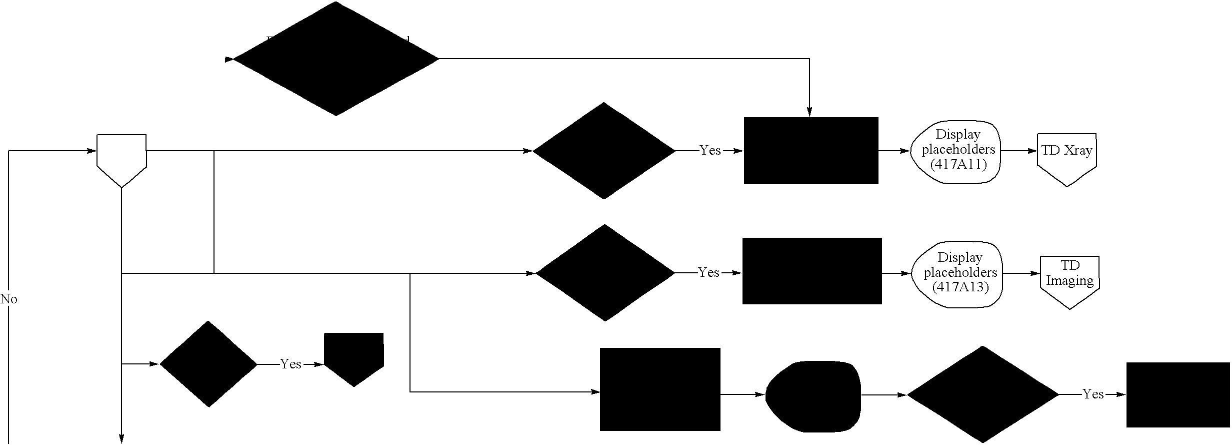

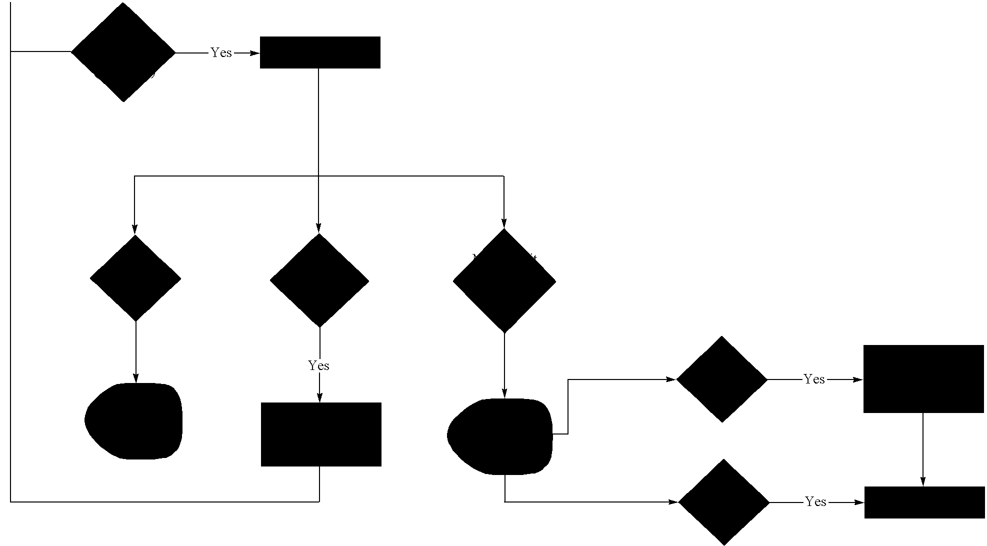

Next subsection is Clinical Information (#416). In this group, the first section is Today's Visit (#417) that only appears if the Patient has a scheduled Visit for the day. When it is selected, the system displays the “Today's Visit” main view (#417A) that has all the information for that day's scheduled procedures and the different ways to quickly and efficiently collect all procedure data digitally, including embedded digital radiographs and images. The main view for Today's Visit is separated into four sections: Procedures, Radiographs, Photographs, and Treatment Notes. At the top of the view is today's date in the header and below that is Procedures. It displays the ADA procedure codes previously scheduled for the Visit and allows the user to “Add” (#417A3), “Delete” (#417A4) procedure codes to the Visit and make procedure Fee Adjustments (#417A5). Adding codes takes the user to that Patient's Plan Treatment view (#419A), which is similar to the standard Plan Treatment view with the addition of “Add Standard Treatment” and “Add to Visit” (#417A7) instead of the Plan Treatment view's “Select Standard Treatment” and “Group Codes”. If the user makes either of the actions to add additional codes to the day's Visit, the newly added codes will be displayed in the Procedures section.

In order to delete codes the user must select the check box next to the Procedure codes (#417A8) and Select “Delete codes”. The codes are removed from the day's Visit view and placed in the Patient's Plan Treatment (#419A) under the Planned Procedures section, ready to be scheduled.

The Procedures section also describes tooth, area, surface, and fee along with the total amount for the visit. This is an example of using previously collected information to help run the Office more efficiently.

Under the Procedures section is the TD Digital Imaging Area (consisting of both Radiographs and Photographs). This gives the user the ability to take radiographs (both intra-oral and extra-oral), digital images (photographs) and CAD-CAM scans as efficiently as can be done with conventional methods but automated transfer and embedding of the digital information to the Patient Chart and more specifically associated with the Patient's Visit.

Under Radiographs is a drop-down menu that contains the types of radiographs associated to the current accepted version of the ADA Procedure codes (and user-managed in the ADA Code Variables section under Office Setup (#125)). If the user had previously scheduled the Patient with a standard Visit type with associated images, the user will see the image placeholders (#417A11) in Today's Visit view (#417A) (Table 41). If the user chooses to add images to the Visit, the view will also display the image placeholder(s) (#417A11) according to the type selected. This holds true for the drop-down menu for Photographs and its image placeholders in Today's Visit view (#417A).

TABLE 42

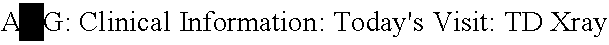

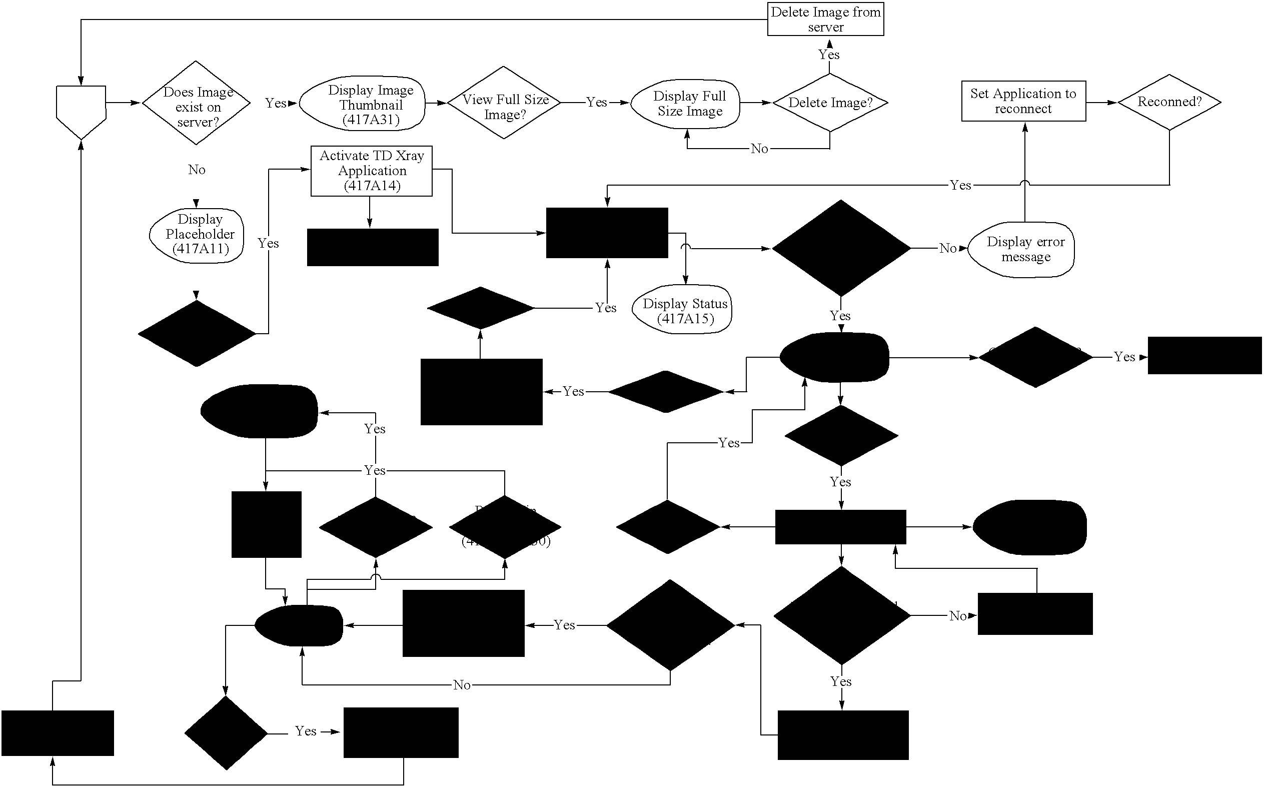

This process describes how the user captures a radiograph: The user must select an image placeholder (#417A11). This will activate TDXray™ Radiograph Capture application (#417A14). After initialization and detecting the USB connected CMOS sensor (not shown) the capture screen description (#417A15) will turn from “Initializing . . . ” to “Ready.” The user must select on “Take X-ray” (#417A16) to activate TDXray to capture the digital information (#417A17) from the sensor. The capture screen outline will change from blue to red indicating that the system is ready to accept data (#417A18). There is also a timer (not shown) started (#417A19) which gives the user that amount of seconds to take, retake, modify and finally save that x-ray. When the sensor is activated with x-ray information, the resulting image is displayed in the image display area (#417A17).

During the session while the timer is active, the user may retake the radiograph without other user intervention.

After the capture, the user may rotate or flip the image (#417A29, #417A30) or change the level/contrast (#417A23, #417A24).

If the user selects to change the Brightness/Contrast (#417A24), the application will display a secondary window with a sliding bar to adjust the levels and a preview window (#417A28). After making changes the user must select “Apply” in order to save the changed brightness/contrast. The user may cancel all changes either by closing the secondary window or selecting “Cancel”.

The application may also automatically rotate and flip the images for a full-mouth series. The user may still rotate and flip the image manually if necessary.

After making changes the user may select “Save” (which only becomes available after the device captures the digital radiograph) (#417A21). When selected, the application will embed the radiograph to the Visit record and refresh the Today's Visit automatically to display the newly captured radiograph instead of the image placeholder. If there are multiple radiographs that need to be captured, the user can select the next image placeholder on the Today's Visit main view. This will bring the TDXray application back to the foreground. The user must select “NEXT” in order to capture the successive radiographs (failing to do so will result in overwriting the previous radiograph already embedded and saved as part of the Visit).

If the user decides to cancel the capture process and quit the TDXray application, the user may select “Quit” (#417A20). This will stop the application and return the user to the Today's Visit main view (#417A). In case the user decides to stop the capture process while it is active (red), the user may select “Stop x-ray” (#417A22). After stopping the process, the user may select “Start” in order to re-initialize the sensor and start the capture process again.

TABLE 43

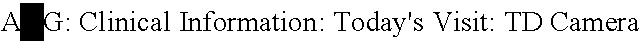

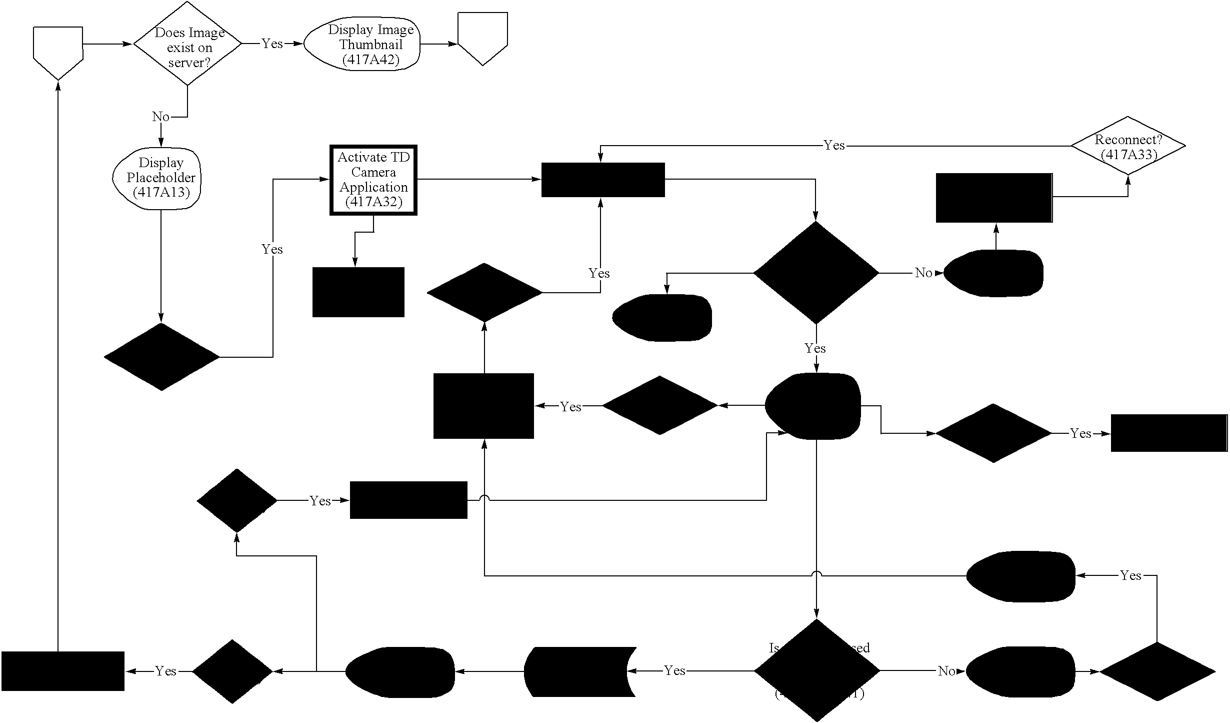

The process of capturing a digital image is similar to the digital radiographs. The user first must make sure the approved digital camera is connected to the Operatory client PC through a powered USB hub or directly to the PC. The user then can activate TD Camera capture system (#417A32) by selecting the photograph image placeholder (#417A13) under the “Photograph” section in the Patient's Today's Visit view (Table 42).

If the digital camera is connected properly, the TD Camera capture system will automatically detect it as the default camera device (#417A34). Otherwise, the user must check all connections and then either “Connect” (#417A33) or the user may close the application and re-activate it by selecting the placeholder image. The TD Camera capture system will detect two ways of capture: the user may either take the picture by pushing down on the shutter button on the camera itself or the user may select “Take Picture” (#417A35) on the GUI. After the photograph is taken, the photograph will display on the main image view (#417A36). The user may save the image by selecting “Save” (#417A37), clear the image cache by selecting “Delete” (#417A38), or retake the photograph by selecting either the camera shutter or “Take Picture” (#417A39). or by taking a second picture or disconnect (#417A40). If the user decides to retake the photograph, the previous image is overwritten and displayed in the main image view (#417A41). Once the user selects “Save” (#417A37), the image is saved to the server image repository, the Patient's Today's Visit view is brought to the foreground and is refreshed (#417A), showing a thumbnail of the newly captured digital image in place of the placeholder (#417A42). If the user is taking a series of photographs, the user must select the next photograph image placeholder on the Patient's Today's Visit view (#417A) (bringing the TD Camera application back to the foreground) and then select “Next”. The user may then proceed with taking the next photograph of the series until all necessary photographs are taken. If “Next” is not selected for each successive photograph the system will overwrite the previous image. The application will also display any type of common errors including the digital camera timeout (to save battery life), cable disconnection (which will preferably also disconnect the application by default), and general error messages. If these error messages are displayed, the user must select “Disconnect” (if not already disconnected), check the USB connection cable, turn the digital camera off then back on, and select “Connect” on TD Camera. The user may then proceed with the photograph capture process.

On the bottom of the Today's Visit view is the treatment notes section. The user may type in any Patient or Visit related information into the text area and saved by selecting “Save Treatment Notes”. If the Office has configured and added automated treatment notes as part of Office Setup, those notes will be pre-filled into the text area. The user may modify the automated treatment notes as with user entered notes. The user may also print Visit information by selecting “Print Visit”. This will print all Treatment and Visit related material.

TABLE 44

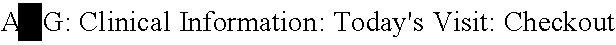

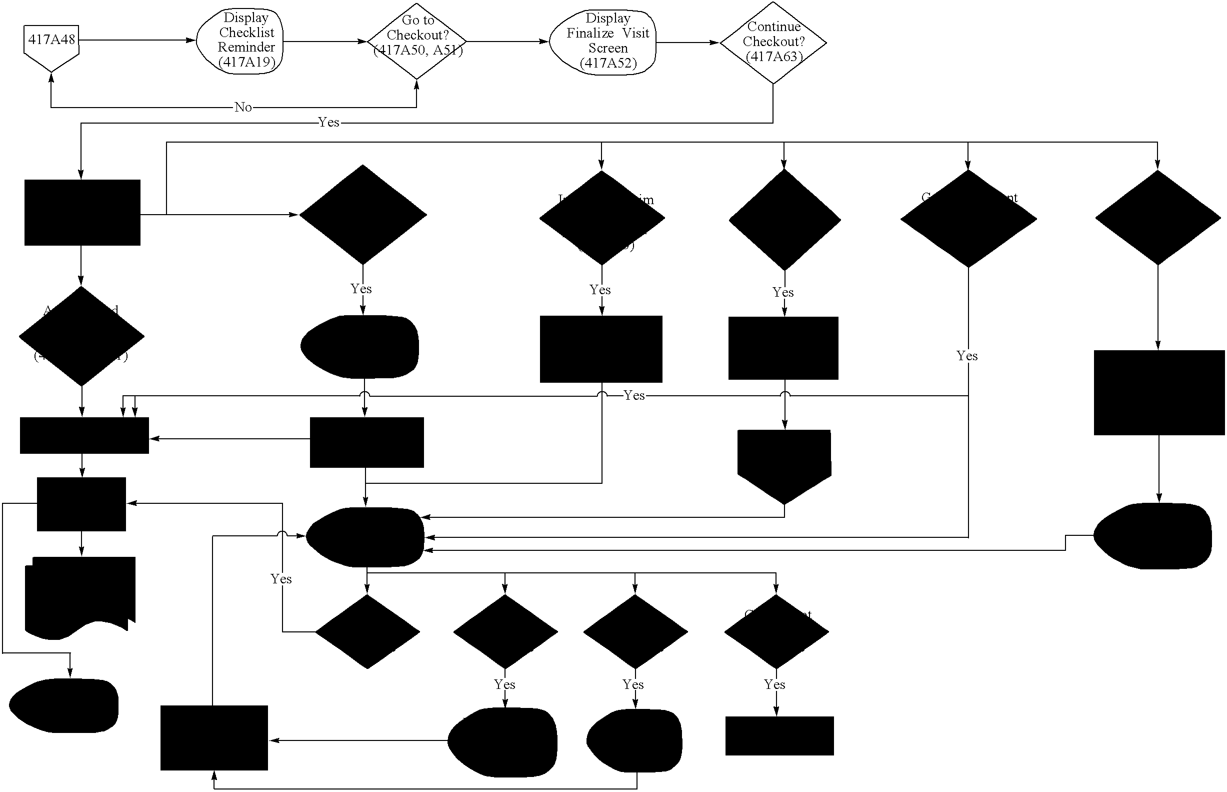

The automated checkout procedure is initiated by selecting “Complete Visit” (#417A48) (Table 43). This brings up a confirmation window (#417A49) wich gives the user the oportunity to review everything that was done and make sure it is correct before proceeding to Checkout. If the user selects “No” (#417A50) the confirmation window is closed and it returns the user back to the Today's Visit view (#417A). If “Yes” (#417A51) is selected the user is displayed the Finalize Visit view (#417A52). Once the user has started the Checkout process, the user may not go back to the previous Today's Visit main view to make changes; the user should finish recording all Visit related information as part of Today's Visit view and only when completed proceed to Checkout.

In the Finalize Visit view (#417A52), there are several options for the user. “Pay Claim to Office” (#417A53) is an option to activate the insurance tracking for a Patient if the Office does not accept insurance as a payment source. “Rads or Models Enclosed” (#417A54) should be checked if the user wants to send the Visit's digital photographs and radiographs with the Patient's Insurance Claim. The next four questions (#417A55) are routine questions to be answered on the standard ADA Claim form.

The user is given the option of choosing which documents to print (#417A56). The user may select to “Print Statement” (#417A57) (checked by default), “Insurance Form” (#417A58) which is checked by default if the Patient has either Primary or Secondary Insurance, (the user may choose to print a blank ADA form with the dental info and not the Patient or insurance info on it), Home Care Instructions (#417A59) which are checked if the ADA codes for the Visit from the ADA code variable list (#125) have defined Home Care Instructions, “Prescription” (#417A60) is also automatically checked if the Visit codes have defined associations to prescription types in the ADA code variable list(#125), and “Patient Education” (#417A61) which can come off the Patient's Planned Treatment (#419) or from the Patient Education section inside the Patient's Visit.

The user may also select to create a Follow-Up Visit (#417A62). Follow-Up Visit is a continuing care Visit which contains all information related to the original visit and associated with the current Visit. It is created and placed in the Patient's Plan Treatment section to be scheduled with high priority in the Planned Visits section.

When the user selects “Continue Checkout” (#417A63), the display (#417A64) gives the user the option to select images (#417A65) the user would like to include for insurance claim submission (#417A54). After the images are selected, the user must select “Continue Checkout” in order to proceed to the Check-Out: Prescription view (#417A68) where the user may select to write a prescription for the Patient. After selecting a listed drug or adding/modifying the existing drug type and dosage, the user must select “Write this Rx” (#417A69) where the system then associates the newly written prescription to the Patient's Visit record (#417A70, #417A71).

The user must then select “Return to Checkout” which then takes the user to Patient Education (#417A73). Any or all visit-related Patient Education information can be checked for displaying. The content for the visit-related Patient Education information is managed through the Office Setup section (#126) and is related to the ADA Codes. Therefore any Visit created from the Patient's Planned Treatment (#419) which contain associated Patient Education information will display the appropriate data at this juncture in the Checkout process.

When the user selects “Continue Checkout” from Patient Education, the Planned Treatment section is displayed to guide the user in scheduling or planning the Patient's next visit. The user can see that the Continuing Care Visit created within the Checkout procedure (#417A62) is at the top of the Planned Treatment list (#417A76) which means that it has the highest priority to schedule for the Patient. The user may create or manage any number of visits for the Patient but the priority is on scheduling the Visit at the top of the list (in this case the Continuing Care Visit) by selecting “Schedule” (#417A77) next to the listed Visit. This brings the user to the Schedule view (#200) and the system created visit with the correct time allotment to schedule (#417A78). This visual representation is attached to the mouse pointer and easily placed in an available time slot that can contain the correct visit time allotment. The user must select the visit start time on the Schedule and this will prompt the user to confirm the appointment (#417A79). Within the appointment confirmation view (#417A80) the user may select the exact start and end time as well as adding a short description about the visit (this description will display on the Front Desk view as a description along with the procedure codes)(#417A81). The user must select “Confirm” (#417A82) in order to schedule the appointment into the system. The user will then taken back to the Planned Treatment view (#419).

If no further appointments need to be scheduled, the user selects “Continue Checkout” and the system displays the Finalize Checkout view (#417A85). This view gives all information regarding the procedures done during the Visit (#417A86), what was charged for each procedure and any previous balance or pending insurance claims (#417A87). The user may accept payment through selecting “Collect Payment” (#417A88) which displays the Patient Payment Center (#414A).

When the user is ready to proceed after taking any type of payment, the user must select “Process” to return to the Finalize Checkout view (#417A85).

The user may make account corrections by selecting “Make Adjustment” (#417A89). The system will display the Account Correction view (#415A). Once again the user must select “Process” in order to return to the Finalize Checkout view (#417A85). If the user is not at the Front Desk or a place to accept payment (such as inside the operatory) the user may select “Continue at front desk” (#417A90). This will close the Patient's chart, allowing the user to return to this point of the Checkout process at the Front Desk.

Once all payment, adjustment, and checkout related steps are completed, the user selects “Finalize Checkout” which then writes all appropriate information to the system and sends all selected documents for printing to the printer. The status of recording and printing the appropriate artifacts will be displayed in the status view (#417A92). The user may then choose “Return to Chart” in order to go back to the Patient's At-a-Glance main view (#400).

The following are the printable artifacts: the Patient's Statement (#417A94), Insurance Claim form including any digital images or radiographs (#417A95), Prescriptions (#417A96), and Patient Education material (#417A97).

TABLE 45

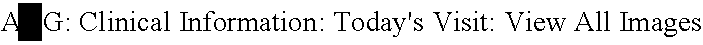

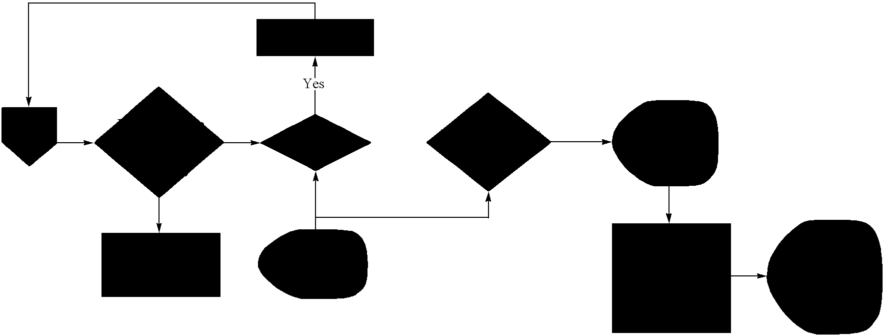

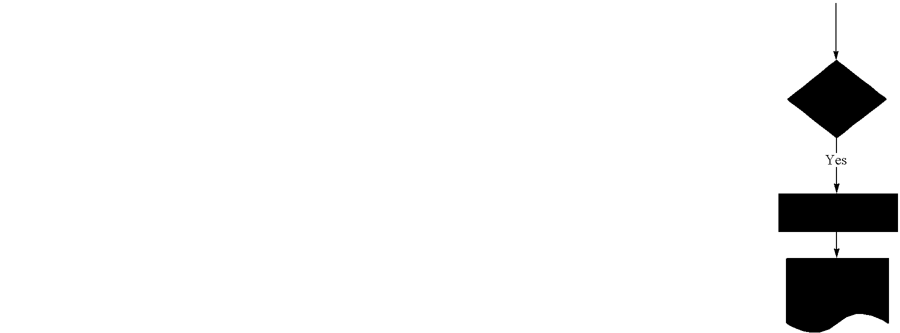

During the Patient visit and before the visit checkout process is started, there are two buttons labeled “View All” (#417A98) (Table 45). When selected, the image viewer is displayed along with all the appropriate digital images for the visit. The user may select as many images to view from this selection screen. This brings up only those selected images chosen in larger form (#417A102) for Patient education and discussion. The user may select “Display All Images” wick returns the user back to the initial viewer screen (#417A99) or “Link with Patient Education” (#417A104) wich then displays a separate view to allow the user to choose the appropriate Patient education content (#417A105) to match the images with.

Once chosen the system then takes the selected images of this particular Patient (#417A102) and combines them with the stored Patient Education information from the Office Setup section (#126) into a personalized Patient Education document (#417A106). This document then can be viewed and discussed with the Patient while in the operatory and also have the document printed for the Patient (#417A107). The final print out is a well-formatted document for better viewing with easily understandable content (#417A108).

Next is Dental History (#418) which when clicked brings the user to the Dental History view (#418A). On this view each individual visit in the Patient's history of dental work is listed as separate and dated items displaying the treatment notes and the list of procedures that have been scheduled and completed. They are listed starting from the most current (including ones that have been scheduled for the future) to the earliest. The date is selectable and will display the visit details in the visit screen when selected. And underneath the date is the visit status (scheduled, confirmed, cancelled, no show, checkout) taken from the actions on the Confirmation Call list (#110), or from changing the status from the visit detail from the Schedule (#205E), or the visit's checkout process (i.e. not a completed visit through checkout or still open visit).

The user may return to the Patient's At-A-Glance (#400) by selecting “Return to Chart”.

While on the screen one still has the ability to change the account with an adjustment.

While is the Visit details view, the user may change the listed ADA codes for the visit; for deleting codes, the user follows the Today's Visit (#417A) procedure for code deletion which is to select the ADA Code and select “Delete Selected” (#417A4). If the user needs to add additional ADA Codes the user must select “Add” (#417A3) which then displays the Planned Treatment view (#419A) for that Patient.

The user may view all images taken during a Visit in its detailed view by selecting the respective “View all” next to each Radiographs and Photographs section

And similar to the Today's Visit (#417A) view is a text area on the bottom of the Visit Details view where the user may write or update the treatment notes for that Visit. The modified treatment notes must be saved by selecting “Save treatment notes” after editing, in order to keep the changes part of the Visit record.

TABLE 46

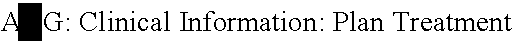

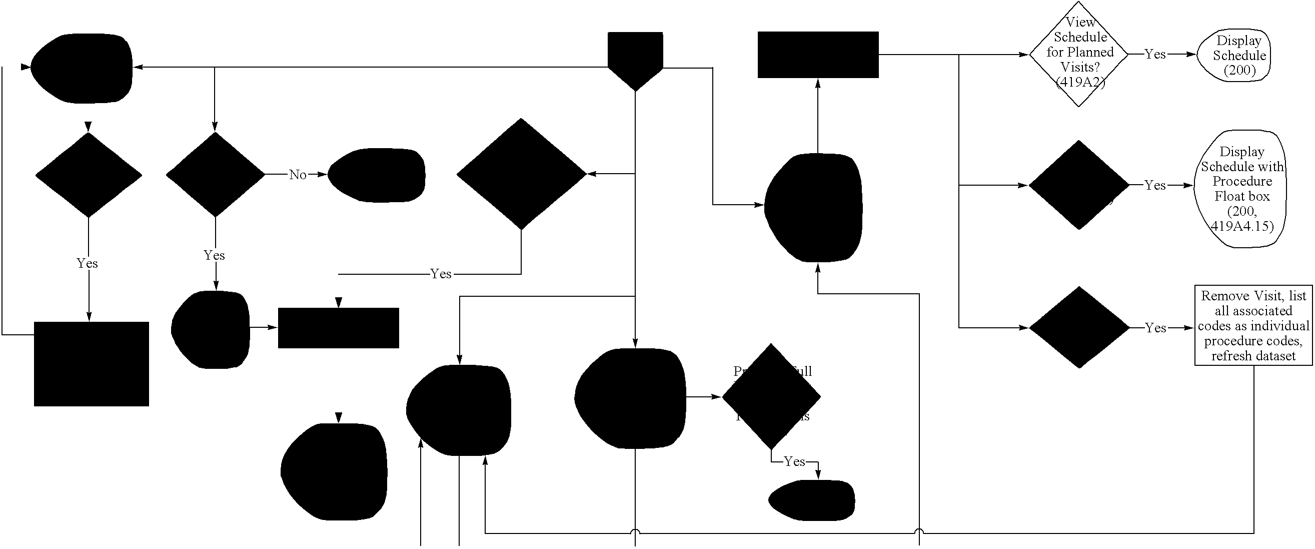

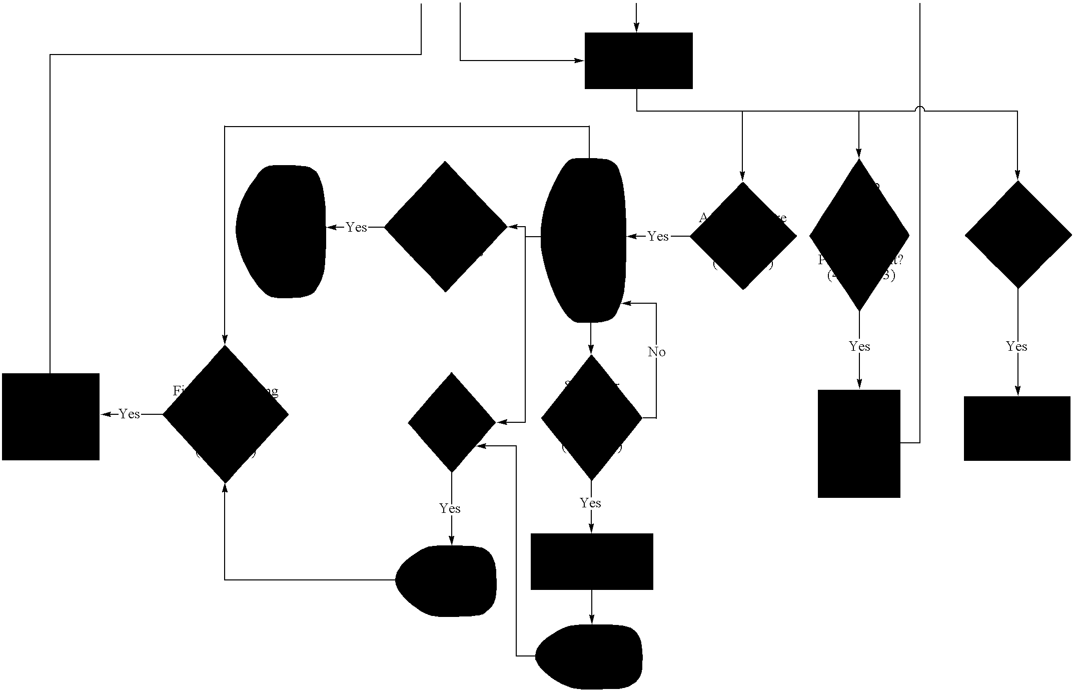

Next in the Clinical Information group is Plan Treatment (#419). When selected, the user is given the Plan Treatment view (#419A) (Table 46) for the Patient. This view is designed to simplify creating and managing dental Visits and its association with the ADA Codes. This view and the process of creating and managing Visits is used throughout the system and Patient management process to quickly create accurate Visits and schedule the Patient according to his or her needs as determined by the collected information set of the digital Patient record.

The Plan Treatment view is broken up into three main sections: Standard Visits, Planned Visits (#419A2), Add Procedure (By Tooth/Area) (#419A3) and Planned Procedures (#419A4).

Under Standard Visits the user is given the Patient's Recare Status (#419A1.1) which also displays the next recare due date. If the Patient is overdue the Recare Status and date is in black. If the Patient is up to date, the due date is in green. Regardless of status the user may schedule the Patient for the recare by selecting on the due date. This will take the user to the Schedule view (#200) with the Recare Visit already created and ready to be dropped (#419A1.11) into a time slot for that Patient. The Schedule will display today's date if the Patient is overdue for the Recare Visit or will display the future due date if the Patient is current. Any automation in creating Visits comes directly with the system manipulation of the ADA Codes and how it is used within the system (#125).

Next to the Recare Status is the Recare Frequency (#419A1.2), which is crucial for recare management. The user may choose the appropriate interval for the Patient by selecting one of the listed options.

The last area under the Standard Visits is the “Select Standard Treatment” list (#419A1.3). This is a list (#419A1.4) of frequently scheduled events for the Office and managed through the Office Setup (#126). When the user selects any of the listed treatments, the user is taken to the Schedule view (#200) with the appropriate Visit created and ready to be dropped (#419A1.11) into a time slot for that Patient. The Schedule will display the current date by default for any of these treatment procedures selected through the list (#419A1.3) but the user may use the Calendar module to navigate to the appropriate day to schedule the Patient accordingly.

The Add Procedure section (#419A3) allows the user to plan treatment for a single tooth or an area of the Patient's mouth:

The user may select an area of the Patient's mouth by choosing an option under “Select Area” (#419A3.1). Underneath the area list are the numbered icons representing each tooth for the Patient (#419A3.2). The icons are colored accordingly: a tooth is marked red if it is defective or decayed (#419A3.3), green if there are no issues (#419A3.4) and gray if the tooth is missing or in need of an implant (#419A3.5). In the gray icon is a number in mm, which corresponds to the width of the space between teeth. These values are determined from the initial charting information (#420).

Whether the user is planning treatment for an area or an individual tooth, the following steps must be taken. The user must select either an area as described above (#419A3.1) or a tooth (#419A3.2). The Select Procedure view (#419A4) is then displayed. This view gives the user the tooth or area for treatment (#419A4.1) and all associated Patient's radiographs and photographs for that tooth or area (#419A4.2) from the Patient's initial exam record. The user also may view the Patient's full mouth series of images by selecting “Open Full Mouth Series (#419A4.3) next to the localized radiographs/photographs for the selected tooth or area. The system will then display the full image set for the Patient (#419A4.4).

Below the images is an expandable, organized list of all ADA Codes for every dental procedure (#419A4.5) with a search engine (#419A4.6) to find anything that is not easily found in the expandable list. Once the proper code is selected it appears below in the Procedure section (#419A4.7). Then the user may enter the surfaces of any restoration (#419A4.8). The user may add any number of procedures to the specific tooth or area until the user is satisfied. The user must then select “Finished” (#419A4.9). This will return the user back to the Plan Treatment view (#419A) with the recently added ADA Codes for the tooth or area (#419A4.10) being displayed in the Planned Procedures area (#419A4).

Once all teeth or areas are planned for their appropriate treatment as described above (#419A4.11), the user must create Visits. When the user selects individual or multiple procedures (#419A4.12) and then selects “Group Codes” (#419A4.13), the system automatically creates a Visit with the selected procedures (#419A4.14) and places the newly created Visit in the Planned Visit area (#419A2). The user may then schedule the Visit (#419A4.15), which follows the process as described previously, or delete the Visit (#419A4.16) which deletes the grouped visit but then places the individual procedures back into the Planned Procedures area (#419A4). The user may also change the priority of the Visits listed by selecting the arrow on the far right in the Visit header (#419A4.17). When the corresponding arrow is selected, the Visit will be moved to the top of the list in the Planned Visit area (#419A2) to be scheduled next by the user.

The user may also view the pre-treatment estimate for insurance purposes and choose to print the insurance claim for that Visit. This action will also be recorded as part of the Patient's Account History (#411, #413).

TABLE 47

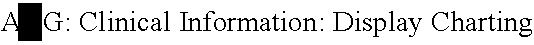

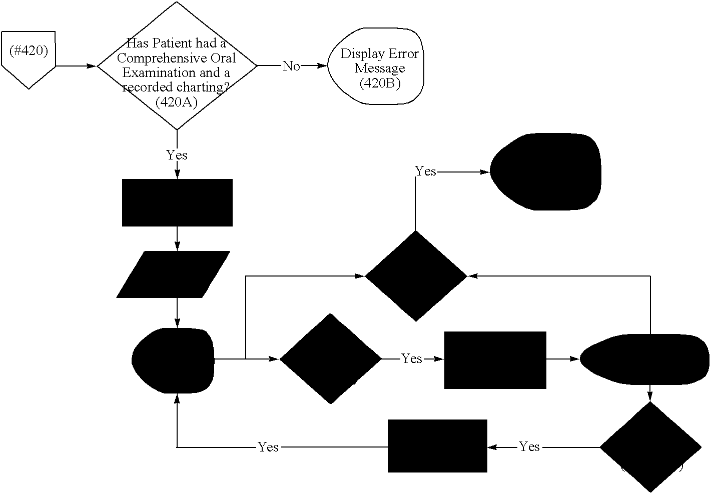

The user may view the Patient's Charting information by selecting Display Charting (#420) (Table 46). If the Patient has had a comprehensive oral exam (charting) previously, the most recent charting information will be displayed in the Display Charting main view (#420C). In case the Patient has not had a comprehensive oral examination which includes a full chart, the user will view an error message (#420B).

By default, the user will see the Restorative Information first upon seeing the last Chart (#420C). The user may choose to view the Periodontal Information by selecting “Perio” (#420C.1). The user may then return to the Restorative Information by selecting “Restorative” (#420C.1.2). The user may choose to return to the Patient's At-a-Glance main view (#400) by selecting “Return to Chart”. The user also has the option to view the previous charting records by selecting “See Previous Charts” which then displays the Patient's Dental History.

TABLE 48

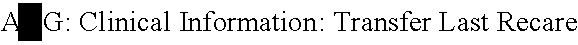

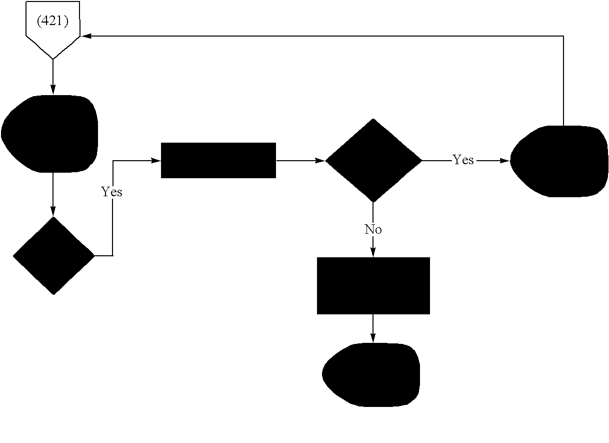

The next section under Clinical Information is Transfer Last Recare (#421) (Table 48). When selected, the system will display the Transfer Last Recare view (#421A). This function is used when the Patient is either a new Patient or a reactivated Patient for the Office where the last recare date is not part of the Patient's record.

After entering the Patient's last recare date and recare frequency, the user must select on “Submit” (#421A3) in order to record the last recare date and frequency. Once submitted, the user is returned to the Patient's At-A-Glance view (#400).

TABLE 49

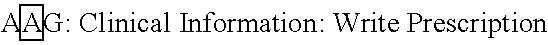

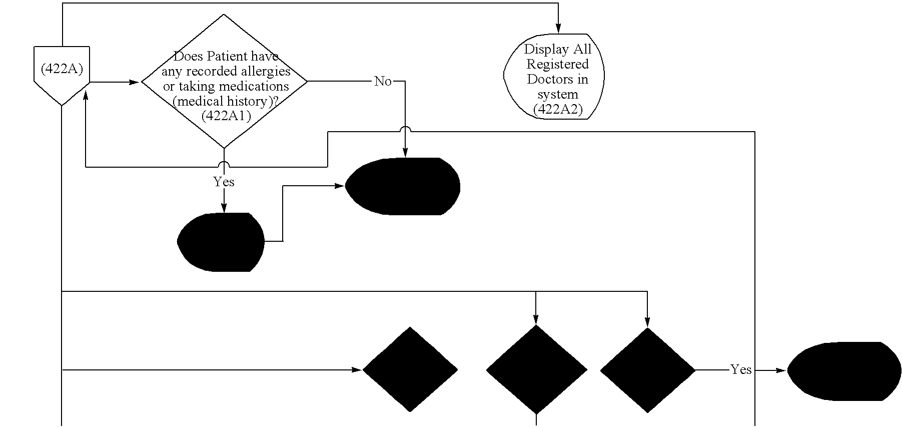

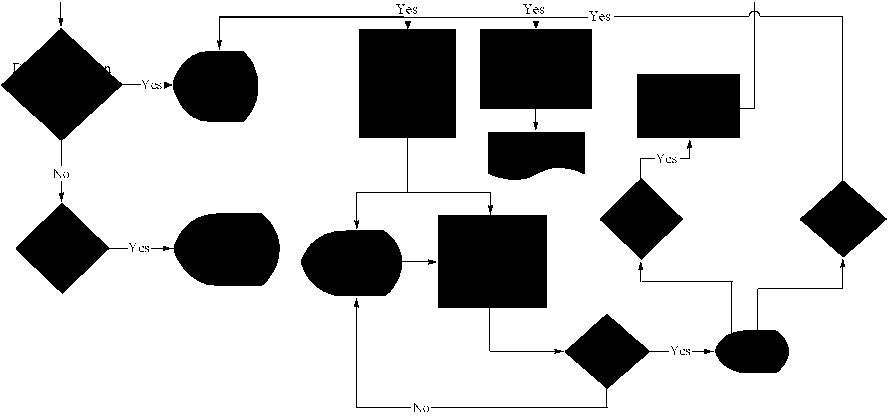

Next under Clinical Information is prescription pad (Write Prescription) (#422). When selected the Prescription Pad view (#422A) (Table 49) is displayed. Within this view the user is given the Patient's information (#422A1) along with the means to write a prescription to either send or hand to the Patient.

The Personal Information section (#422A1) contains the Patient name and lists any current medications or any allergies to medications (these notifications come from the Patient's Medical History (#409)). The Select Doctor section (#422A2) allows the user to select the appropriate dentist writing the script, if the Office has more than one licensed dentist. The dentist's information managed within the Office Setup (#126) is used here and may be changed within that section. The Prescription menu (#422A4) contains a list of commonly written dental prescriptions (#422A5). The user may select to create a new Prescription record by selecting New Rx (#422A6) from the Prescription menu (#422A4). When selected, the system displays an empty medication entry form for the user (#422A7). Once all pertinent information is filled in the appropriate places, the user must select “Write Prescription” (#422A9) in order to create the new entry. This new entry is viewed under Added Prescriptions (#422A11). Every time a new Prescription is created, the medication type is checked against the Patient's information of drug allergies and/or drugs currently being taken, from the Patient's Medical History (#409). After comparing the information of the Prescription, Patient's information, and cross-referencing the Physicians Desk Reference for any potential warnings, indications, contraindications, etc. the findings are then displayed as a suggestion for the dentist to consider. The dentist may then makes necessary changes for the Prescription written if needed, and then print the scripts. The user may write any number of scripts for the Patient and print them all by selecting “Print Prescriptions” (#422A12). The scripts will be sent to the networked printer (#422A13, #422A14) and also record the event into the Patient's Dental History (#418).

TABLE 50

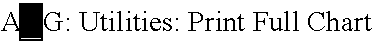

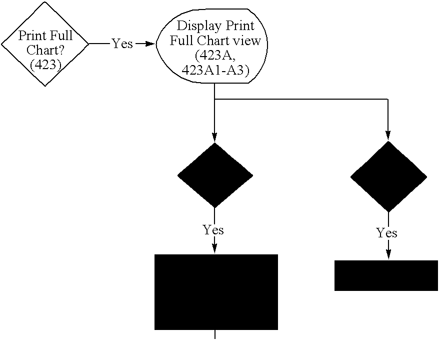

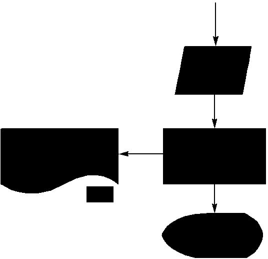

There are times when the Patient leaves the office for various reasons and/or request that his or her records be either given to them personally or forwarded to another office or request a copy of their records for a referral or second opinion. There are two methods where the user can reproduce the Patient's information in print form.

The user may select Print Full Chart (#423) from the Patient's AAG (#400). Selecting to do so (#423) (Table 50) displays the Print Patient Chart main view (#423A). Within the view the user may reprint these information sets: Release of Records form (#423A1), Patient Information (#423A2), Medical History (#423A3), and Dental History (#423A4). The user may select more than one type to reprint. The user may choose “Cancel” (#423A5) to go back to the Patient's AAG main view (#400) or “Print” (#423A6) to print the selected sections. The Patient does not become deactivated.

The second method is to select to change the Patient's status on the Patient header that appears at the top of every Patient chart view. Selecting the status link when the Patient is inactive will simply change the status to active. If the Patient is active and is leaving the office and requesting records, changing the status will start the Patient deactivation process with a new view similar to the Print Patient Chart main view (#423A). The same options for the information sets are present except that in order to complete the process the user must select “De-activate Patient”. This will change the Patient status to inactive and print the complete Patient chart.

TABLE 51

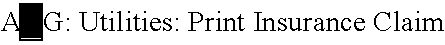

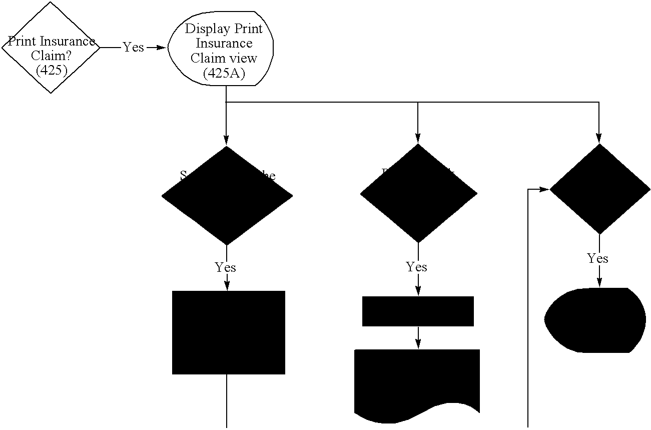

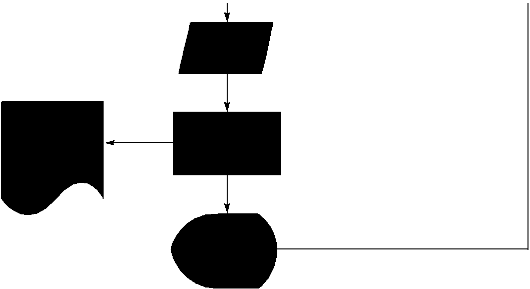

Next in the Utilities is the Print Insurance claim (#425) (Table 51). When selected, the Print an Insurance Claim view (#425A) is displayed. Within the view, all insurance claims for the Patient are listed and organized by date. The user may print a particular ADA insurance claim form (#425A2) by selecting the date (#425A1). After the user has selected on the appropriate date for reprint, the system will display a status view for the printing process (#425A3). The user may also select to print a blank insurance claim form (#425A6) for the Patient by selecting “Print a Blank Insurance Form” (#425A5).

The user may then select to “Return to Chart” (#425A4) which returns the user to the Patient's At-A-Glance view (#400).

TABLE 52

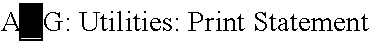

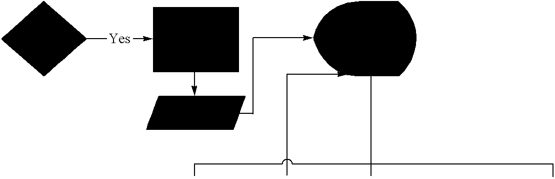

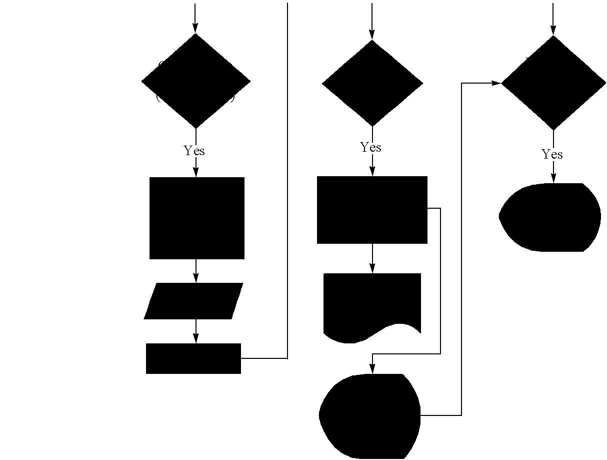

Next in Utilities is Print Statement (#426). The Print Statement view (#426A) is displayed when selected. The view will display the last date and service details of the Patient by default. The user may then choose to reprint this statement by selecting “Print Statement” (#426A2). Once selected, the system will display a print status view for the reprint (#426A4). The user may also select “Return to Chart” (#426A5), which returns the user to the Patient's At-A-Glance (#400).

If the user needs to reprint a statement for services before the last service rendered (or a more comprehensive listing of services), the user may change the start date for the list (#426A7-8). Once the user has changed the start date, the view will display all services (by date) from the new start date to the current date. The user may then select to print the statement accordingly (see above).

TABLE 53

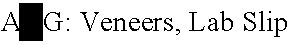

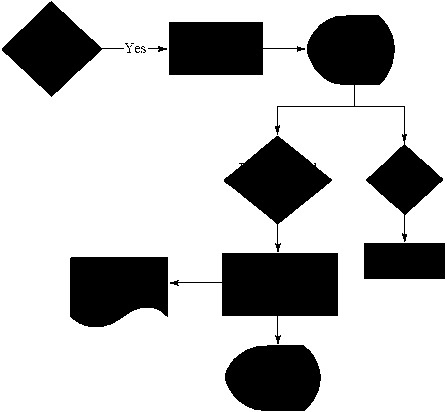

Final selection under Utilities is Veneers, Lab Slip (#427) (Table 53). When selected the system displays the selection view for the types, shapes, sizes and categories of veneer shapes and sizes (#427A). After showing the choices to the Patient and having the Patient select his choices, the user must select the appropriate veneers (#427A1). In order to print out the lab slips, the user must then select “Print” (#427A2). The system will display a status view (#427A4) for the lab slips (#427A3). The user then selects to return to the Patient's AAG (#400) by selecting “Close” (#427A5).

### TotalDentist: Description of New Patient Flow

This description gives full detail as to how a typical office using TotalDentist would record and use all information in regards to a new Patient—from the initial phone call to proceeding visits. Please note that although some of the tables are repeated from the System Description, the portions used as part of the flow are highlighted.

The new Patient calls the office and inquires as to the availability of the office to new Patients. The staff person assures the caller that the office is accepting new Patients and asks for the new Patient's name (in this scenario Andrew Z. Tester), and how he heard about the Office (a current Patient, One Demo, whom he plays golf with, referred him).

TABLE 54
Front Desk: Main View

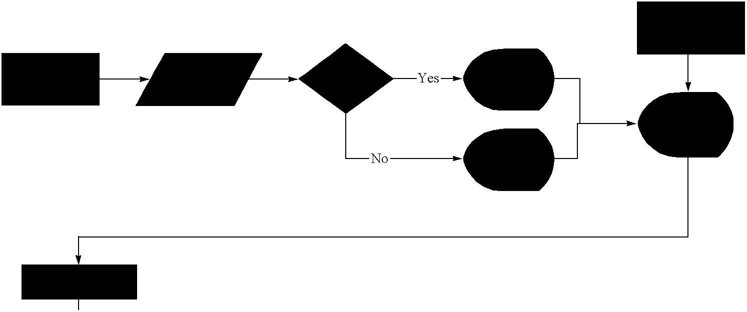

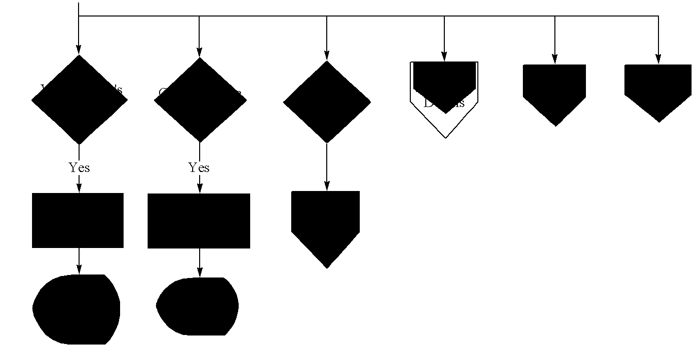

While the staff person is talking to the prospective new Patient the user is viewing the Front Desk main view (#100) and searching to see if the Patient's record is already existing in the system by part of the last name (Test) (#101, #102).

TABLE 55
Front Desk: Patient Search

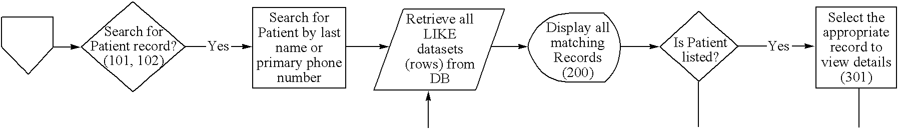

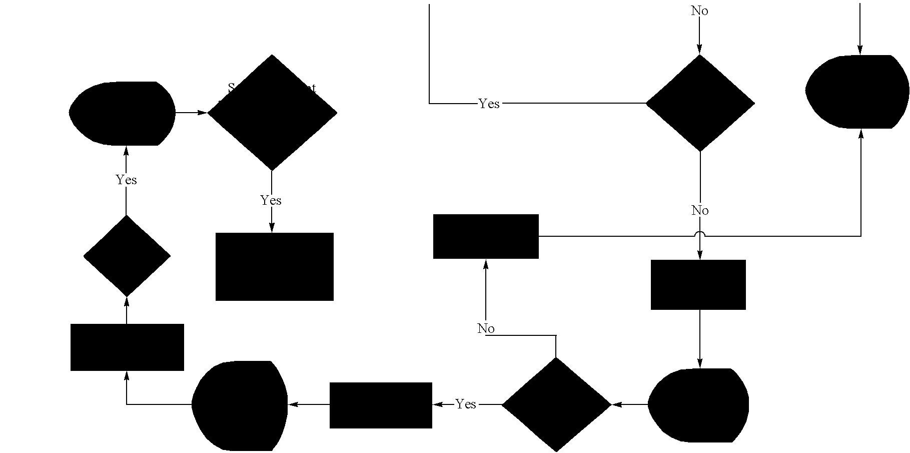

After the last name has been entered and the staff person selected to proceed (#102), the system displays the Patient Search Results view (#200). If the person is not found on the list of retrieved records (as is the case for a new Patient), the staff person selects to create a new record by selecting the “New Person” option (#201). This will start the New Patient process which starts with the Create New Patient view (#300). The staff person then fills out all pertinent information (#301) about the new Patient (as much or as little as the person's name and phone number) and chooses the appropriate referral information (#302). In this case it was an existing Patient in the Office so the staff person selects “Patient” and selects “Create Patient (#303) to continue the process. The system will then display the Referral Patient Search view (#304). The staff person enters the name of the referral source, in this case Demo, (#305) and clicks the search button (#306). This brings up the list of current Patients with matching last names (#307).

TABLE 56
Patient At-a-Glance: Main View

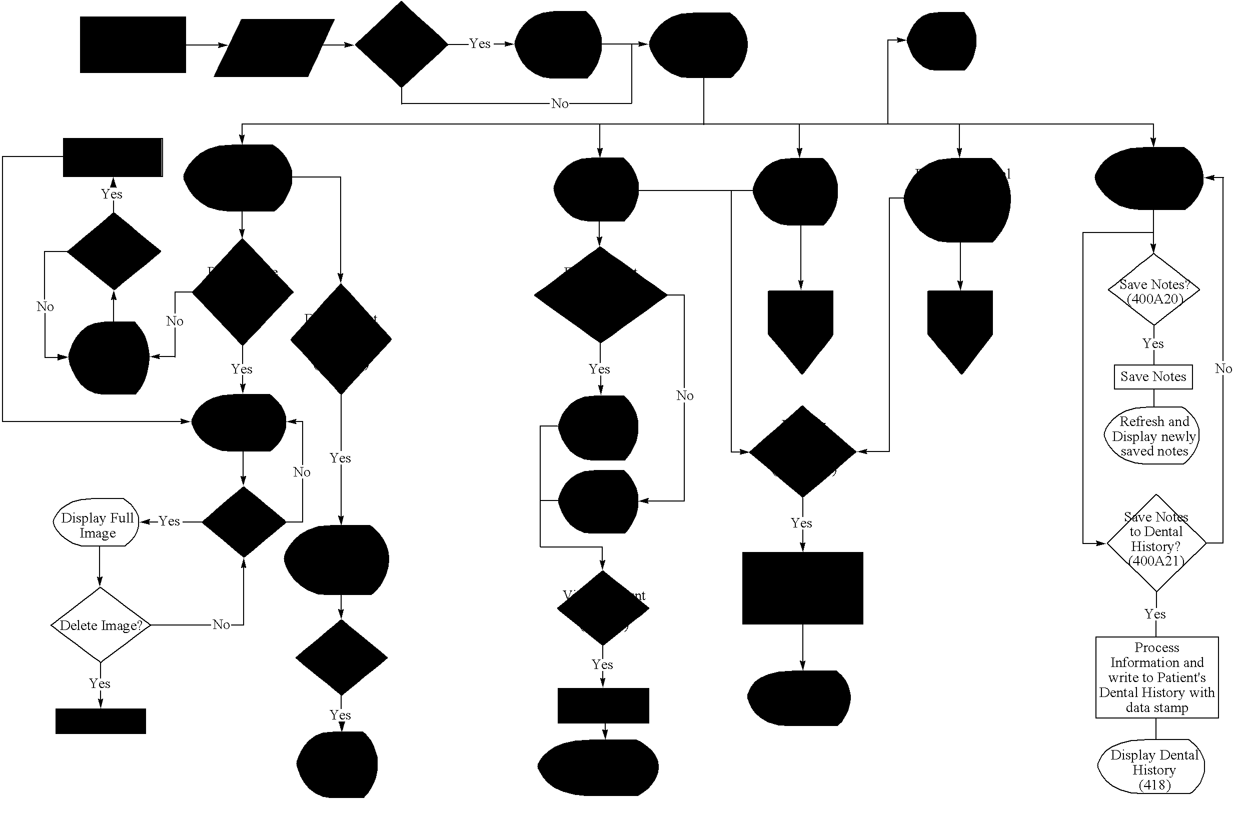

TABLE 57
Patient At-a-Glance: Clinical Information

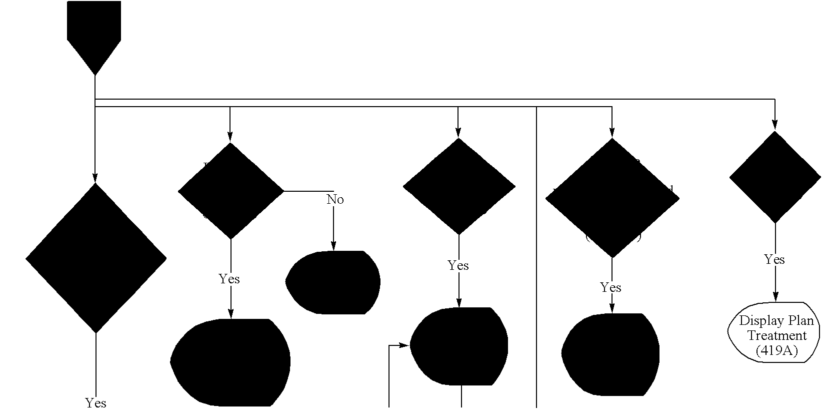

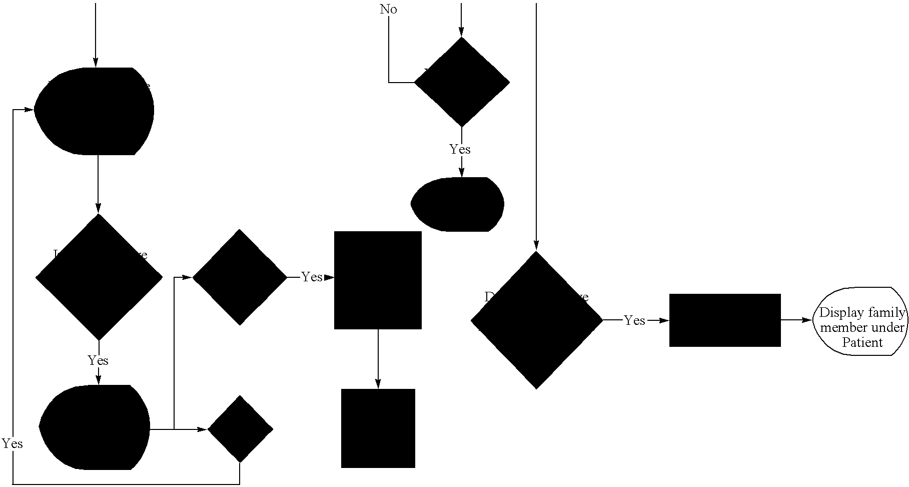

Selecting the appropriate name (#308) finishes both the Referral and the New Patient process and records all data and associates the selected Patient as the “Referred By person”. It then creates the new Patient record and displays the Patient's At-A-Glance view (#400). Notice that the Patient referral reflects the information entered during the New Patient process (#401).

From this view, the staff person may select any of the headers for Financial Information (#402), Insurance Information (#403) or Clinical Information (#404) in order to display and explain the Office Policies (#405) on these subjects so the staff person is consistent in discussing Office related information with every new Patient (The Policies may be managed in the Office Setup section).

The Patient will then be ready to schedule an Initial Exam Visit. The staff person goes to the drop down menu labeled Select Treatment (#406) (which lists the most common appointment options) and chooses the Initial Exam (#407).

After a selection has been made (in this scenario, Initial Exam), the system will display the Schedule view (#500) with the Patient's already created and ready to be scheduled (#501). After verifying the date and time for the Visit with the Patient, the staff person selects the appropriate start time, in this example 1:00 PM (#502), for today.

Once the staff person has placed the Visit into the schedule, the system will display the Confirm Appointment Information view (#503). The staff person can then verify and manage all information for the Visit and the timeframe as well (#504, #505). If for any give reason the staff person needs to cancel the recently entered Visit, the staff person needs to select “Cancel” (#506) from the Confirm Appointment Information view. This action will return the staff person to the Schedule view (#500) along with the Visit again in a format to be placed within (#501). If the information displayed as part of the Confirm Appointment Information view is correct, the staff person must select “Confirm” (#507) to complete the Visit scheduling process. It also returns the staff person to the Patient's At-A-Glance view (#400) where any final questions the Patient has may be answered (along with displaying the newly scheduled Visit (#508)).

TABLE 58
Front Desk: Schedule

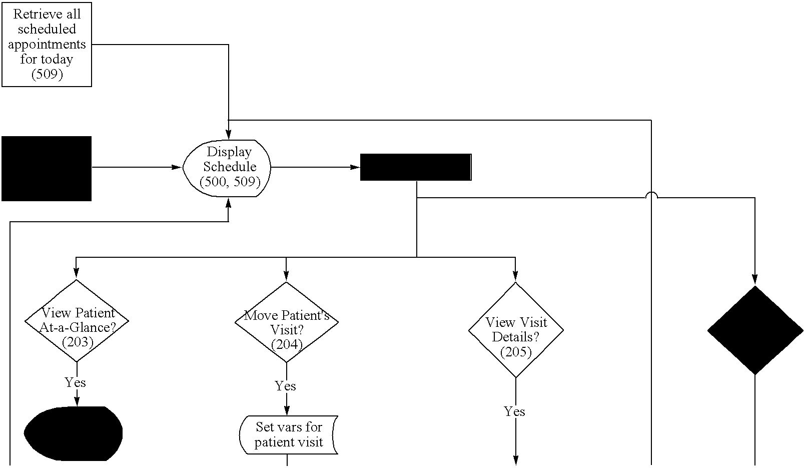

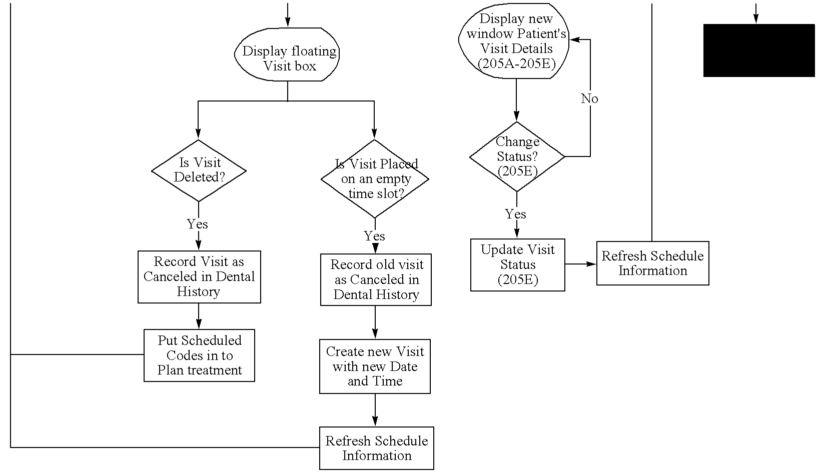

The staff person then selects “Close Patient Chart” (#508) to return to Schedule view (#500). The staff person then sees the newly scheduled Visit in today's schedule view and in the slot at 1 PM to 2 PM for an Initial Exam (#509).

When the staff person selects “Return to Main” (#510) the system will return the user to Front Desk view (#100) and note the new Patient's Visit listed for today with all the pertinent information (#511).

At this point in the conversation with the new Patient, the staff person informs the Patient that when he comes in for the Visit that he needs to complete forms containing detailed personal information. The staff person also informs the Patient that these forms and other information about the Office can be found on the Office's website (hosted by TotalDentist). The Patient then may download the electronic forms, print, fill them in by hand, and bring them with him at the time of the Visit or fill out the active forms online or wait until they are present in the office to enter the information on the computer kiosk in the reception area.

TABLE 59
Patient At-a-Glance: Main View

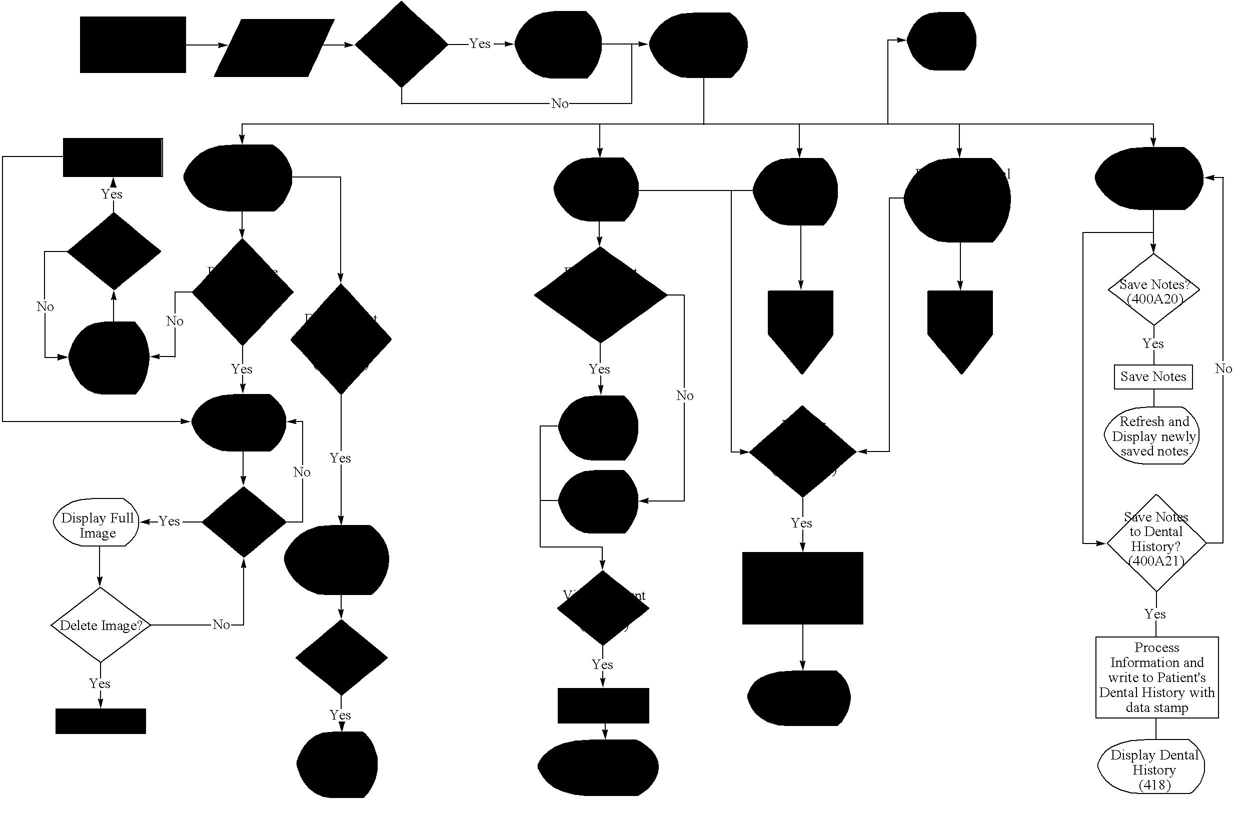

TABLE 60
AAG: Today's Visit

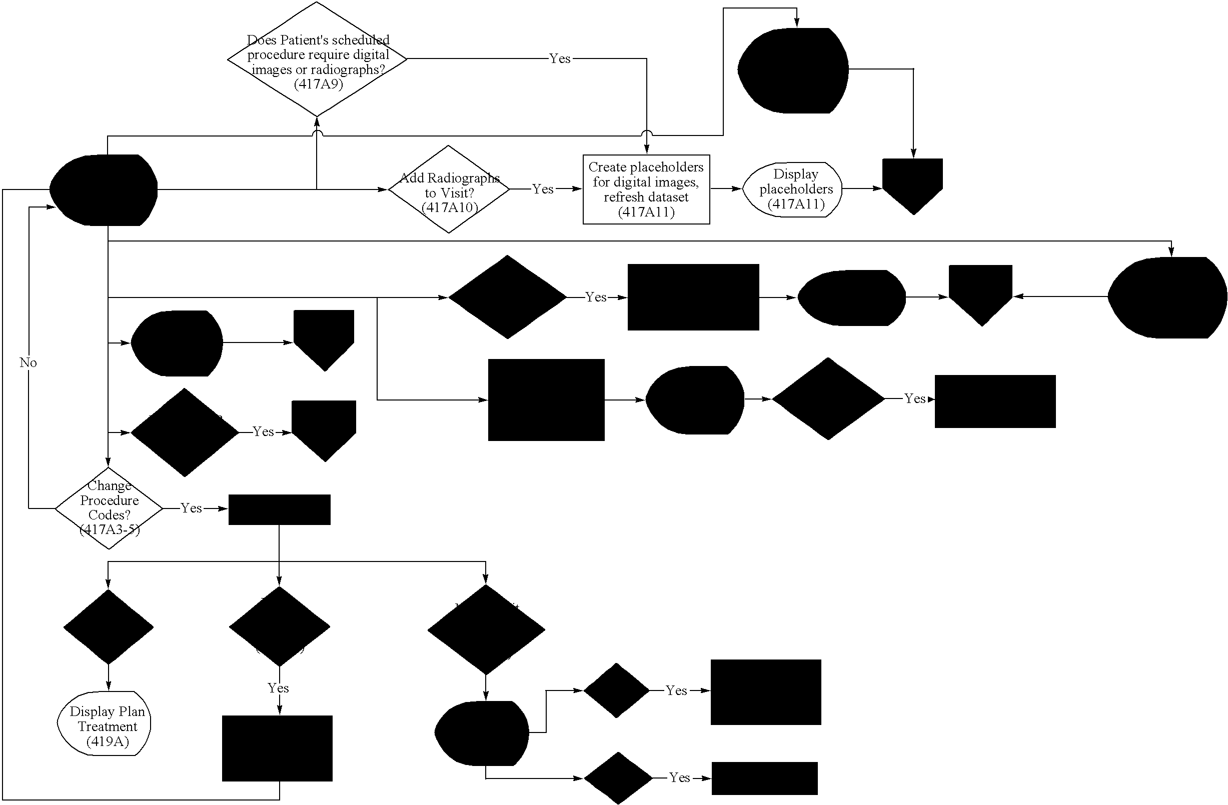

TABLE 61
AAG: Today's Visit: TD Xray

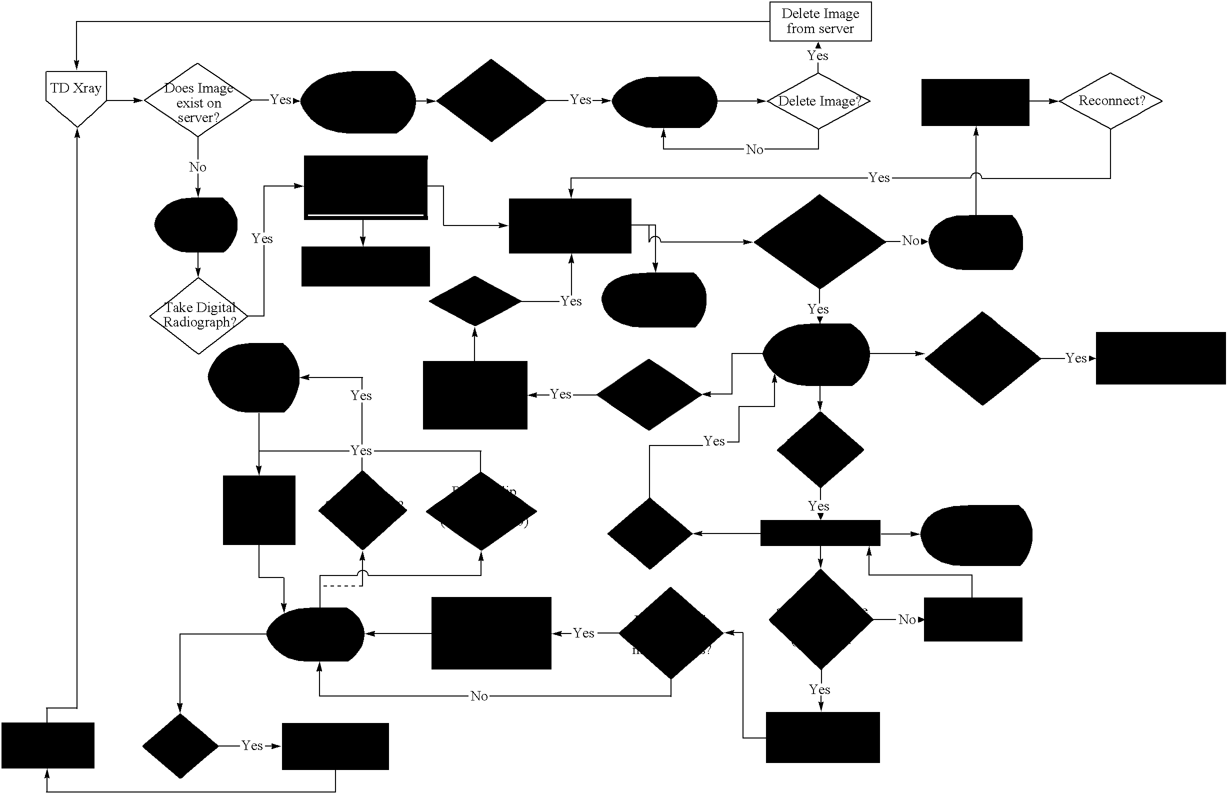

TABLE 62
AAG: Today's Visit: TD Camera

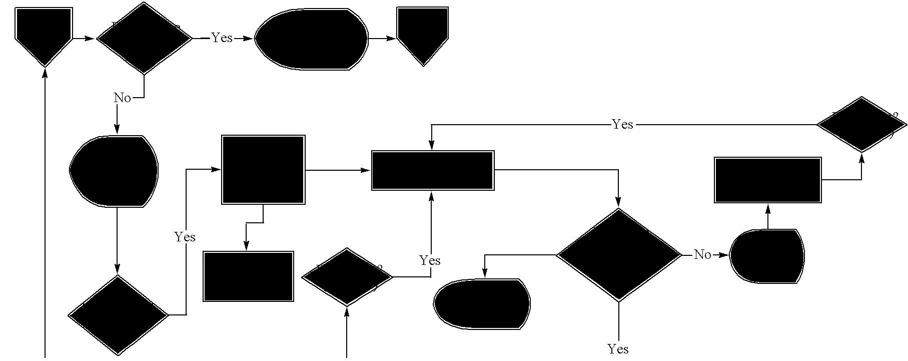

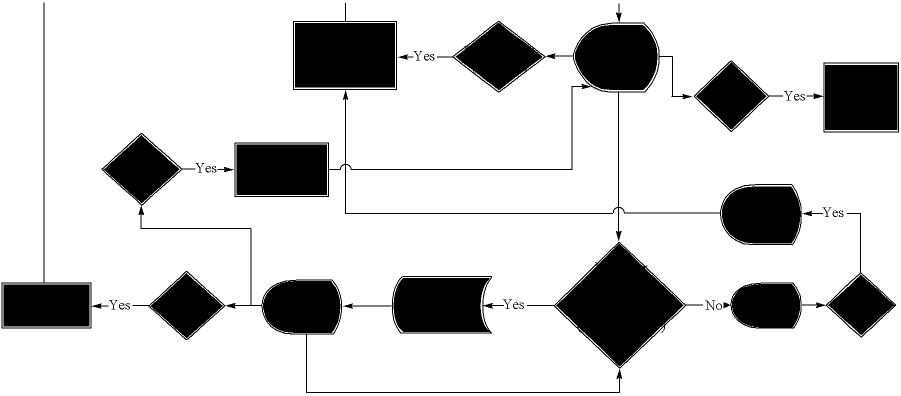

When the Patient is at the Office for the Visit and has completed his information (using methods described above), the corresponding sections in the Patient's At-A-Glance view (#400) will reflect all entered information under (#401), (#402), (#403), (#404), (#405), (#406), (#407), (#408), (#409).

The Patient is then brought into the operatory and the Patient's At-A-Glance view (#400) is opened. The staff person or the dentist selects to go to “Today's Visit” (#417) to view the Visit chart and relevant information for an Initial Exam (#600). The Initial Exam contains these information sets: Full mouth series of radiographs, (#601) full mouth series of pictures (#602), full periodontal and restorative charting (#603) and treatment notes (#604).

The staff person will work with the dentist in order to capture all image sets first. For the radiograph portion, the staff person activates the TD X-Ray application by selecting the appropriate Radiograph icon (#605) and proceeds through the image capture procedure discussed previously in section (#417A) until all Radiographs are taken. The procedure is repeated for the digital Photographs (#606) as discussed earlier in section (#417A) until all photographs are taken. The full face picture is taken by hitting on the icon in the chart header (#607) but can also be taken from the full face icon (#608) in the full mouth series.

TABLE 63
AAG: Today's Visit: Charting

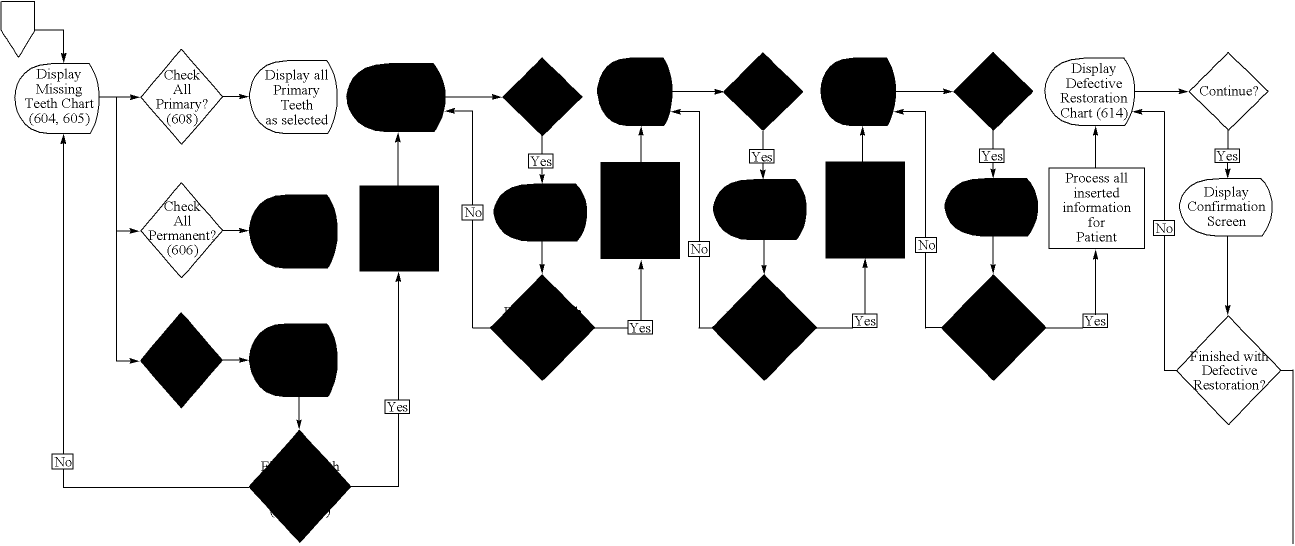

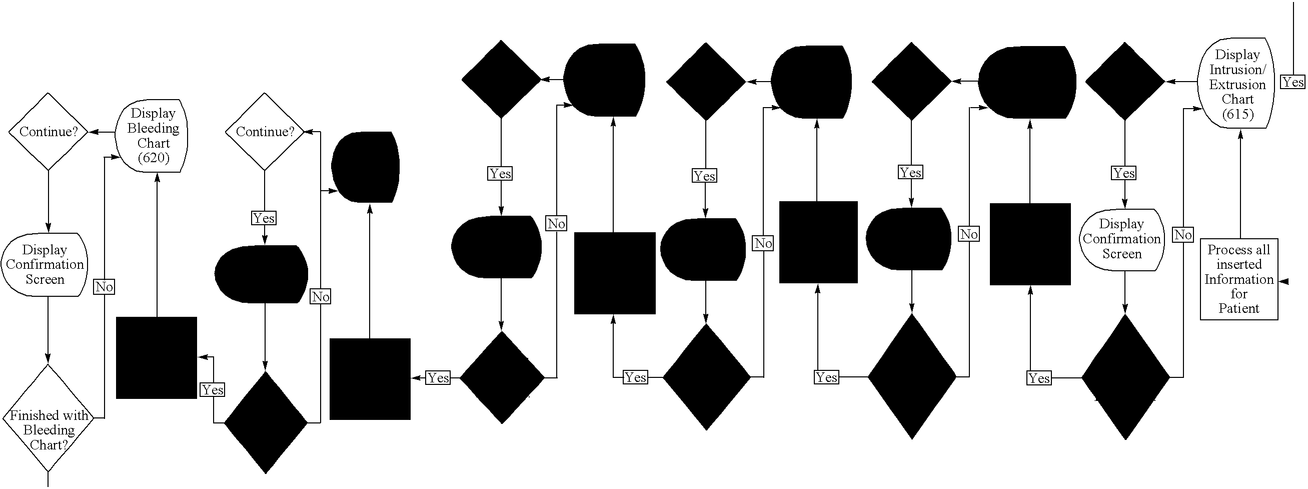

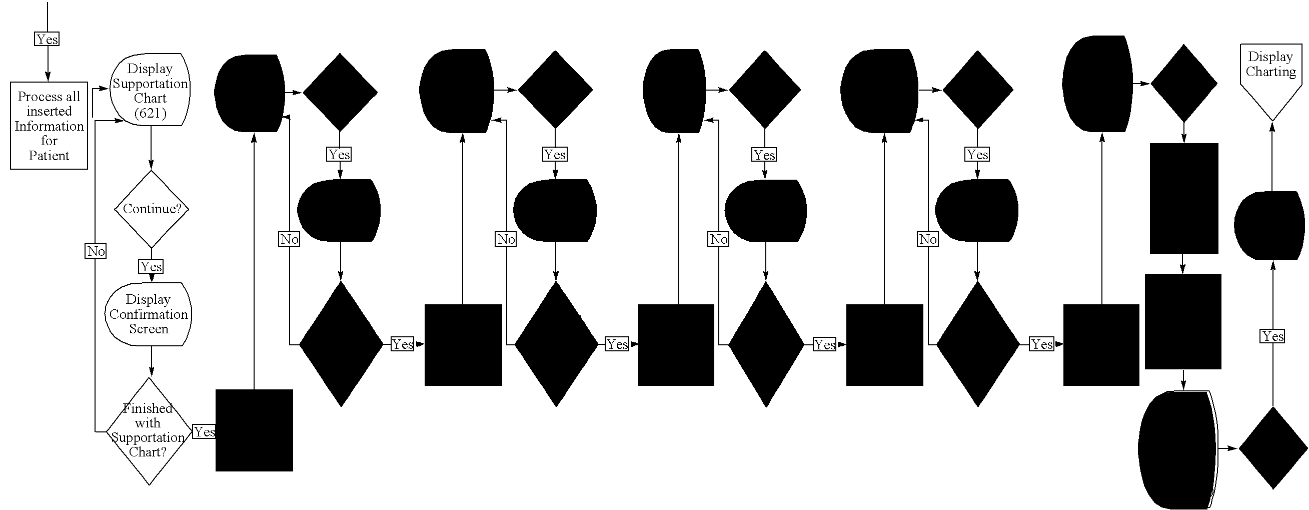

TABLE 64
AAG: Today's Visit: Display Charting

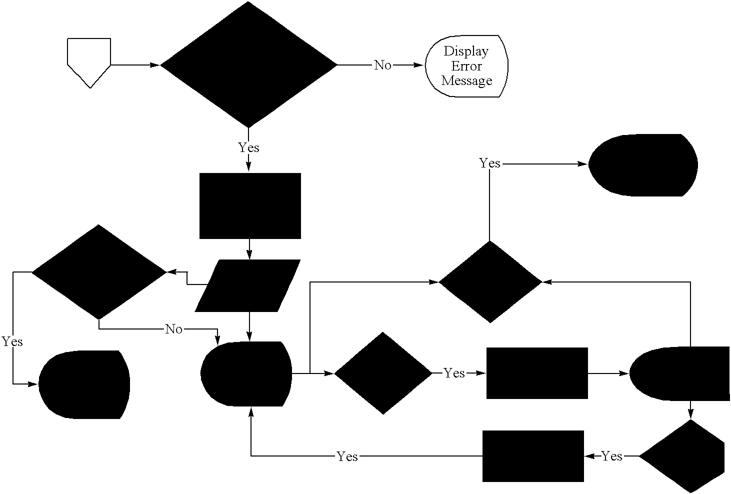

After completing the capture of Radiographs and Photographs, the staff person or the dentist may then proceed to collect the charting information. When the user selects “Charting” (#603), the Charting process is started. The first is missing teeth (#604). This sets up this Patient's dental topography with regards to missing teeth, total numbers of teeth and types of teeth. Once this has been established through examination, the user may either select individual tooth (#605) or use grouped selections (#606) to mark the missing teeth. After completing this section, the user must select “Next” (#607). The system will display a confirmation view for the user to confirm that this step in the process is complete (#608). This gives the staff person and dentist an opportunity to review the data and confirm that it is indeed correct before moving on. If something is amiss or incorrect, the user may select “No” (#609) to be returned to the previous step in the process (in this case, “missing teeth” (#604)). If the user is sure that all information is correct, the user may select “Yes” (#610) to progress to the next step in the charting process, Supernumerary Teeth (#611). As the dentist continues through the complete charting process, the steps to complete each section are duplicated by the user as described above. The order of the sections is as follows:
Missing Teeth (#604)
Supernumerary Teeth (#611)
Sensitivity (#612)
Caries (#613)
Defective Restorations (#614)
Intrusion/Extrusion (#615)
Drift/Rotation: (#616)
Diastema: (#617)
Mobility: (#618) with drop down menu of values to choose
Probing: (#619)
   (The recording of the measurement of periodontal depth moves the cursor to the next appropriate space to facilitate quick data entry)
Bleeding: (#620)
Supporation (#621)
Recession (#622)
Masticatory Mucosa: (#623)
Furcation (#624)
Head and Neck Exam: (#625)
Blood Press/Heart rate: (#626)

The design of the TotalDentist system allows all, some or none of the charting for a Patient Visit. More importantly, as needs arise for other specific charting (i.e. TMJ, Occlusal exams, Oral cancer screening, etc), the system can be easily updated to include and meet these needs.

Once charting is completed, at the bottom of the Head and Neck Exam (last section of full Charting process) the user must select Submit (#627) in order to record the charting data and activate the TotalDentist Automated Planned Treatment™. The system will then display a list of diagnoses (#627) based on the information collected from the charting, and correlating that with dental standards of care like The American Academy of Periodontology guidelines for periodontal diagnosis and treatment.

The resulting view (#627) displays a list of teeth that seem to be in need of restorative work and the preliminary periodontal diagnosis of the Type of Periodontal Disease all based upon the previously collected data. The dentist can then modify the periodontal type diagnosis (#628). Once completed, the user must select “Finished” (#629) and the system will display the charting information (by default Restorative first)(#630). The user may select “Periodontal Charting” (#631) to view the periodontal information (#632). If the Patient had multiple chartings done as part of his recorded Visits, all previous charts are listed by date for quick access (#420). Once the user is satisfied with the information collected and reviewed under charting, the user may select “Return to Visit (#633). The system will then display the Patient's Planned Treatment view (#634, #419) showing the expanded periodontal treatment recommended for the chosen Type diagnosis (#635).

TABLE 65
AAG: Today's Visit: Plan Treatment

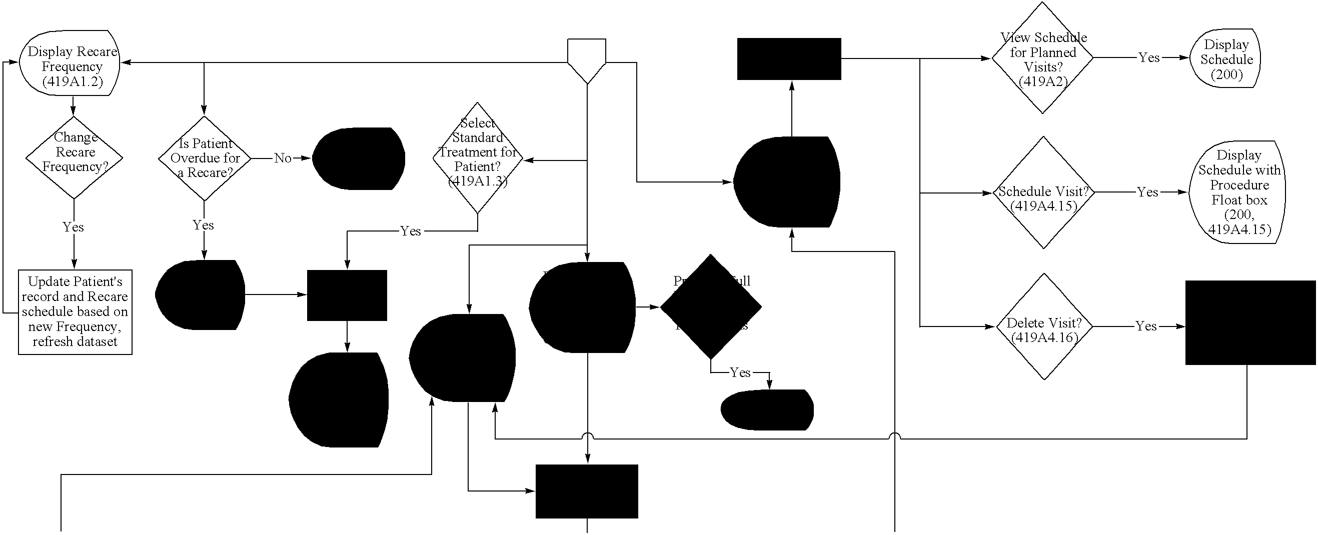

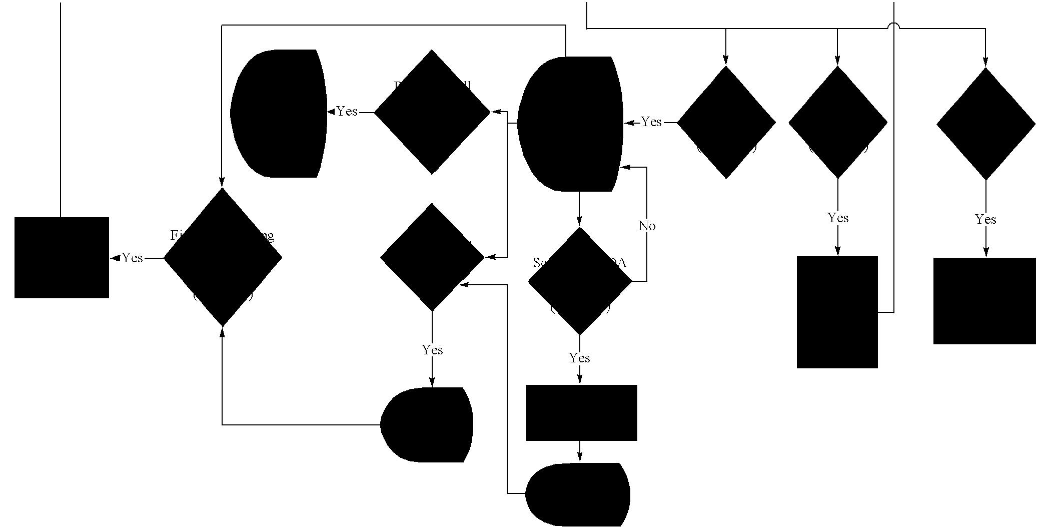

Once the user is the Plan Treatment view, the dentist or the staff person can see all the recommended Visits created based on the analysis done based on the collected charting information. The view also displays the teeth information on the bottom on the view with teeth identifiers (by number) (#636) and also color coded. The missing teeth are gray (#637), needing or marked for repair red (#638) and healthy identified in green (#639).

Please refer to the System Description of Plan Treatment for full details.

When the dentist or the staff person is ready to go back to the Patient's Visit information, the user may select “Today's Visit”. This will return the user to the Today's Visit view with the Initial Exam information sets (#600).

The user may then review the information contained within the Treatment Notes section (#604) and add or modify the automated treatment notes for this type of procedure. After editing the information, the user must select “Save Treatment Notes” to save the changes to the Patient Visit record. All entries are date and time stamped and recorded in the system as such.

If any discussion on future treatments is needed at this time, the dentist selects “View All” (#417A98) in order to display the merged view of Patient Education material and the Patient specific information.

If the dentist would like to plan a tooth for a restoration he or she chooses the appropriate tooth within the view and follows the steps described in System Description (#419A3, 4).

TABLE 66
AAG: Today's Visit: Checkout

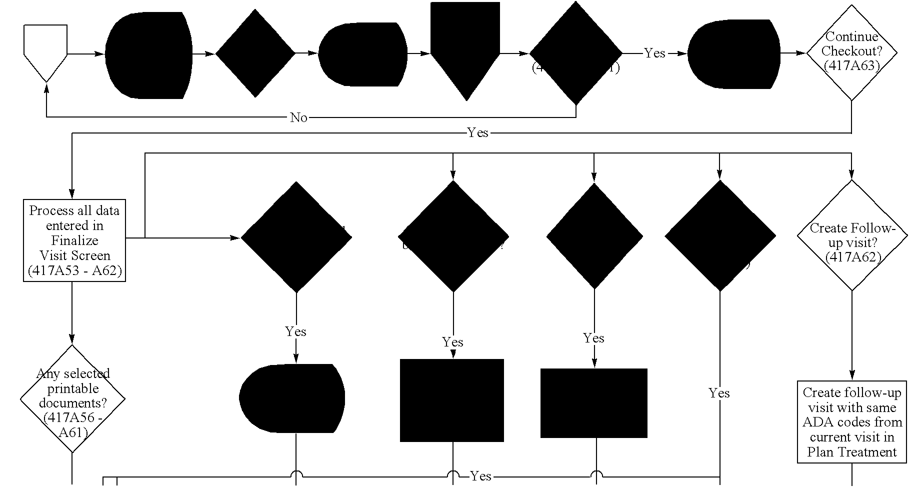

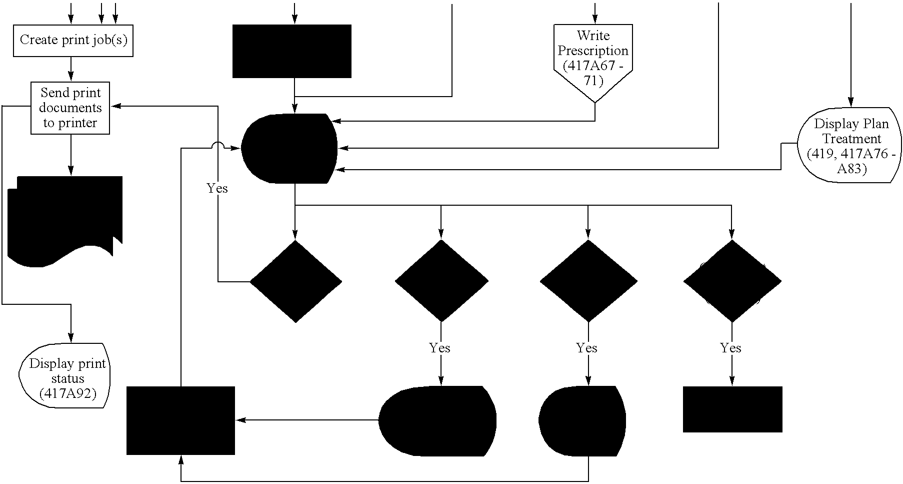

At this point in the operatory the Visit is now ready to be completed, with the staff knowing what the next Visit should be (according to the analysis of charting information). When the dentist of the staff person is ready to finish the Visit, the user must select “Complete Visit” (#640). This will begin the automated Check Out process.

At the beginning of the process is the Verify Procedures view (#641). It is a reminder view to the either the staff person or the dentist to check all information before proceeding into the Check Out process. If the user is unsure the user should select, “No”. This will return the user to the Patient's Visit view for further change and modification for that Visit. If the user is ready to proceed to Check Out process, the user must select “Yes” (#642).

The system will display the Planned Treatment view (#643, 400) for review and scheduling of the next Visit for the Patient. In this case the next planned Visit to be scheduled is Type 2 Perio Visit 1 (#644). The user must select “Schedule” (#645) in order to schedule the Visit. The Schedule view (#500) for the current day is displayed, along with the Type 2 Perio Visit 1 ready to be scheduled and attached to the mouse cursor (#646). Once the Patient is scheduled for his next Visit, the system returns the user to the Planned Treatment view (#646) with the recently scheduled Visit listed as scheduled (with date) (#647). The system returns the user to the Planned Treatment view because the system is Visit centric. The core of the business process revolves around the Visit and the procedures that make up the Visits. The more an Office takes advantage of this design the Office will be able to have the Patient return to the Office for the necessary current and future work in an easy and efficient manner.

If no other Visits are needed to be created and/or scheduled at the time, the user may continue the Check Out process by selecting “Continue Checkout” (#648) (and the Check Out proceeds as in Today's Visit (#417) in System Description). After all the necessary steps are completed and the Check Out process is finished, the proper materials are printed and the user is returned to the Patient's At-A-Glance view (#649) (#400).

If the Patient has any questions regarding his Visit or anything about his personal information, the user may then use the Patient's AAG (#649) (#400) and its subsections to answer the questions (i.e. Account Balance (#650), Pending Insurance (#651), Next Visit (#652), and any scheduled and unscheduled Planned Treatment (#653), etc.).

Appendix 1 shows a table display of one application of the drawings that may be generated by the system, such drawings marked to show the code organization tables herein that structures the drawings and a set of drawings of the code at the programmer level.

Because many varying and different embodiments may be made within the scope of the invention concept taught herein which may involve many modifications in the embodiments herein detailed in accordance with the descriptive requirements of the law, it is to be understood that the details herein are to be interpreted as illustrative and not in a limiting sense.

1. A dental system for use with dental customers, comprising:
a) an application server;
b) input devices connected to said server adapted for entry of dental practice data;
c) a digital memory device connected to said server for storing said data; and
d) said input devices including an imager sensor connected to said server.

2. The dental system of claim 1, wherein said server includes two units, redundantly connected.

3. The dental system of claim 1, wherein said sensor is the only connection between said sensor and said screen.

4. The dental system of claim 1, wherein said memory device includes redundant storage.

5. The dental system of claim 4, wherein said server includes at least one unit and said redundant storage includes at least two memories for each of said units.

6. The dental system of claim 5, wherein said redundancy is in real time.

7. The dental system of claim 5, wherein said redundancy is saved separate from the server.

8. The dental system of claim 1, wherein said sensor directly feeds raw data to said server, whereby there is image capture in a browser environment.

9. The dental system of claim 1, wherein said input devices are shared to said server.

10. The dental system of claim 1, wherein the output of said imager to said server is shared in said memory associated with the dental customer whose image is stored.

11. The dental system of claim 1, wherein image capture and radiography image are stored in said memory device.

12. A method of conducting a dental business for dental patients, comprising the steps of:
a) Receiving data from a plurality of instruments, patients and staff;
b) Storing the data in digital memory;
c) Applying non-linear web technology to the data for reassembly and multiple display of the data in multiple formats.

13. The method of claim 12, wherein said displays enhance customer service.

14. The method of claim 12, wherein said displays enhance productivity.

15. The method of claim 12, wherein said step of applying non-linear web technology includes the step of automating manual processes.

16. The method of claim 12, wherein there is included the step of accessing on-line purchasing of equipment and supplies based on the dentist's patient mix and treatment practice derived from the data.

17. The method of claim 16, wherein there is included the step of displaying the data to track said purchasing.

18. The method of claim 12, wherein said step of receiving the data includes collecting diagnostic digital information and wherein said step of applying non-linear web technology includes the step of automating planning of treatment using the diagnostic digital information.

19. The method of claim 12, wherein said step of receiving the data includes collecting diagnostic digital information and wherein said step of applying non-linear web technology includes the step of automating diagnosis of disease using the diagnostic digital information.

20. The method of claim 18, wherein said planning is associated with patient procedures for treatment.

21. The method of claim 20, wherein said patient procedures are represented by the American Dental Association Code.

22. The method of claim 12, wherein said step of receiving data includes receiving image data and said step of applying non-linear web technology includes display of the image data linked to the patient particular dental visit data, as well as use in displaying all images or x-rays by date.

23. The method of claim 12, wherein said step of applying non-linear web technology includes the step of integrating patient education into the patient visit.

24. A method of conducting a dental business for dental patients, comprising the steps of:
a) Receiving data from a plurality of instruments, patients and staff;
b) Storing the data in digital memory;
c) Accessing on-line purchasing of equipment and supplies based on the dentist's patient mix and treatment practice derived from the data.

25. A method of conducting a dental business for dental patients, comprising the steps of:
a) Receiving data from a plurality of instruments, patients and staff;
b) Storing the data in digital memory;
c) wherein said step of receiving the data includes collecting diagnostic digital information and wherein there is included the step of automating planning of treatment using the diagnostic digital information.

26. A method of conducting a dental business for dental patients, comprising the steps of:
a) Receiving data from a plurality of instruments, patients and staff;
b) Storing the data in digital memory;
c) wherein said step of receiving the data includes collecting diagnostic digital information and wherein there is included the step of automating diagnosis of disease using the diagnostic digital information.

27. A method of conducting a dental business for dental patients, comprising the steps of:
a) Receiving data from a plurality of instruments, patients and staff;
b) Storing the data in digital memory;
c) wherein said step of receiving the data includes collecting diagnostic digital formation and wherein there is the step of automating planning of patient procedures for treatment.

28. A method of conducting a dental business for dental patients, comprising the steps of:
a) Receiving data from a plurality of instruments, patients and staff;
b) Storing the data in digital memory;
c) wherein said step of receiving the data includes collecting diagnostic digital formation and wherein there is the step of automating diagnosis of disease for treatment.

29. A method of conducting a dental business for dental patients, comprising the steps of:
a) Receiving data from a plurality of instruments, patients and staff;
b) Storing the data in digital memory;
c) wherein said step of receiving the data includes receiving image data and collecting the image sequence of data as the data is generated.

30. A method of conducting a dental business for dental patients, comprising the steps of:
a) Receiving data from a patient;
b) Scheduling patient visits associated with specific procedures to be done on the patient;
c) Storing the patient information in digital memory;
d) Automating the use and display of the collected data to be accessible from any station in the dental facility.

31. A method of claim 30 wherein there is further included the step of the collection of digital imaging information.

32. A method of conducting a dental business for dental patients, comprising the steps of:
a) Receiving data from a patient;
b) Scheduling patient visits associated with specific procedures to be done on the patient;
c) Storing the patient information in digital memory;
d) Automating the use and display of the collected data to be accessible from a site separate from the digital memory through a secure connection.

33. A method of claim 32 wherein there is further included the step of the collection of digital imaging information.
